(19) United States
(12) Patent Application Publication
(10) Pub. No.: US 2014/0045153 A1
(43) Pub. Date: Feb. 13, 2014

(54) METHODS FOR TEACHING READING AND MATH SKILLS TO INDIVIDUALS WITH DYSLEXIA, DYSCALCULIA, AND OTHER NEUROLOGICAL IMPAIRMENTS

(71) Applicant: Michael E. Cornell, Gibsonia, PA (US)

(72) Inventor: Michael E. Cornell, Gibsonia, PA (US)

(21) Appl. No.: 14/047,317

(22) Filed: Oct. 7, 2013

Related U.S. Application Data
(63) Continuation-in-part of application No. 13/136,147, filed on Jul. 25, 2011.
Application No. 13/136,147 is a continuation-in-part of application No. 12/927,356, filed on Nov. 12, 2010, now abandoned.
(60) Provisional application No. 61/260,481, filed on Nov. 12, 2009.

(51) Int. Cl. G09B 19/02

(52) U.S. Cl. CPC G09B 19/025
USPC 434/201

(57) ABSTRACT

The present invention includes mathematical symbols for teaching math skills to individuals with dyslexia, dyscalculia, and other neurological impairments when unique geometric shapes are arranged to form numbers of a base 10 counting system that are capable for using in additional, subtraction, multiplication, and division. The present invention of mathematical symbols includes whole numbers, real numbers, integers, fractions, and decimals. The present invention also includes a computer implemented digital interactive learning system comprised of having a user manipulating the unique geometrical shapes on a device using an interface. Preferably the interface is comprised of a shape bar area where the various geometrical shapes are displayed and a workspace area where the various geometrical shapes are manipulated by the user. The present invention can be used to teach students how to perform basic math operations and how to use currency.

### CROSS-REFERENCE TO RELATED APPLICATIONS

This is a Continuation In Part application of non-provisional application U.S. Application Ser. No. 13/113,6147, titled Methods and Apparatus for Teaching Reading and Math Skills to Individuals with Dyslexia, Dyscalculia, and Other Neurological Impairments, filed on Jul. 25, 2011, which is a Continuation In Part of non-provisional U.S. application Ser. No. 12/927,356, titled Methods and Apparatus for Teaching Reading and Math Skills to Individuals with Dyslexia and Other Neurological Impairments, including Phonetose, SHAPE MATH® Conceptual Clarifiers, Internet Speaking Reference Chart, Speaking Phonetose Program, Phonetic Hangman, Alternating Line Highlighting, and English Grid, filed Nov. 12, 2010, which claims priority from U.S. Provisional Patent Application No. 61/260,481, titled METHODS AND APPARATUS FOR TEACHING READING AND MATH SKILLS TO INDIVIDUALS WITH DYSLEXIA AND OTHER NEUROLOGICAL IMPAIRMENTS, INCLUDING PHONETOSE, SHAPE MATH® CONCEPTUAL CLARIFIERS, INTERNET SPEAKING REFERENCE CHART, SPEAKING PHONETOSE PROGRAM, PHONETIC HANGMAN, ALTERNATING LINE HIGHLIGHTING, AND ENGLISH GRID, filed Nov. 12, 2009, all applications designated above are incorporated herein by reference.

### FIELD OF THE INVENTION

Teaching methods and a system on a digital interface for teaching math skills to individuals with dyslexia, dyscalculia and other neurological impairments.

### BACKGROUND OF THE INVENTION

Dyslexia is a learning disorder that manifests itself primarily as a difficulty with reading and spelling, but math skills can also be affected. It is separate and distinct from difficulties resulting from other causes, such as a non-neurological deficiency with vision or hearing, or from poor or inadequate reading instruction. Although dyslexia is thought to be the result of a neurological difference, it is not an intellectual disability. Dyslexia is diagnosed in people of all levels of intelligence: below average, average, above average, and highly gifted. People with dyslexia are often gifted in math. Their three-dimensional visualization skills help them “see” math concepts more quickly and clearly than non-dyslexic people. Unfortunately, difficulties in directionality, rote memorization, reading, and sequencing can make the math tasks so difficult that their math gifts are never discovered. In particular, many dyslexic children and teens have problems in some areas of math, especially the multiplication tables, fractions, decimals, percentages, ratio and statistics. Thus, good methods for teaching math to dyslexic individuals emphasize their visualization skills. Dyslexia symptoms vary according to the severity of the disorder as well as the age of the individual. It is estimated that dyslexia affects approximately 5% to 17% of the U.S. population.

It is also estimated that approximately 4-7% of school age children have dyscalculia which is a math disorder. Persons with dyscalculia have difficulty understanding cardinal numbers, math symbols and basic arithmetic. Additionally, dyscalculics struggle with memorizing mathematical facts, including multiplication tables. Often times dyscalculia is coupled with a lack of the ability to focus and can be associated with dyslexia as well. These challenges pose an enormous difficulty for students to learn the basic math operations of addition, subtraction, multiplication and division, as well inhibiting the ability to use currency—e.g. to make change. Dyscalculia has been long overlooked by the public schools because the focus has traditionally been on helping the students with reading. However persons with dyscalculia or other cognitive deficiencies regarding math skills will have difficulty or may never learn or become proficient in mathematics without specific intervention.

There is no cure for dyslexia or dyscalculia, but individuals affected by these and other disorders can learn to read and write and do math problems with appropriate educational support. What is needed is a system which is geared to teaching mathematics to these affected persons in way that emphasizes their visualization, as well as their other cognitive skills. The present invention provides for computer implemented methods and systems for teaching math skills to individuals with dyslexia and dysealculia. The tools of the present invention can be used in combination with other programs and systems.

### SUMMARY OF INVENTION

The present invention uses a series of shapes that fit in logical patterns that make a geometric representation of the 10-based number system. It allows students to do mental math problems such as multiplication and division without using times tables. Ultimately it allows users to visually and conceptually understand what were previously to them, purely abstract concepts. Instead of thinking about how two numbers are added together, a user thinks about how the two numbers fit together. It is specifically tailored to how the dyslexic and the dyscalculic mind work.

The present invention is a mathematical learning system comprised of unique geometrical shapes, with each unique geometric shape having a specific value ranging 1-10. These geometrical shapes are arranged to form numbers of a base 10 counting system and can be used in addition, subtraction, multiplication, or division. The geometrical shapes can be used to perform mathematical operations with whole numbers, real numbers, integers, fractions, and decimals. Geometrical shapes are also used to teach individuals how to use currency and how to convert one unit of time into another, such as minutes to seconds-seconds to minutes using a 60 base system. The present invention also includes a computer implemented digital interactive learning system comprised of having a user manipulating the unique geometrical shapes on a device using an interface. Preferably the interface is comprised of a shape bar area where the various geometrical shapes are displayed and a workspace area where the various geometrical shapes are manipulated by the user. The unique geometrical shapes can be comprised of standard shapes, preferably each standard shape is comprised of a specific color, or geometrical shapes made using the written form. All these unique geometrical shapes represent numerical values traditionally represented by Arabic numerals. In a preferred embodiment, the system is further comprised of a spacer representing a null value. The geometrical shapes can also be arranged in specific configurations with each specific configuration representing a monetary value of a specific currency denomination. The computer implemented system of the present invention may be further comprised of a device that can stored certain information for each unique geometrical shape and for each specific configuration of geometrical shapes and wherein the information stored may be comprised of: a) a selection status; b) a type status; c) a numeric value; d) an orientation; and e) a style. Each geometrical shape or configuration may also have different size values, preferably with at least three different size values. In a preferred embodiment, some larger geometrical shapes comprised of smaller geometrical shapes can be separate into those smaller geometrical shapes and then manipulated by the user. In another preferred embodiment, the use of outline shapes can be used to demonstrate how unique geometric shapes with smaller values can be combined to form unique geometrical shapes with larger values. In other embodiments, outline shapes can be manipulated on the interface in the same manner as standard shapes.

### BRIEF DESCRIPTION OF THE DRAWINGS

FIG. 1A is an example of a representation of 28 according to one embodiment of the present invention;

FIG. 1B discloses shows SHAPE MATH® numbers 1-10, zero spacers, a fifty, one hundred and a 60 pattern;

FIG. 2 discloses zero spacers;

FIG. 3 shows SHAPE MATH® shapes 1-5.

FIGS. 4-5 show different kinds of ten shapes;

FIG. 6A-6F show examples of various SHAPE MATH® numbers;

FIG. 7 shows the written form of numbers 1-10;

FIGS. 8A-B demonstrate a SHAPE MATH® manipulation;

FIGS. 9A-B shows the quantities of 10 and 100 in place value;

FIGS. 10A-F show place value addition;

FIGS. 11A-F show place value subtraction;

FIG. 12 shows ten shape patterns used to represent multiples of ten in direct representation;

FIGS. 13-14 show manipulation with the ten shape patterns;

FIG. 15A-E show the manipulations needed to perform an addition problem;

FIGS. 16-24 are examples of multiplication techniques;

FIGS. 25-28c demonstrate time conversion;

FIG. 29 shows a SHAPE MATH® cube laid flat;

FIGS. 30-34 demonstrate direct representation mental division;

FIGS. 35-36 demonstrate direct mental division;

FIGS. 37A-B demonstrate long division;

FIG. 38 shows the SHAPE MATH® penny;

FIG. 39 shows the SHAPE MATH® coins;

FIG. 40 shows ten SHAPE MATH® pennies equaling the SHAPE MATH® dime;

FIGS. 41A-C shows how to make 33 cents;

FIGS. 42A-B shows how to add coins

FIG. 43 shows the problem (1 dollar−68 cents);

FIG. 44 shows a one dollar bill, for example, is composed of 100 SHAPE MATH® pennies;

FIG. 45 shows alternative SHAPE MATH® one dollar bills;

FIG. 46 shows the SHAPE MATH® bills in descending order from top to bottom;

FIGS. 47A-B show the problem ($27+a five dollar bill);

FIGS. 48A-E shows the problem $10−$5.17;

FIG. 49 is a SHAPE MATH® representation of ¾;

FIG. 50 shows the front side of a three shape 3b next to the reverse side of that same three shape;

FIG. 51 shows the problem 2/7+ 5/7;

FIGS. 52A-C shows the problem 2/4+⅜;

FIG. 53 shows the written form of ¼;

FIGS. 54A-D shows how to multiply fractions in SHAPE MATH®;

FIG. 55A-C shows the problem 2/4÷¾;

FIG. 56 shows the equivalent fractions of ( 3/2) and (1 ½) written as SHAPE MATH® fractions;

FIGS. 57A-G show the problem of [1 ( 2/7)]+[2 ( 6/7)];

FIGS. 58A-G show the problem [2 (⅕)]−[1 (⅘)];

FIGS. 59A-C show the problem 3/2+½ as it would be completed with written improper SHAPE MATH® fractions;

FIGS. 60A-B show a percentage representation;

FIG. 61A-C shows percentage representations;

FIGS. 62A-C show all the common percentage pieces within the one shape that represents 100 percent;

FIG. 63 shows the same one shapes from FIGS. 62A-C as they would appear if the percentage pieces were pulled apart;

FIG. 64 shows how to calculate 20 percent of 5;

FIG. 65A-B shows how to calculate a 20 percent tip for 27 dollar check;

FIG. 66 demonstrates 20% of 4 dollars;

FIG. 67 shows the calculation of 15 percent of 2;

FIG. 68 An example of a screen shot of Digital SHAPE MATH®;

FIG. 68A demonstrates the drop down menu for video lessons;

FIG. 69 demonstrates standard shape tab use Digital SHAPE MATH®;

FIG. 69A demonstrates dragging shapes;

FIG. 70 demonstrates use of the writing tab;

FIG. 71 demonstrates use of the outline tab;

FIG. 72 shows the outline shape for digit seven after it has been overlaid with an inner four shape;

FIG. 72a-j shows the outline shapes;

FIG. 73 the outline of a 10 shape is shown;

FIG. 74 demonstrates the use of the coin tab;

FIG. 75 shows the difference in size between a five dollar bill and a nickel;

FIG. 76 shows quarters in SHAPE MATH®;

FIG. 77 shows the bills tab;

FIG. 78 shows the real world money tab;

FIG. 79a shows selection and manipulation of items;

FIG. 79b demonstrates different orientations of some shapes;

FIG. 80 shows smaller constituent pieces;

FIG. 81 is a diagram showing a preferred embodiment of the process for checking for video review links;

FIG. 82 shows the specific information is stored for each object on the interface;

FIG. 83 shows an example of the different values stored for a piece;

FIG. 84-shows step one of solving the problem 2×7 using the interface;

FIG. 85 shows step two of solving the problem 2×7 using the interface;

FIG. 86 shows step three of solving the problem 2×7 using the interface;

FIG. 87 shows step four of solving the problem 2×7 using the interface;

FIG. 88 step one of solving the problem 3+3+3+1;

FIG. 89 shows step two of solving the problem 3+3+3+1;

FIG. 90 shows step three of solving the problem 3+3+3+1;

FIG. 91 shows step four of solving the problem 3+3+3+1;

FIG. 92 is a demonstration of how four quarters fit into a dollar;

FIG. 93 is a demonstration of how four quarters fit into a dollar;

FIG. 94 shows how to break down amounts smaller than a dollar;

FIG. 95 shows how to break down amounts smaller than a dollar;

FIG. 96 shows how to teach a student how different denominations of bills can equal the same amount.

FIG. 97 shows how to teach a student how different denominations of bills can equal the same amount; and

FIG. 98 shows how to teach a student how different denominations of bills can equal the same amount.

### DETAILED DESCRIPTION OF THE INVENTION

The geometrical shapes and methods of use are referred to herein as SHAPE MATH®. There examples presented in this application are for illustrative purposes and are not meant to limit the invention.

### SHAPE MATH® Basic Introduction

With SHAPE MATH®, basic math operations can be calculated by visualizing and manipulating shapes that each represent a quantity. Instead of adding abstract symbols which is hard for a dyscalculic, a SHAPE MATH® user can visualize the combination of various shapes. It is a system that displays in a highly visual format and that utilizes dyslexic visual mechanical acuity and dyslexic kinesthetic awareness.

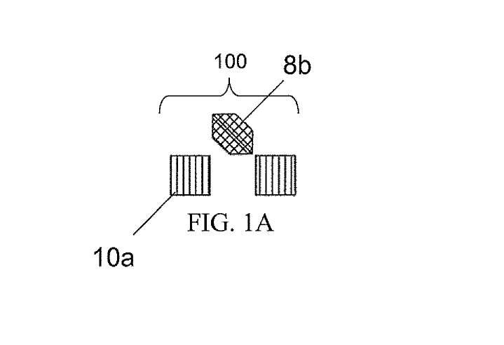

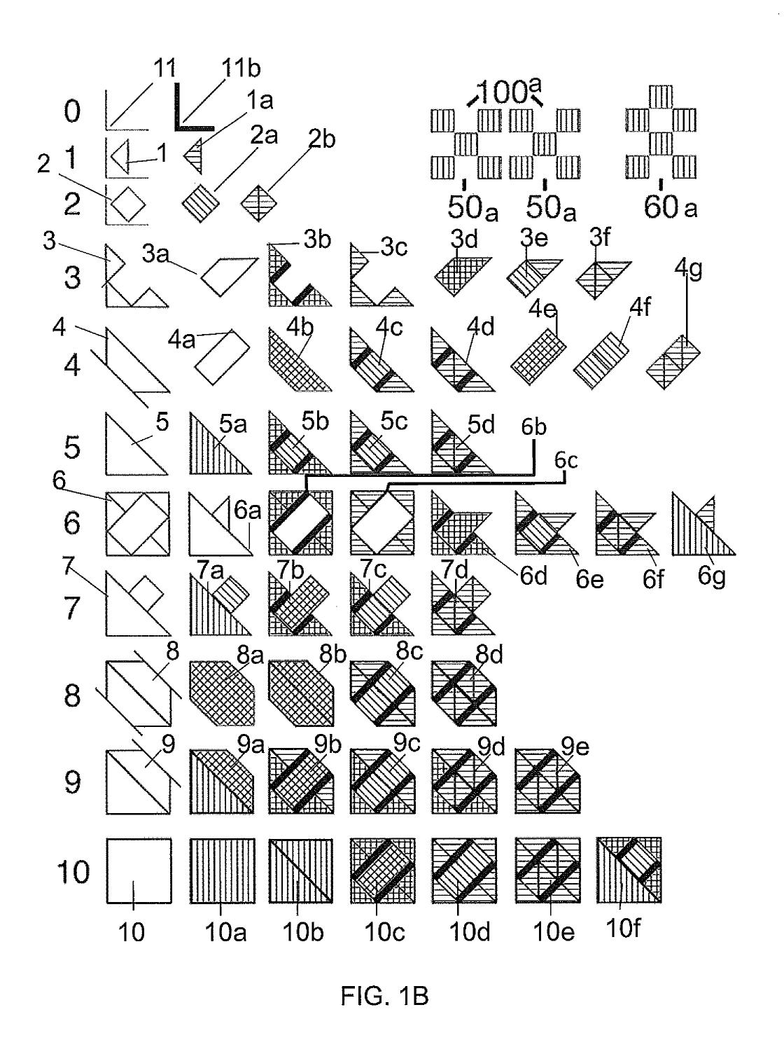

FIG. 1A is an example of the number 28 when expressed with SHAPE MATH® symbols. These symbols will be described in more detail later in the document.

This section demonstrates the basic principles of SHAPE MATH® by introducing the one, two, three and five shapes and demonstrating how they can be combined to make a ten shape. These numbers were selected because they are the basis of all the larger numbers.

The outer three shape 3b represents the quantity of 3 and the two shape 2a (shown in FIG. 1B) represents the quantity of 2. A two shape 2a and three shape 3b, when combined together, make a five shape 5b which represents the quantity of 5. This composite five shape is equivalent to the solid five shape 5a because the value of a SHAPE MATH® number is determined by its size and outline.

A two shape 2a, three shape 3b and five shape 5a can be arranged to make the square shape that represents 10 10f (see FIG. 1B). The ten shape is the standard unit of value when combining shapes because modem math operates on a base ten system. There are many different ways to make a ten shape, including a solid square 10a.

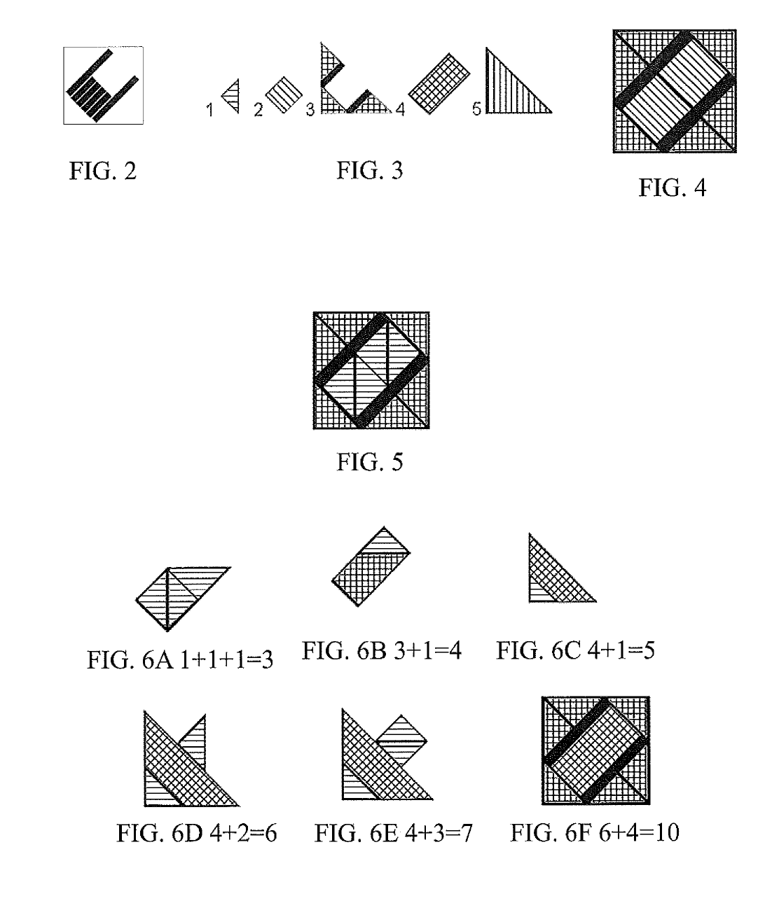

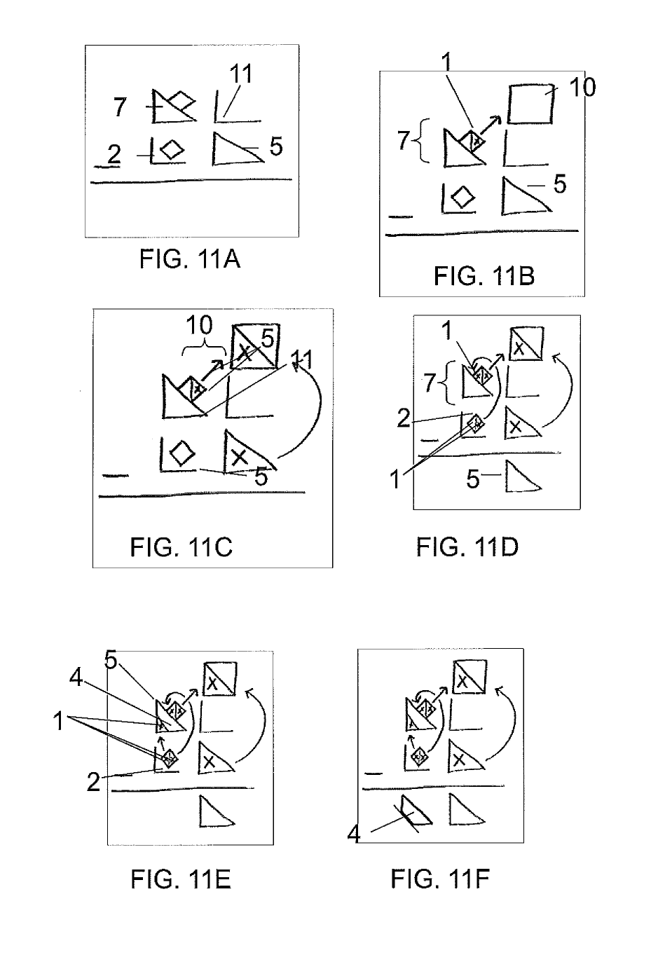

Every shape in SHAPE MATH® can be broken down into one triangles 1a (see FIG. 11B) which represent the quantity of 1. For example, ten shape 10e is made out of 10 one triangles 1a and the zero spacers (see FIG. 2).

One of the purposes of the zero spacers (see FIG. 2) is to allow ten equally sized right triangles (ten one triangles 1a) to be compiled into a square (ten shape 10). A square is easy to visualize and without the spacers, a square could only be made from differently sized one triangles 1a. The zero spacers are also used to fit other numbers into the ten square 10 and assist in visual tracking (which is hard for dyscalculics and dyslexics) by separating inner and outer shapes. The zero spacers represent the number 0 if you rearrange them into an L shape 11b (see FIG. 1B).

### Shape Colors

Having the shapes to each be different colors can also be used to further enhance understanding and manipulating the shapes to perform operations. The primary purpose of color or shading differences is to assist the student in distinguishing the numeric shapes. In a preferred embodiment, the SHAPE MATH® numbers and colors are: 1 blue, 2 green, 3 yellow, 4 orange, and 5 red. Scientifically, blue is a warmer color than red but in the preferred embodiment, the colors ascend according to the scale of cultural subjective perception. Cool objects from everyday life tend to be blue and thus blue falls on the cool end of this spectrum. This is the opposite of red which typically signifies that something is hot, such as a flame. Thus, red falls on the hot end of this spectrum. The intuitively ascending colors are easier to remember and to visualize. However, the present invention is not limited to this or any other particular color scheme.

### Inner and Outer Shapes

It is important to note that some SHAPE MATH® numbers can have different forms which are labeled either inner or outer. An outer shape, when arranged into a ten shape, touches its border. An inner shape, when arranged into a ten shape, is entirely surrounded by other shapes. The inner six is an exception to this rule and the specifics of this will be addressed later in the document.

### Numbers 1-5

The following section explains some of the important details about SHAPE MATH® numbers below 5; see FIG. 3.

The inner four shape 4f can be made by combining 2 two shapes 2a (shown in FIG. 11B). Inner 4 shapes are typically 4e and when placed within the ten square, they are always surrounded by other shapes such as the 2 outer three shapes 3b seen in ten shape 10c.

The outer four shape 4b (see FIG. 1B) is composed of a two shape 2a, 2 one triangles 1a and two zero spacers as seen in four shape 4c. It is larger only because of the zero spacers. It is important to put the zero spacers in when forming the outer four shape so that it lines up with other shapes within the square ten shape.

The inner three shape 3d and outer three shape 3b (shown in FIG. 1B) follow the same rules of nomenclature that were previously applied to the inner and outer four shapes.

### Numbers 6-10

At this point, SHAPE MATH® numbers 1-5 have been introduced and briefly explained. The following are various examples of SHAPE MATH® numbers 6-10 and how they are made by combining numbers 1-5. While this section does not exhaust all possibilities, it shows some of the more common ways of compiling the larger digits.

Six shape 6b is made with 2 outer three shapes 3b (shown in FIG. 1B) while the equivalent six shape 6c is made from inner three shape 3d and outer three shape 3b. Additionally, six shape 6g is made with five shape 5a and one shape 1a (see FIG. 1B).

Seven shape 7a is made with five shape 5a and two shape 2a while the equivalent seven shape 7b is made with outer three shape 3b and inner four shape 4e (see FIG. 1B). Additionally, seven shape 7c is made with outer three shape 3b and 2 two shapes 2a.

Eight shape 8b is made with 2 four shapes 4b (see FIG. 1B).

Nine shape 9a is made with five shape 5a and four shape 4b (see FIG. 1B).

The ten shape (shown in FIG. 4) can be made out of 2 outer three shapes 3b and 2 two shapes 2a while the ten shape (shown in FIG. 5) can be made out of 2 outer three shapes 3b and four one shapes 1a.

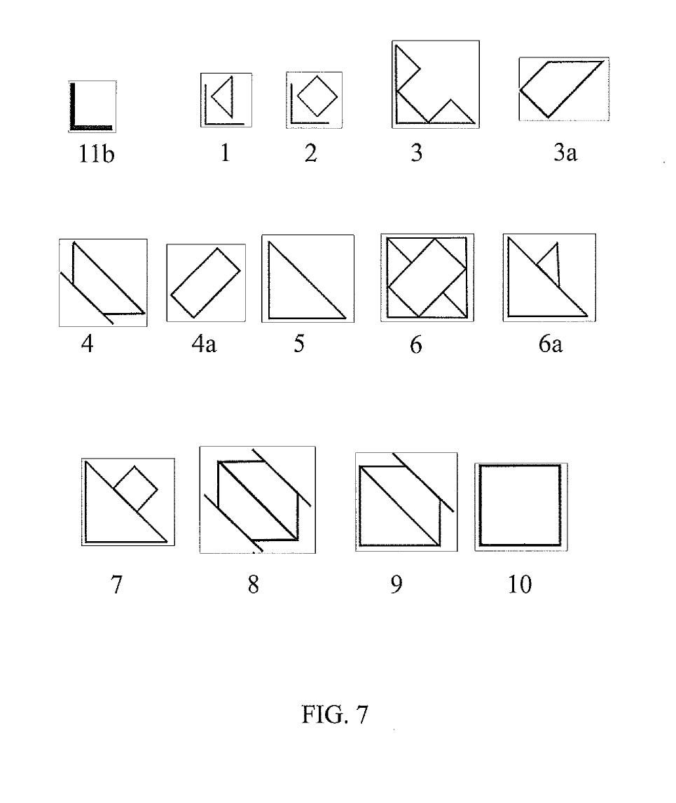

FIG. 6A-6F show examples of various SHAPE MATH® numbers. FIG. 6A is a 3 shape composed of 3 one shapes. FIG. 6B is a four shape composed of a three shape and a one shape. FIG. 6C is a five shape composed of a four shape and one shape. FIG. 6D is a six shape composed of a four shape and two one shapes. FIG. 6E is a seven shape composed of a four shape a one shape and a two shape. FIG. 6F is ten shape composed of a four shape and two three shapes.

### Written Form

The next section will cover the written form of SHAPE MATH® and further explain the zero spacers.

A user of the written form of SHAPE MATH® can complete most of the common operations that are traditionally performed by writing problems with Arabic numerals. Instead of Arabic numerals, however, SHAPE MATH® written numbers are used to express and track the quantities involved. These written SHAPE MATH® numbers, which omit the colors, look very similar to the standard SHAPE MATH® numbers with the exception of the written one shape 1 and written two shape 2 (shown in FIG. 1B). Without color, one shape 1a and two shape 2a could be confused with five shape 5a and ten shape 10a, respectively. Thus, zero spacers are placed around the written one and two shapes to distinguish them from five and ten shapes. Zero spacers are used because they do not represent any value and when oriented against each other into a right triangle, they form the corner of an empty ten shape 11b. Placing the one and two shapes within the context of the corner of a ten shape will distinguish them by showing their relative size to 10. For added distinction, the written one shape 1 and two shape 2 are turned at an angle to make them look different from the written five shape 5 and ten shape 10.

Now turning to FIG. 7 for all of the SHAPE MATH® written numbers which include zero spacers 11b, one shape 1, two shape 2, outer three shape 3, inner three shape 3a, outer four shape 4, inner four shape 4a, five shape 5, outer six shape 6, inner six shape 6a, seven shape 7, eight shape 8, nine shape 9 and ten shape 10.

The lines on the written eight shape 8 and nine shape 9 are extended to exaggerate the specific qualities of their shape and make them different from the written ten shape 10 when handwriting is naturally sloppy. If a user of the system gets the written outer four shape 4 confused with other numbers, they can add an extended line like in the case of the written eight shapes 8 and nine shapes 9.

If someone using the system gets confused by the negative space inside of the written outer six shape 6 they can cross out the center. This will make sure they do not think there is a written four shape 4a in the center, which would indicate the quantity of ten.

### Addition

The following section will explain the basics of mental SHAPE MATH® addition using several examples. The process described is also how a student would use the SHAPE MATH® pieces, a learning tool that will be described later in the document.

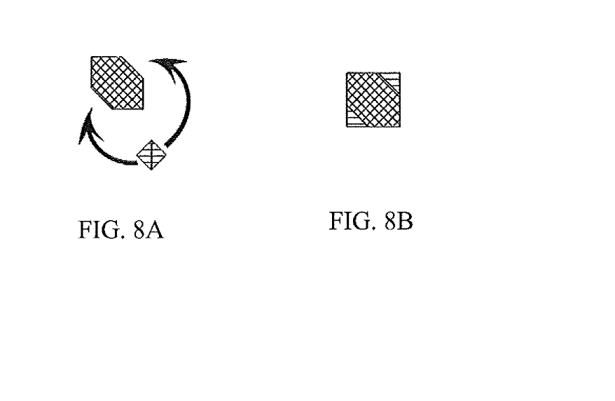

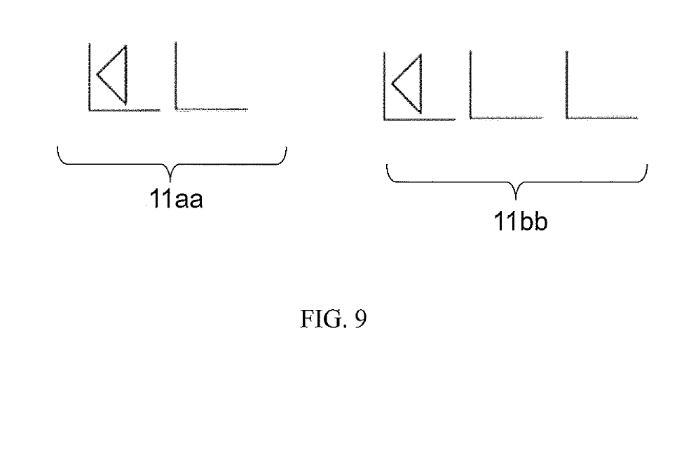

For the problem 8+2 eight shape 8a and 2 one shapes 1a can be visualized and the one shapes placed on each flat corner of the eight shape 8a (see FIG. 8A). This arranges the addends (8 and 2) of the addition problem into a ten shape 10a (see FIG. 8B).

For the problem 5+2=7 five shape 5a and 2 shape 2a can be visualized and combined to create the mental image of seven shape 7a (see FIG. 1B).

For the problem 3+4 outer three shape 3b and inner four shape 4e can be visualized and combined to create the mental image of seven shape 7b (see FIG. 1B).

For the problem 7+3 seven shape 7a and outer three shape 3b are combined to make ten shape 10e (see FIG. 1B).

For the problem 3+3+4 outer three shape 3b can be combined with another outer three shape 3b to create six shape 6b (see FIG. 1B). Then, inner four shape 4e can be imagined in the empty space within six shape 6b to create ten shape 10c (see FIG. 1B).

In SHAPE MATH®, the completion of very basic addition problems is no different than the creation of larger numbers from base numbers and very little memorization is required.

### Written SHAPE MATH® and Place Value

The next section outlines the specifics of written SHAPE MATH® addition using a place value system that allows SHAPE MATH® users to work with larger numbers.

Place value is when a numbers place within the context of another number determines that digits worth. The 1 in the number 10 represents ten things while 1 in the context of 100 represents one hundred things. Similarly, in SHAPE MATH®, a one shape 1 followed by a zero shape 11 seen in place value representation 11aa (shown in FIG. 9A) represents the quantity of ten while a one shape 1 followed by 2 zero shapes 11 shown in place value representation 11bb (seen in FIG. 9B) represents the quantity of one hundred.

The following section will demonstrate the use of the place value system in SHAPE MATH® as it applies to larger addition and subtraction problems. When using a place value system, one can perform mathematic operations at a specific place value at a time. These place values are organized into columns in both standard math and SHAPE MATH®. Since each column in a ten based system can hold only the numbers 1-9, one can use the SHAPE MATH® techniques for basic addition to complete the math necessary for each column. Instead of memorizing the sums of all possible combinations of digits in each column, a SHAPE MATH® user can apply the mechanical principles of basic SHAPE MATH® addition to find the sums of those columns. When the sum of the ones column is ten or greater, that ten shape must be carried to the next column were it is expressed with a one shape. To perform the basic operations within each column, someone using SHAPE MATH® would draw arrows to track the movement of the shapes being combined, redraw those shapes at the ends of the arrows and then cross off the original location of the relocated shapes.

The following example demonstrates this process.

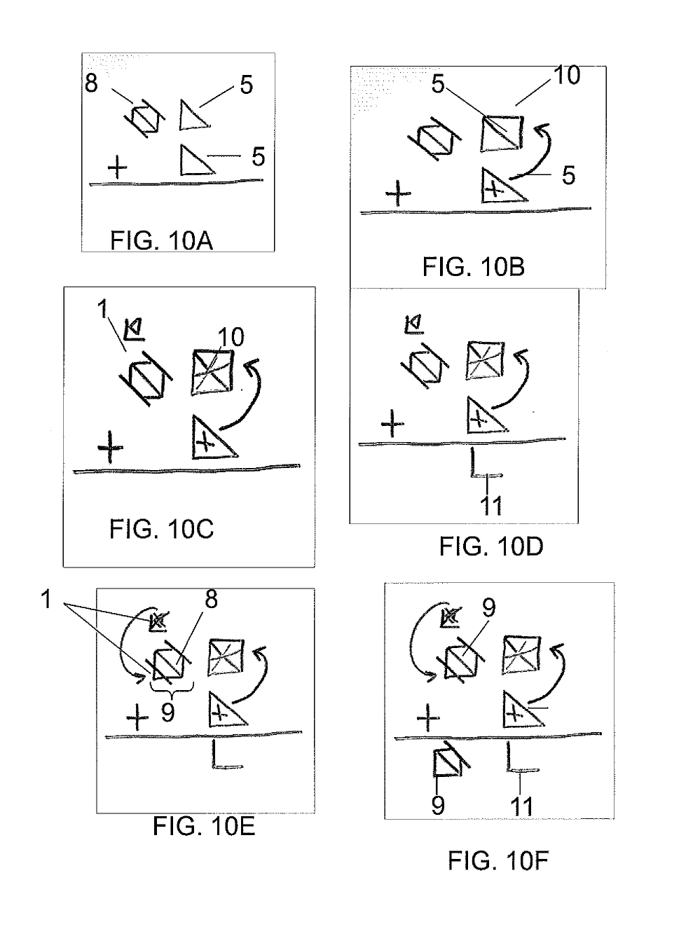

FIGS. 10A-F shows the addition problem 85+5. The first step of the method, seen in FIG. 10A, is to express the problem with SHAPE MATH® numerals using eight shape 8 in the ten's place (or left column) and five shape 5 in the one's place (or light column), both in the top row, to form 85 and five shape 5 in the one's place of the bottom row to represent the quantity of 5. The next step, shown in FIG. 10B, is to draw an arrow to take the lower five shape 5 and add it to the upper five shape 5 to form a ten shape 10. The lower five shape 5 is then crossed out. The next step, shown in FIG. 10C, is to cross out the ten shape 10 from the one's place (or right column) and carry that quantity to the ten's place (or left column) where it becomes a one shape 1. A zero shape 0 is then placed in the one's column (right column) of the answer row as seen in FIG. 10D because everything in the one's column has been crossed out. The next step, shown in FIG. 10E, is to add the 1 and the 8 of the ten's column. This is done by drawing an arrow from one shape 1 to eight shape 8, crossing off one shape 1 and re-drawing one shape 1 at the end of the arrow to make the eight shape 8 into a nine shape 9. In the final step, shown in FIG. 10F, nine shape 9 of the ten's column is brought down to the answer row. Together, the nine shape 9 and zero shape 11 of the answer row represent the quantity of 90, which is the solution to the problem.

Now, turning to FIGS. 11A-F for the subtraction problem 70−25. Like the previously explained addition problem, the first step of the method is to express the problem with SHAPE MATH ®™ numerals as shown in FIG. 11A using a seven shape 7 in the ten's place (or left column) and a zero shape 11 in the one's place (or right column) of the minuend (top row), to form 70 and a two shape 2 in the ten's column (left column) and a five shape 5 in the ones column (right column) of the subtrahend (bottom row) to form 25. Since five shape 5 of the one's column of the bottom row is greater than the zero shape 11 of the ones column of the top row, the quantity of ten must be borrowed from the ten's column. This is done by crossing out a one shape 1 from the seven shape 7 of the tens column, drawing an arrow from that one shape 1 to the space above the zero shape 11 in the one's column and drawing a ten shape 10 at the end of the arrow as demonstrated in FIG. 11B. The next step is subtracting five shape 5 from the borrowed ten shape 10. To do this, an arrow is drawn from five shape 5 to ten shape 10 and the ten shape 10 is divided into two five shapes 5. The five shape 5 from the bottom row is crossed off along with one of the five shapes 5 of the top row as demonstrated in FIG. 11C. The uncrossed shapes of the ones column can then be totaled and moved to the answer row. In this example, a five shape 5 remains and is drawn in the answer row as shown in FIG. 11D. The next step is to subtract the ten's column of the bottom row from ten's column of the top row. To do this, the two shape 2 of the bottom row is divided into 2 one shapes 1. An arrow is then drawn from one shape 1 of the bottom row to one shape 1 of the top row and both one shapes are crossed off as demonstrated in FIG. 11D. This step only subtracts the first one shape 1 of the bottom row. The next one shape 1 of the bottom row is subtracted by crossing it off, dividing the five shape 5 from the top row into a four shape 4 and a one shape 1, and crossing off the one shape 1 created by this division as demonstrated in FIG. 11E. Next, the uncrossed shapes of the tens column can be added for a total of 4, which is expressed as a four shape 4 in the answer row of the tens column to complete the answer of 45 as seen in FIG. 11F.

### Patterns

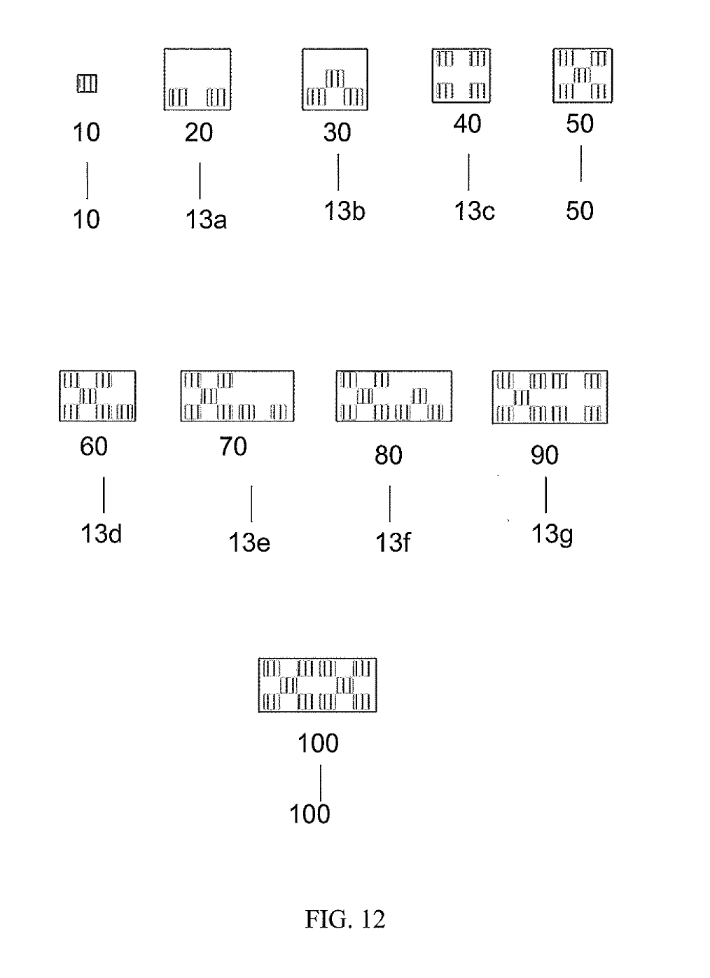

The next section introduces the patterns of ten shapes (referred heretofore as ten shape patterns) used to represent multiples of ten. The fifty pattern 50a (shown in FIG. 1B) is the basis of the ten shape patterns. Ten shape patterns below 50 maintain the basic structure of the fifty pattern with the necessary number of ten shapes removed. Ten shape patterns above fifty are combinations of fifty patterns and lower ten shape patterns. The ten shape patterns representing 10 through 100 are (shown in FIG. 12). The X pattern is used to represent 50 because X is easy to visualize mentally and the corners of each cube touch the corner of the center cube which creates negative space to distinguish each cube from the other. The ten shape patterns are used to complete addition and subtraction problems for multiples of ten using a system of direct representation instead of a place value.

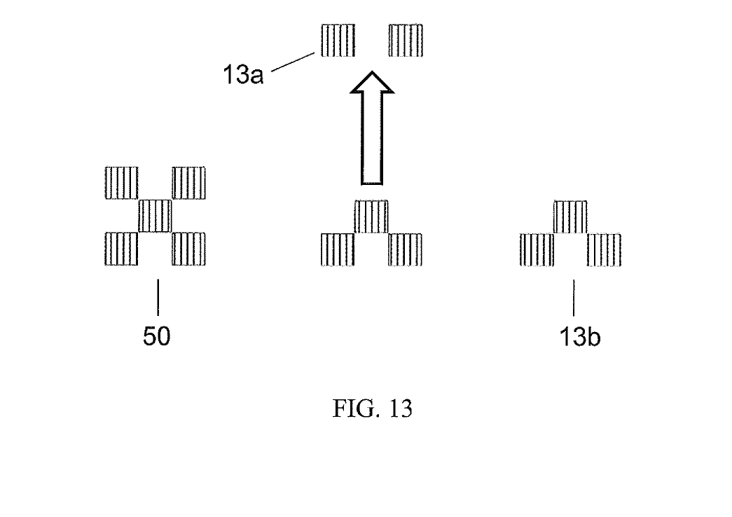

For the problem 50−20 (see FIG. 13), a SHAPE MATH® user will first imagine a fifty pattern 50. The user will then imagine removing a twenty pattern 13a, leaving a 30 pattern 13b.

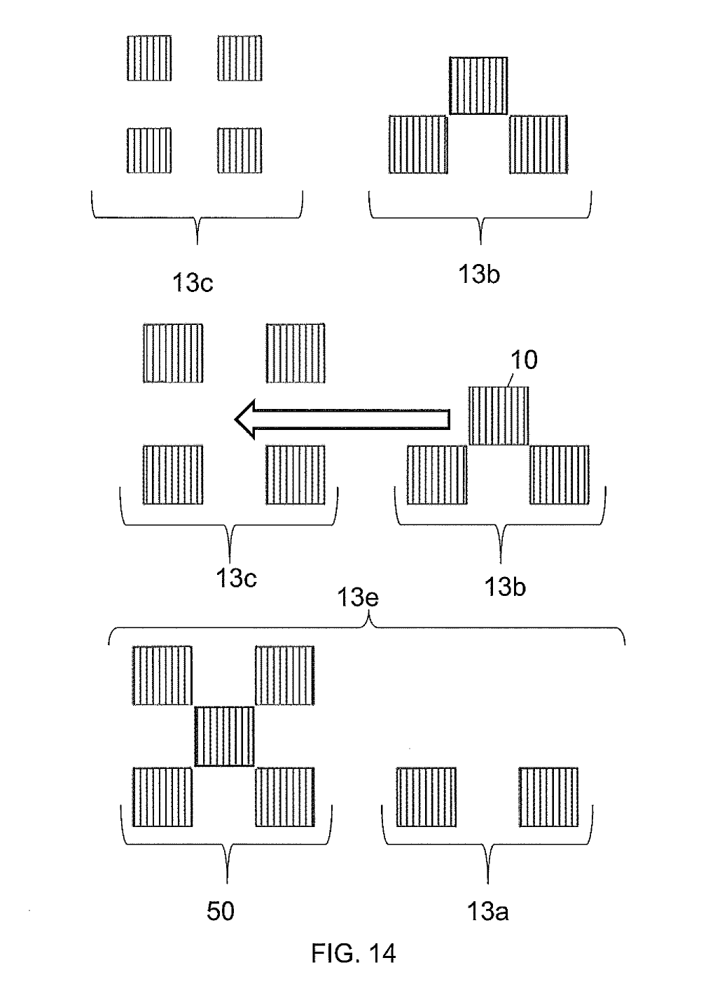

For the problem 40+30 (see FIG. 14), a SHAPE MATH® user will imagine both a 40 pattern 13c and a 30 pattern 13b arranged side by side. Then the user will imagine sliding the top ten shape 10 of the 30 pattern 13b into the center space of the 40 pattern 13e. The result is a 50 pattern 50 next to a 20 pattern 13a, which together constitute a 70 pattern 13e, the answer to the problem. Because the basic structure of the fifty pattern is maintained, mentally manipulating the pieces is both easier and results in recognizable patterns.

### Mental SHAPE MATH® Not Divisible By Ten

The next section will explain SHAPE MATH® addition of larger numbers not divisible by ten while using direct representation instead of the place value system. While the previously described written form of SHAPE MATH®, which does rely on a place value system, allows users to do problems of any size, it is very difficult to do mentally because you have to keep track of a lot of things in your head at one time. On the other hand, direct representation allows users to visually regroup the quantities involved without worrying about their place values. Because of this, each shape always maintains the same value throughout the completion of the problem and is easier to track and manipulate. A SHAPE MATH® user will begin by constructing the problems using both ten shape patterns and SHAPE MATH® numerals. In the case of addition, the numbers below ten will be combined into ten shapes which will then be placed within the structure of the 50 pattern to make their final sums easily recognizable.

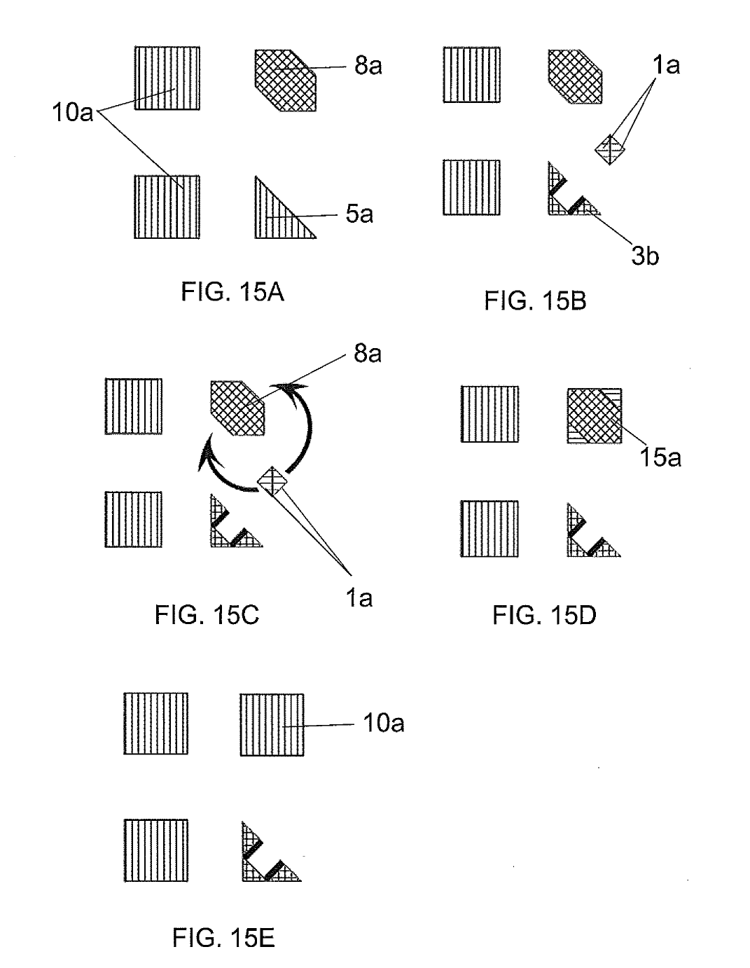

For the problem 18+15 (see FIGS. 15A-E), a student will imagine a ten shape 10a and an eight shape 8a to represent 18 and a ten shape 10a and a five shape 5a to represent 15 as demonstrated in FIG. 15A. It is important to note that the SHAPE MATH® numerals are being arranged into the structure of the ten shape patterns. The next step is to combine any shapes less than ten into ten shapes. First, the five shape 5a from addition representation 14a is divided into a three shape 3b and 2 one shapes 1a as demonstrated in FIG. 15B. Next, the one shapes 1 are moved to either side of the eight shape 8 as shown in FIG. 15C to complete ten shape 15a which is shown in FIG. 15D. A user will then convert the ten shape 15a of fourth addition representation 14d to the standard red ten shape 10a, to complete the mental image shown in FIG. 15E. At this point, the SHAPE MATH® numerals are in standard form and arranged into the ten shape pattern structure, making the final quantity of 33 easily recognizable to some with practice using the SHAPE MATH®.

### Multiplication of Lower Numbers

The next section will introduce the principles behind SHAPE MATH® multiplication for lower numbers. The goal when multiplying lower numbers is to rearrange the SHAPE MATH® numbers into groups of 5 or 10 so their quantities can be visualized easily. This is done by mentally placing instances of the multiplied shape within a ten shapes.

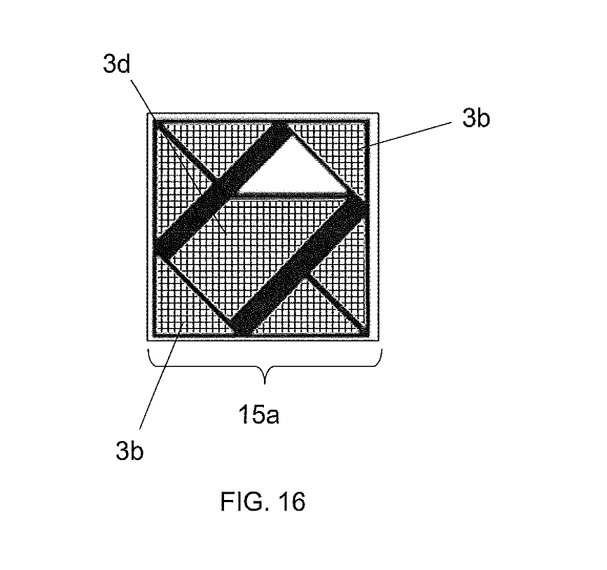

For the problem 3×3, shown in FIG. 16, a student would imagine an outer three shape 3b, then a second outer three shape 3b to form the outline of a six shape 6b, then an inner three shape 3d within six shape 6b so that the user imagines nine shape 15a.

### Rearrangement

The next section will explain the first SHAPE MATH® multiplication technique: rearrangement. Rearrangement, which was just demonstrated in its simplest form, involves moving some of the shapes to make the product of multiplication problems more recognizable.

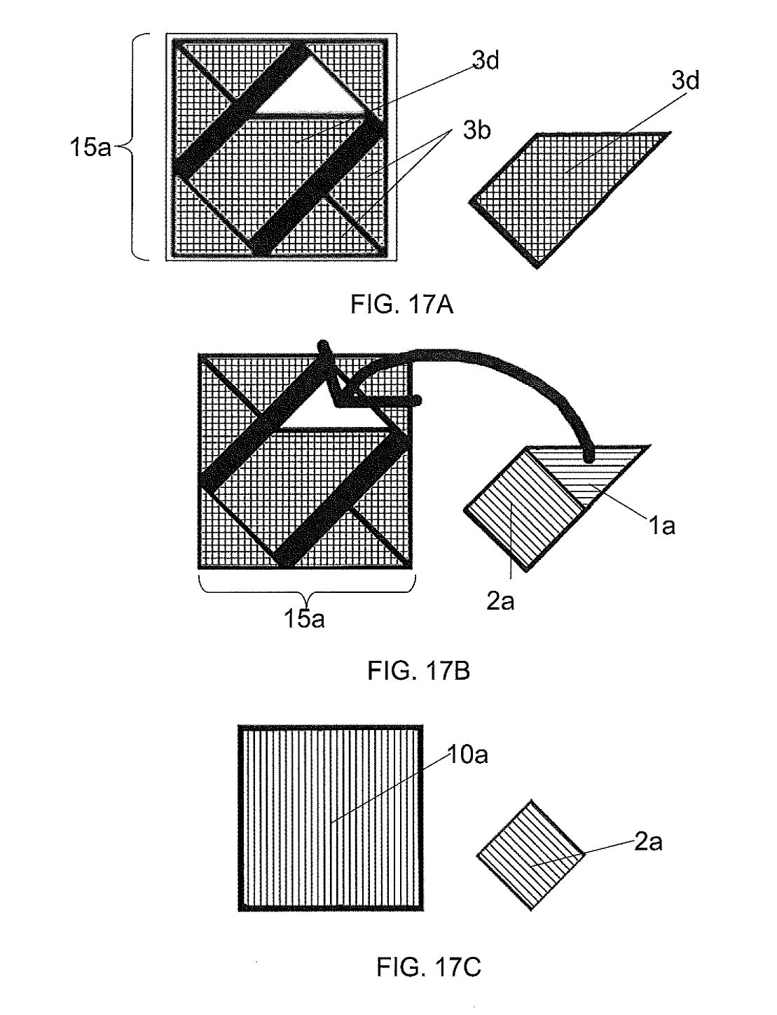

For the problem 3×4, (shown in FIGS. 17A-C) which has a product greater than ten, the student will first visualize 4 three shapes, making sure to place as many three shapes as possible within the outline of a ten shape. The first 3 three shapes are imagined as nine shape 15a and consist of 2 three shapes 3b and one three shape 3d while the 4th three shape 3d is imagined by itself as shown in first FIG. 17A. FIG. 1B shows three shape 3b when separated from other shapes. In the next step, shown in FIG. 17B, the isolated inner three shape 3d (from above) is divided into a two shape 2a and a one shape 1a. Then, the one shape 1a is moved into the empty space within shape 15a. When all the space within the outline of shape 15a has been filled, it can now be imagined as standard ten shape 10a shown in FIG. 17C. After the one shape has been moved, only the two shape 2a remains next to ten shape 10a so that the quantity of 12 can be easily recognized.

### Counting Onward

The next section will explain the second SHAPE MATH® multiplication technique: counting onward. This technique involves counting the ten or five shapes and then tallying what is left over. If the rearrangement technique has already been properly applied, the left over quantities from counting onward will be minimal.

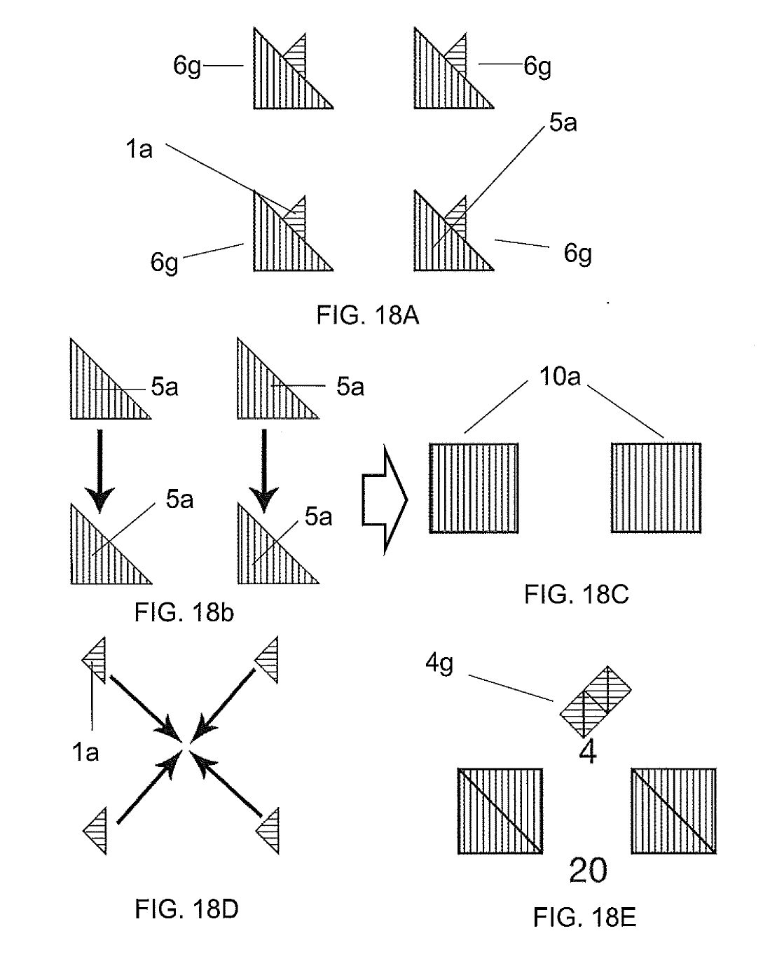

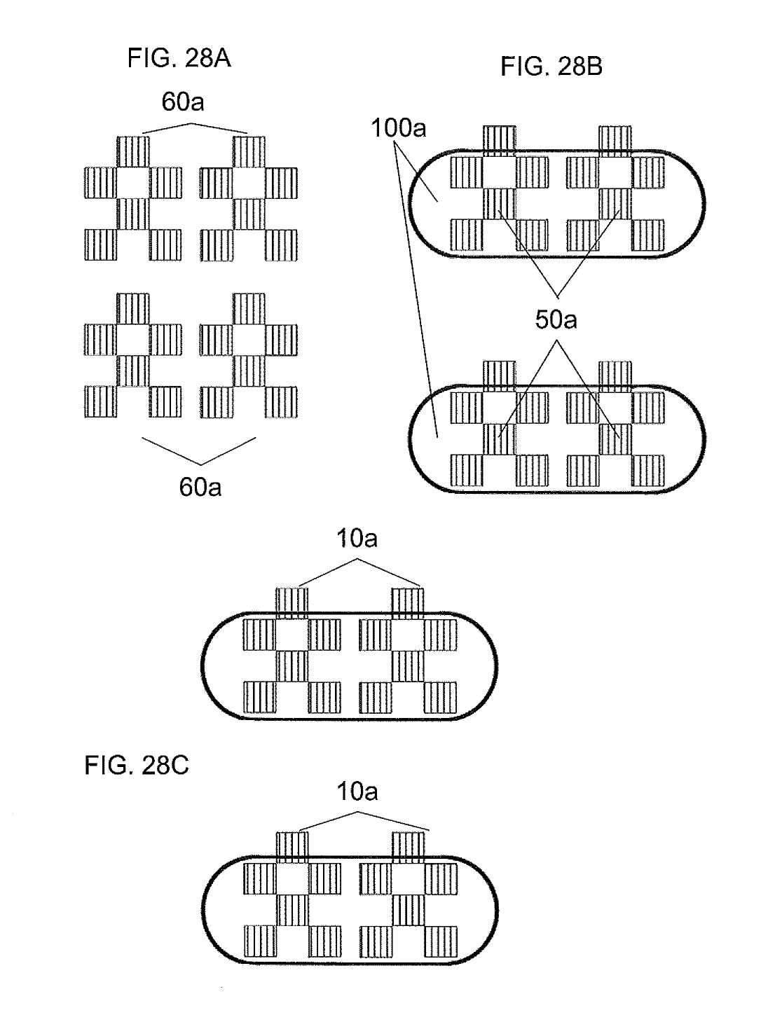

For the problem 6×4 (shown in FIGS. 18A-E) the student would imagine 4 six shapes 6g arranged into the context of a ten shape pattern as seen in FIG. 18A. It is important to note that shapes are almost always imagined in the context of this pattern if the quantities allow it. Imagining them this way makes them easier to visualize and remember and gives a basic structure to their arrangement that can remain consistent throughout various multiplication techniques that may be applied to a single problem. When applying the technique of counting onward to this problem, a student would first count the five shapes 5a, for a total of 4, which should be easily recognized as the quantity of twenty when the images are mentally placed into a ten shape pattern as shown in FIG. 18B (ignore arrows for now). If is easier to visualize, one would combine the five shapes 5a from 16b into 2 ten shapes 10a, the results of which are shown in FIG. 18C. The student could also count by fives for each five in the pattern; five, ten, fifteen, twenty. After the fives are counted, the one shapes 1a shown in FIG. 18D can then be counted (effectively rearranged), totaling 4 in this case and represented by four shape 4g from FIG. 28E, which is easily recognizable as the quantity of 24.

### Subtraction

The next section will explain the third SHAPE MATH® multiplication technique: subtraction. This technique is used when one of the multipliers is 8 or 9. A student will complete the problem as if the 8 or 9 shapes are actually ten shapes. Then, the student would count the shapes that had to be added to the 8 or 9 shapes and subtract that total from the product created by completing the problem as if they were ten shapes. See FIG. 11B for representations of eight shapes, nine shapes, and ten shapes.

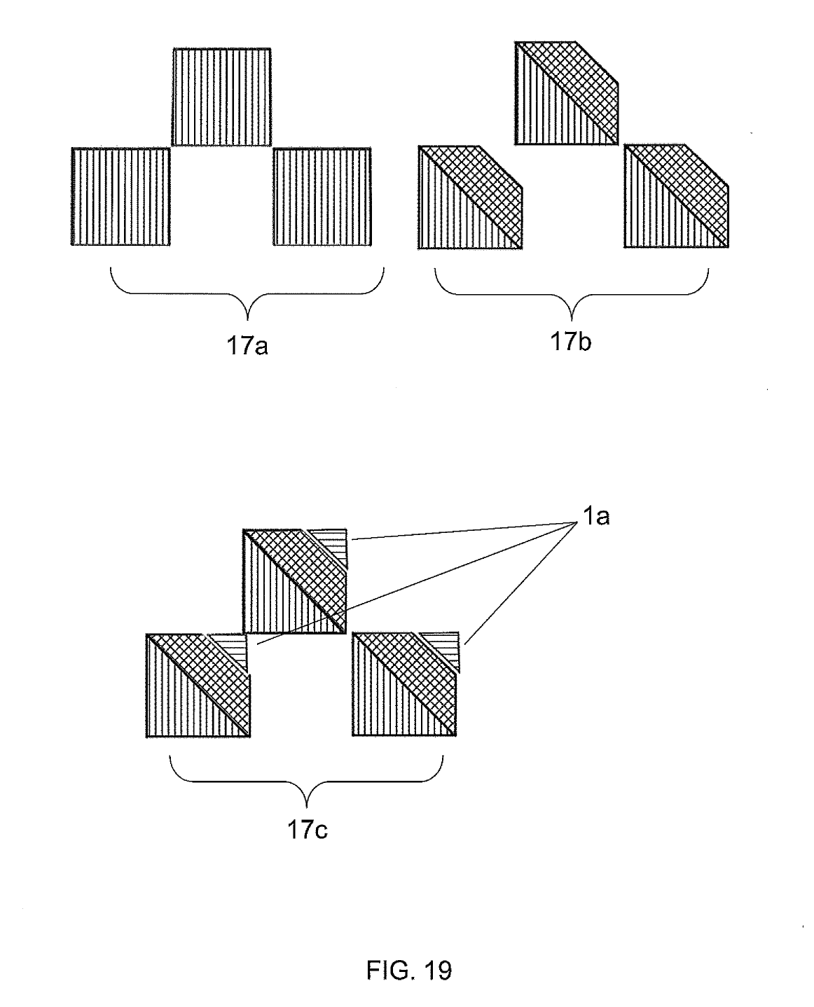

For the problem 3×9, (shown in FIG. 19) a student would create the problem 3×10 by imagining 3 ten shapes 10a as a thirty pattern as shown in first multiplication representation 17a. Then, the student will convert the ten shapes 10a into 9 shapes as shown in second multiplication representation 17b. In order to convert the ten shapes 10a into nine shapes 9a, a one shape 1a had to be removed from each ten shape 10a. These one shapes 1a are visually represented in third multiplication representation 17c, and total 3, which will be obvious to any student creating this mental image. The quantity of 3 is then subtracted from the quantity of 30 using techniques from the subtraction section and the answer of 27 is calculated.

### Splitting

The next section will explain the fourth SHAPE MATH® multiplication technique: splitting. When working with multiplication problems such as 5×6 or higher, a dyscalculic will not have the working memory to employ only the rearrangement and counting onward techniques. Splitting allows SHAPE MATH® users to divide larger multiplication problems into two smaller problems.

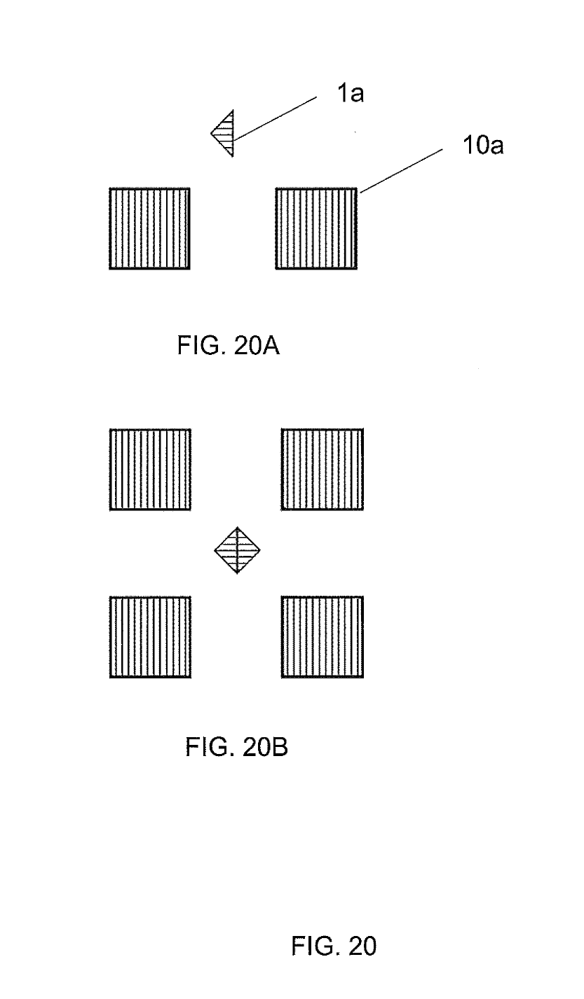

The problem 6×7 can be broken down into 2 instances of the problem 3×7. The sub-problem 3×7 can be solved more easily and its answer can then be added to itself to find the answer to 6×7. When possible, it is best to split the even multiplier of a multiplication problem. This is because even numbers can be split evenly and easily. One could complete the problem 3×7 in several ways using the previous multiplication techniques. If the student works within the ten shape pattern, the answer to 3×7, shown in FIG. 20A, will be composed of 2 ten shapes 10a and 1 one shape 1a. To add this quantity to itself (or double it), a student can imagine a second instance of the mental image for 21 seen in FIG. 20A and then slide both instances together to form the pattern shown in FIG. 20B, which is easily recognizable as a representation of the quantity of 42.

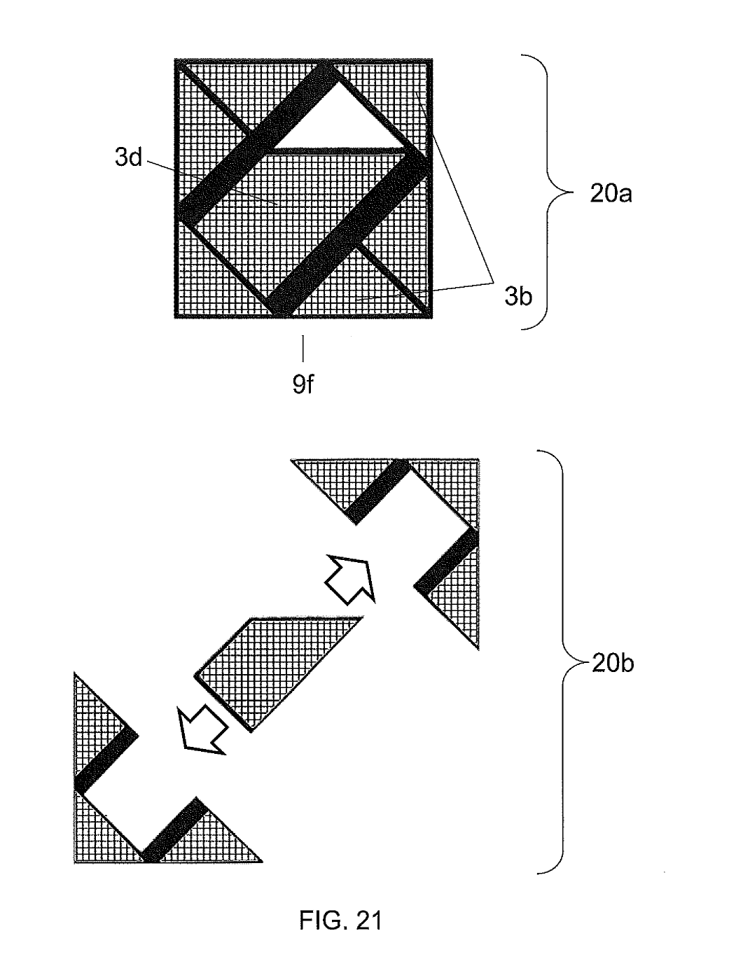

Some larger problems require special techniques to complete. The problem 9×9, for example, contains no even multipliers. Instead of splitting the 9's in half, they must be broken into thirds. In order to do this, a SHAPE MATH® student will first imagine the nine shape 9f from first multiplication representation 20a (shown in FIG. 21). This nine shape 19a is composed of 2 three shapes 3b and 1 three shape 3d for a total of 3 three shapes. A student can move the mental images of these shapes apart to visually represent the division of a nine shape into 3 three shapes, a process demonstrated in second multiplication representation 20b.

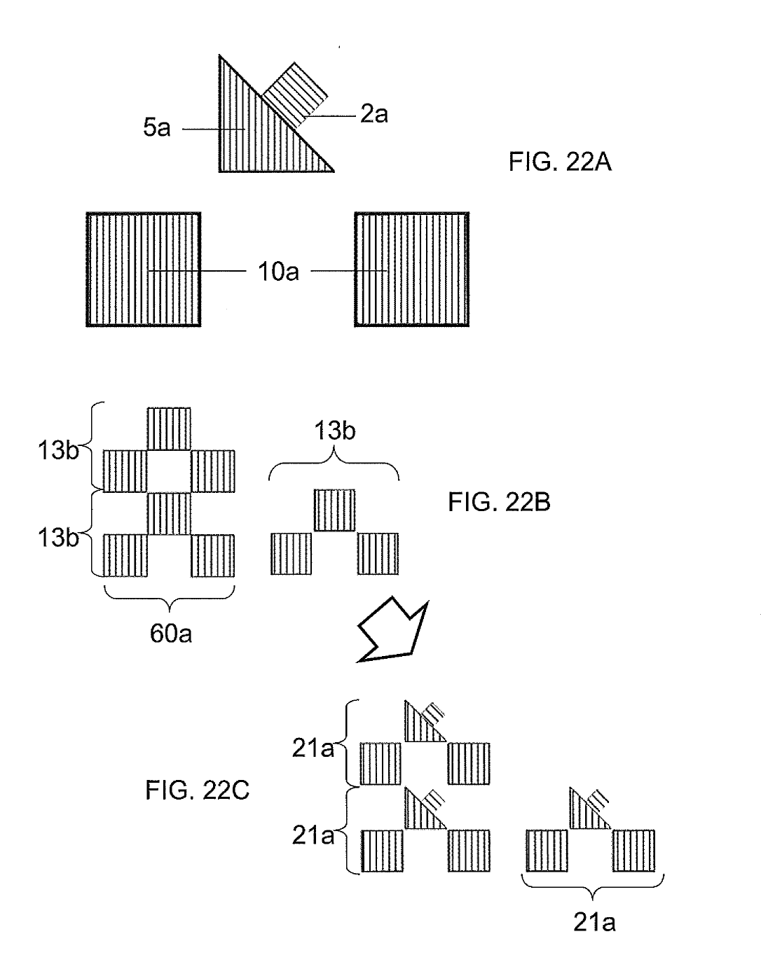

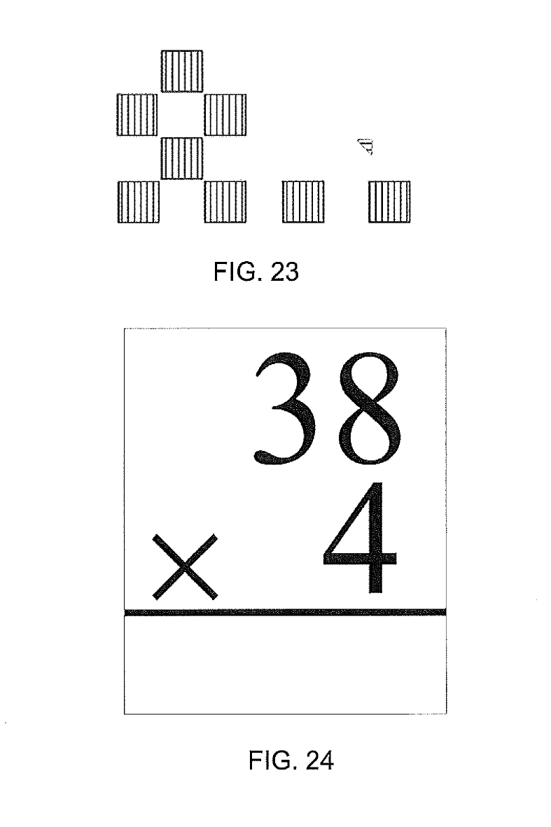

Once the 9 has been broken into 3's, one can complete the simpler problem of 3×9 and triple the answer. The earlier SHAPE MATH® techniques are sufficient to find that 3×9=27. However, adding together 3 instances of 27 can be confusing and may require too much working memory to use only the addition techniques from earlier sections. In order to find the answer to 27+27+27, a SHAPE MATH® user must be familiar with 60 base operations. Much like the ten shapes are single conceptual unit that represents the quantity of ten, a 60 pattern 60a (shown in FIG. 1B) is a single conceptual unit that represents the quantity of 60. In the context of this problem, a SHAPE MATH® user will first arrange the quantity of 27 into 2 ten shapes 10a, a five shape 5a and a two shape 2a to make a 27 pattern shown in FIG. 22A. The user will then create a mental image of three 27 patterns 21a within the context of a 90 pattern shown in FIG. 22B. The 90 pattern 21b uses the 60 base system described earlier and is composed of a 60 pattern 60a and 30 pattern 13b. When the user replaces the thirty patterns 13b with 27 patterns 21a, the mental image from FIG. 22C is created. Imagining the 27 patterns 21a within the 90 pattern 21b helps to simultaneously visualize all the shapes involved because they are placed within the context of larger conceptual units. Once the user has imagined the pattern from FIG. 22C, they can use the subtraction technique of multiplication explained earlier to determine that 1 three shape 3b (see FIG. 1B) is missing from each thirty pattern, for a total of 3 three shapes. These 3 three shapes can be compiled into a 9 shape 20a (shown in FIG. 21) using the addition techniques described earlier. This nine shape can then be subtracted from the 90 pattern shown in FIG. 22B so that the user has the mental image (shown in FIG. 23), which can be recognized as the quantity of 81. This process may seem complicated to someone already familiar with standard math, however, it easier for a dyscalculic to perform these steps than to memorize nearly 100 solutions to 100 problems. Each step in the process follows a logical progression that manipulates shapes within conceptual units that are easy to visualize and group together.

### Place Value Multiplication

Once the techniques for completing times tables up to 9×9 are learned, a SHAPE MATH® user can apply them within the place value system of standard math in order to complete larger problems. For example, FIG. 24 shows the problem of 38×4 as it would be seen in standard math. The previously described techniques can be used to multiply 4×8 and 4×3 to complete the basic multiplication needed when completing the problem within the structure of standard math. The problem is not demonstrated with a figure including SHAPE MATH® numbers because the process can be completed by applying the previously explained multiplication techniques to the structure of multiplication seen in standard math.

### Time Conversion

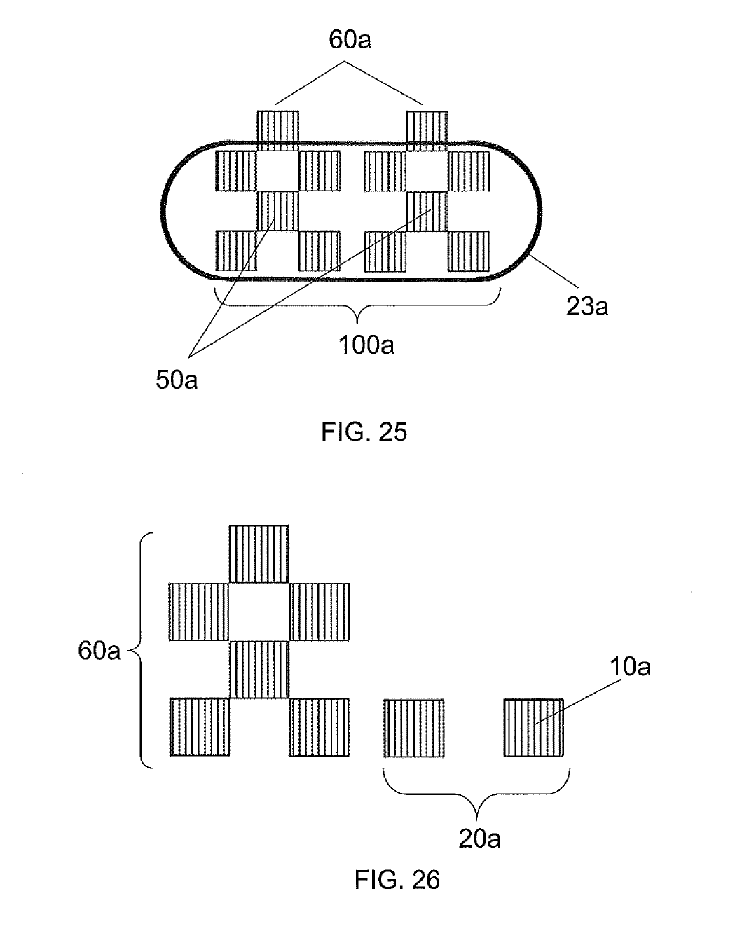

Now, turning to FIG. 25, the next section will demonstrate how SHAPE MATH® is applied to converting units of time (seconds, minutes, hours). Because the system of time has a base of 60, the 60 pattern 60a is used to express minutes or hours. If the 60 pattern 60a expresses an hour, then each ten shape 10a within the pattern expresses ten minutes, for a total of 60 minutes. Similarly, when a 60 shape 60a is used to express one minute, each ten shape 10a within the pattern expresses 10 seconds for a total of 60 seconds. The 60 shapes are easy to visualize in groups because each 60 pattern 60a contains a fifty pattern 50a (see FIG. 1B), and when those 60 patterns 60a are placed side by side (as shown in FIG. 25), the 50 patterns 50a within them form a 100 pattern 100a, which is separated by outline 23a. One should note that outline 23a exists in this figure purely to clarify which ten shapes 10a compose the 50 patterns 50a. When doing time conversation within the 60 pattern structure 60a, a SHAPE MATH® user will count the number of ten shapes 10a and add a zero to that total to calculate out how many minutes are represented.

### Minutes to Hours

To convert 80 minutes into hours, the minutes are expressed as 8 ten shapes 10a and placed according to the convention of the 60 pattern to create the mental image shown in FIG. 26. The first 6 ten shapes 10a make up a 60 pattern 60a and the remaining 2 ten shapes 10a make up a 20 pattern 20a. Conceptually, a SHAPE MATH® user will realize that the 60 pattern 60a represents one hour and the 20 pattern 20a represents the remaining 20 minutes, for a total of 1 hour and 20 minutes.

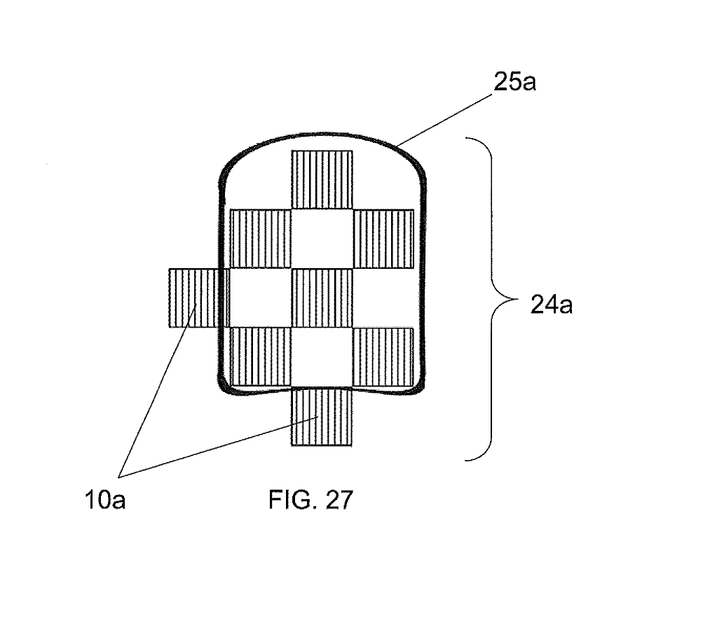

Another way of completing this problem is creating the mental image of an 80 pattern 24a (shown in FIG. 27). The user will mentally distinguish the 60 pattern (separated by outline 25a) from the remaining 2 ten shapes 10a for a total of 1 hour and 20 minutes.

### Hours to Minutes

In order to convert hours to minutes, the ten shapes are totaled by conceptually separating the 50 patterns 50a, grouping them into 100 patterns (if necessary) and tallying the remaining ten shapes 10a. For example, to convert 4 hours into minutes (a process shown in FIGS. 28A-C), a student would first create the mental image of 4 sixty patterns 60a as seen in FIG. 28A. Then, the fifty patterns 50a are distinguished and grouped into 2 one hundred patterns as seen in FIG. 28B. These 2 one hundred patterns 100a represent 200 minutes. The remaining ten shapes 10a, seen in FIG. 28C, are added for a total of 4 and represent 40 minutes, which can be added to the 200 minutes represented by the 100 patterns for the answer of 240 minutes.

### SHAPE MATH® Cube

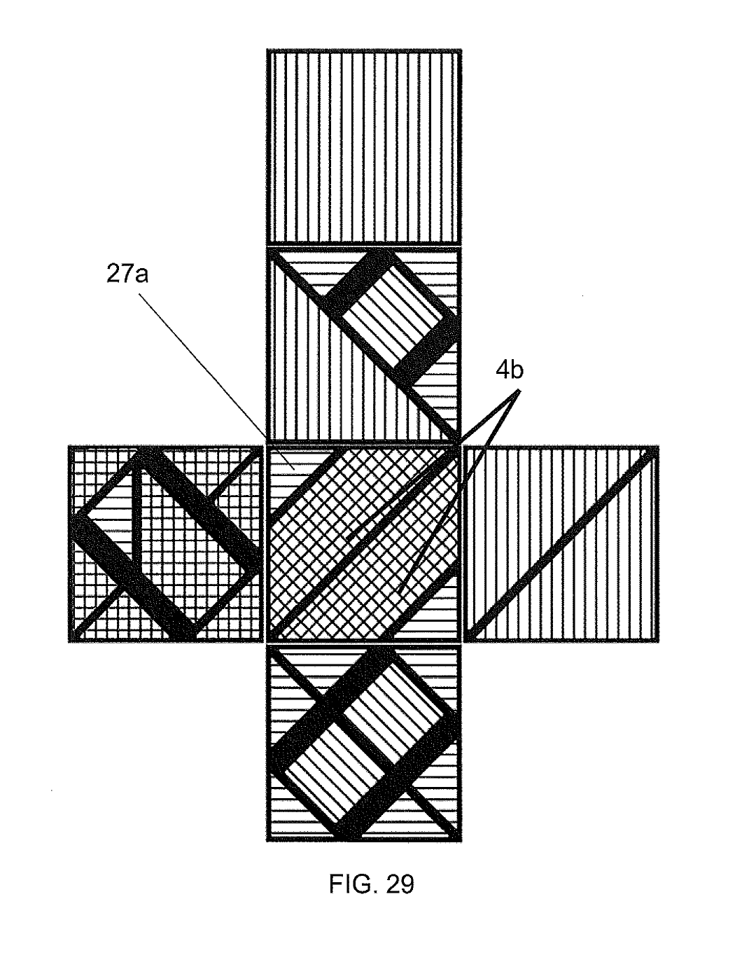

The next section will explain the SHAPE MATH® cube, an instructional tool to aide in learning and operating with SHAPE MATH®. The SHAPE MATH® cube is a physical cube with each side displaying a particular ten shape. FIG. 29 displays the faces of the cube before they are folded. A SHAPE MATH® student can use the SHAPE MATH® cube as a quick reference when there is a need to conceptualize particular ten shapes. For example, if a student needs to conceptualize a ten shape consisting of 2 four shapes, they could quickly browse the cube until their eyes find the four shapes 4b shown on ten cube face 27a. The SHAPE MATH® cube is most useful in division when it becomes necessary to determine the multiples of a number within another number, as well as the quantity that remains after those multiples are determined.

### Mental Division

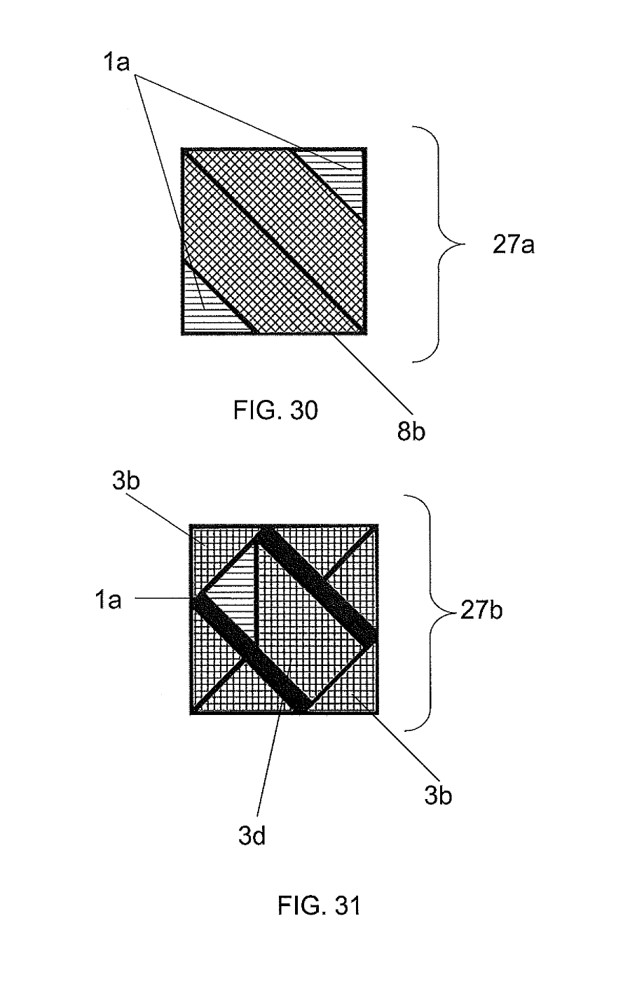

The next section will explain mental division using SHAPE MATH® and the SHAPE MATH® cube. When learning division, a student will start by dividing ten by various numbers, The problem 10÷8 would be solved by first searching the SHAPE MATH® cube for face 27a (shown separately in FIG. 30) which displays an eight shape 8b (compounded from 2 four shapes) and two one shapes 1a. This visual indicates that the quantity of ten contains 1 instance of the quantity of 8 with 2 as a remainder.

Similarly, when calculating 10÷3, a student would first search for cube face 27b (shown in FIG. 31). The 2 outer three shapes 3b and 1 inner three shape 3d can then be counted for a total of 3. The remaining 1 shape is easily recognized as the remainder so that cube face 27b indicates the answer of 3 with a remainder of 1.

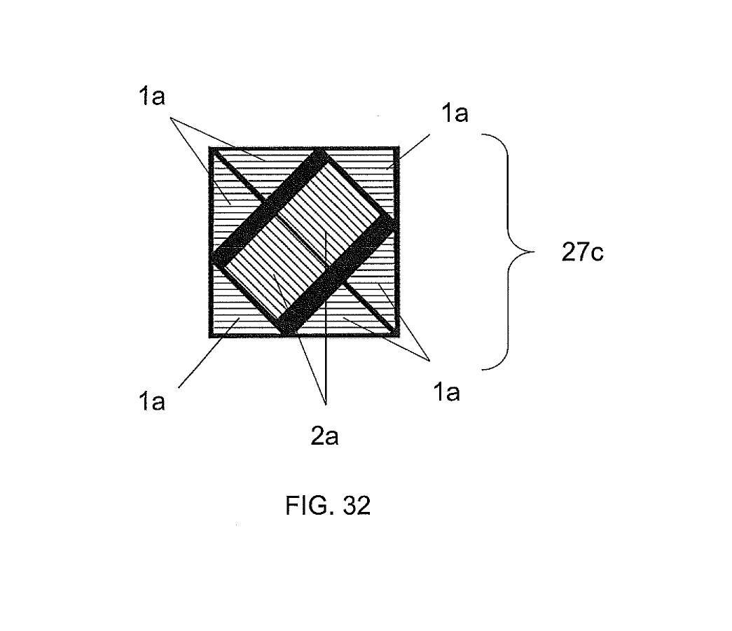

It is important to note that when dividing even numbers by 2, it is easier to divide the shape in half than to visualize and count the 2 shapes within a larger SHAPE MATH® number. For the problem 10÷2, it is easier to visualize ten shape 10a (FIG. 1B) and divide it in half to make ten shape 10b (FIG. 1B) and determine the answer of 5. The alternative is to visualize cube face 27c (shown in FIG. 32) representing ten shape 10d, count the 2 shapes 2a and recognize that the remaining one shapes 1a can be combined to make 3 more two shapes 2d (FIG. 1B) for a total of 5.

When dividing with a divisor (number going into the dividend) larger than ten, a SHAPE MATH® user will visualize the dividend (the number the divisor goes into) and then estimate the quotient (answer). The user will then visually distinguish a number of ten shapes within the dividend that is equal to their estimation of the quotient (answer). Those ten shapes are then combined with smaller shapes from what remains of the dividend in order to convert each ten shape into the quantity of the divisor. The instances of these groupings are then totaled for the answer, with a remainder existing for certain problems. This process may seem extremely confusing; however, an example demonstrates that it is simpler in practice.

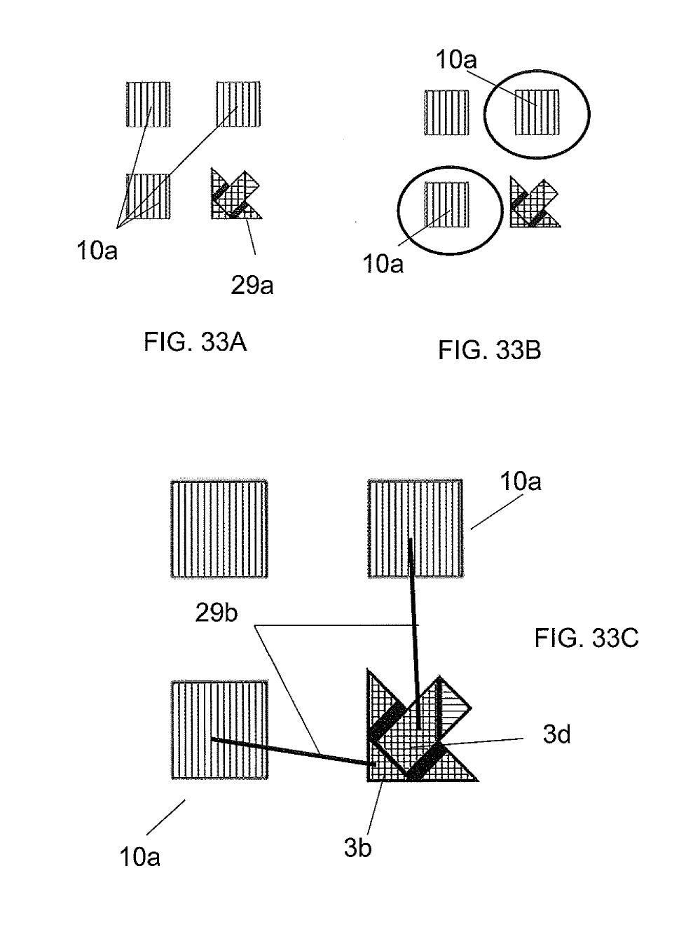

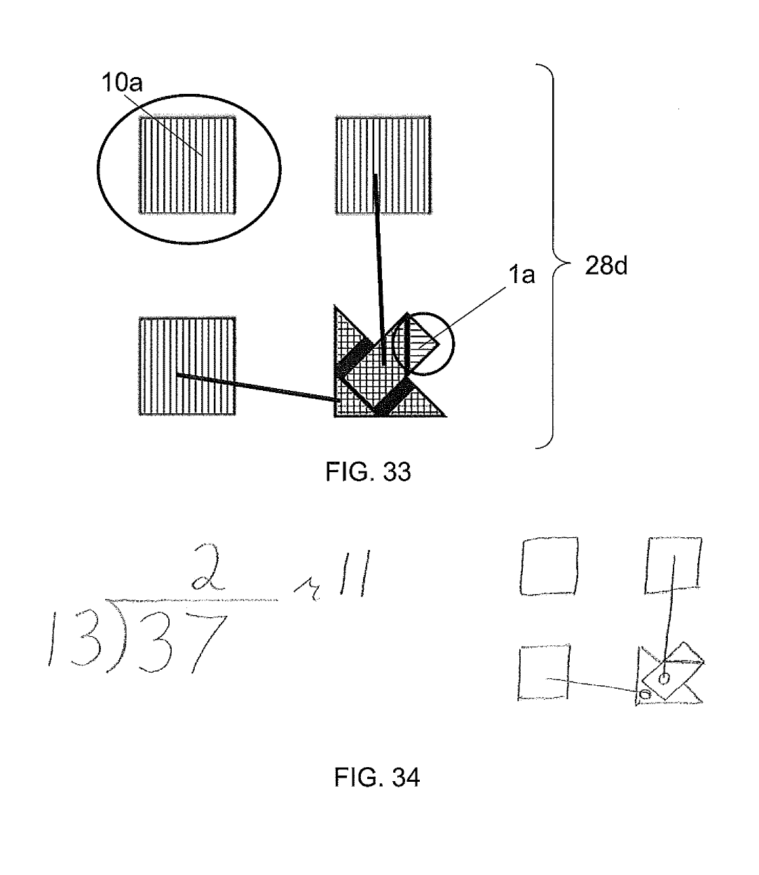

Now turning to FIG. 33 illustrating the completion of 37÷13 (shown in FIG. 33), the basic goal is to isolate ten shapes within the dividend (37) and combine them with left over shapes from that dividend to create instances of the divisor (13). In this problem, the process effectively combines ten shapes with three shapes to find the instances of 13 within 37. One would first draw a thirty seven pattern seen in FIG. 33A and consisting of 3 ten shapes 10a and seven shape 29a. For the purposes of this example, full standard pieces will be used instead of pencil drawings. The next step is to estimate the quotient (answer) and distinguish a number of ten shapes equal to that estimate. In this case, one would most likely estimate that 13 goes into 37 2 times and thus distinguish 2 ten shapes 10a marked in this example with a circle (not typically drawn in practice) as seen in FIG. 33B. Then, the distinguished ten shapes 10a are combined with inner three shape 3d and outer three shape 3b, a process that is marked by lines 29b (drawn in practice) in order to distinguish 2 separate instances of 13 (the divisor) within 37 (the dividend) as seen in FIG. 33C. It is important to note that seven shape 29a was chosen during the first step because it includes three shapes, the amount needed above ten to complete the divisor (13). The 2 instances of 13 (the divisor) that could be distinguished within 37 (the dividend) represent the quotient (the answer). Thus, before calculating the remainder, we find the quotient so far is 2.

After the quotient (answer) is calculated, the remainder must then be calculated to determine an exact solution to the problem. This is done by counting the quantity of the shapes not included in the answer thus far. In this example, a ten shape 10a and a one shape 1a as see in FIG. 33D and marked by circles not typically drawn, are left as a remainder, and total 11 so that the final answer of 2 with remainder 11 is calculated. FIG. 34 shows this example as a SHAPE MATH®™ student would write it in practice.

### Mental Division (Direct)

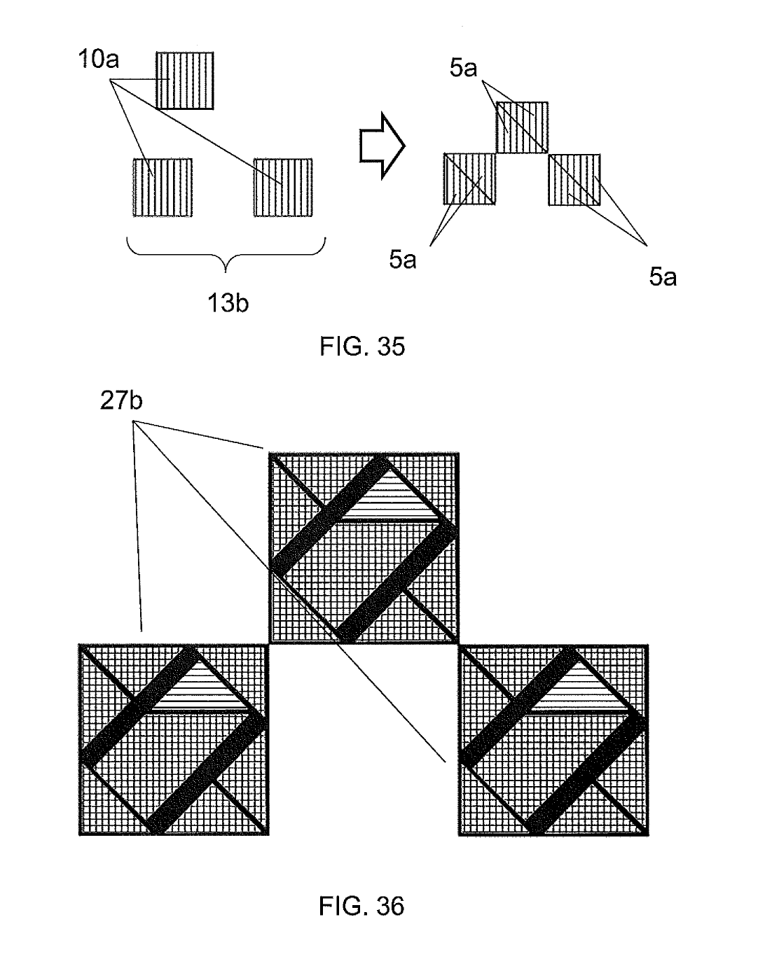

Certain division problems are simple enough to perform mentally by visualizing directly the instances of a divisor within a quotient. For example 30÷5 (see FIG. 35) is simple enough for a student to imagine 3 ten shapes 10a in a thirty pattern 13a and split them into 6 five shapes 5a. Even some problems that do not divide evenly (the shapes not the quantities) can be fully visualized mentally and the answers counted from this image. For example 30÷3 can be solved by visualizing 3 instances of ten shape 27b (shown in FIG. 36). The 3 three shapes per ten shape 27b can be added for a total of 9 and the remaining 3 one shapes 1a combined to make a 10th three shape, indicating 10 as the solution to 30÷3.

### Long Division

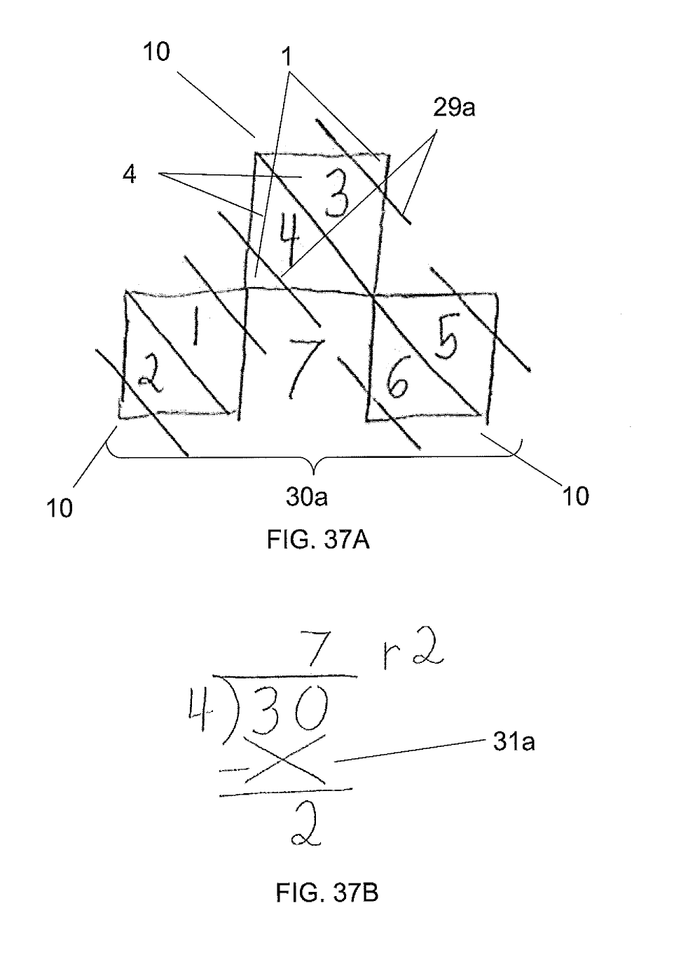

The next section will explain the techniques for completing long division with decimal solutions instead of remainders. The problem 43÷4 can be completed with the previously described techniques to yield the answer: 10 r3 (10 with remainder 3). However, sometimes solutions must be calculated in the form of a decimal. In SHAPE MATH®, remainders are converted to decimals in a way that is similar to standard math. The remainder is first multiplied by 10 and then divided by the original divisor. If the answer to this step also contains a remainder, the process must be repeated until the solution no longer contains a remainder. In this case the remainder is three and thus converts to 30; this is then divided by the original divisor of 4. Some SHAPE MATH® users can complete this problem (30÷4) mentally, however, FIG. 37A demonstrates the written form of this equation and shows some of the conventions of written division not yet covered. The ten shapes 10 of the thirty pattern 30a are first broken into four shapes 4 by drawing slashes 29a. This divides each ten shape 10 into 2 four shapes 4 and 2 one shapes 1 (reference numbers are only added to the top ten shape). A SHAPE MATH® user will then count the four shapes 4 by marking them 1 through 6. The remaining one shapes 1 are then totaled into groups of 4. In this case, one four shape 4 was made from totaling the one shapes 1 and marked with a ‘7’ placed within the thirty pattern 30a. Since 2 one shapes 1 remain from this process, we know that 30÷4=7 r 2. Sometimes larger problems require SHAPE MATH® users to track these steps using standard long division. FIG. 37B shows the problem of 40÷3 as a SHAPE MATH® user would write it to track their progress. The ‘X’ 31a is placed over the subtraction step because SHAPE MATH® does not use subtraction to discover the remainder, but instead comes to this total by counting the remaining shapes that cannot be grouped into multiples of the divisor. In this case, 2 one shapes 1 remained after 30 was divided into 7 four shapes 4. Since the remainder of 2 still exists, the process must be repeated. Remainder 2 is multiplied by 10 and thus converted to 20 and then divided by the original divisor of 4. Written as a completed equation, this process reads 20÷4=5 r0. Since no remainder exists, we can now complete the final answer using the sub-answers from each step of this process. In this example, while completing (43÷4) we calculated the following equations: 43÷4=10 r3, 30÷4=7 r2, 20÷4=5 r0. Each time the remainder of the previous equation was multiplied by ten and became the dividend of the next equation. To find the final solution, the answers to each sub-equation must be written without remainders in order of completion. In this case the answers when written in this way read 1075. At this point, the decimal must be added to complete the solution. The placement of the decimal depends on the number of remainders that were given a zero (multiplied by ten). In this case 2 zeros were added and the decimal is thus placed two spaces from the far right making 1075 into 10.75, the decimal answer to 43÷4.

### MONEY

### Coins

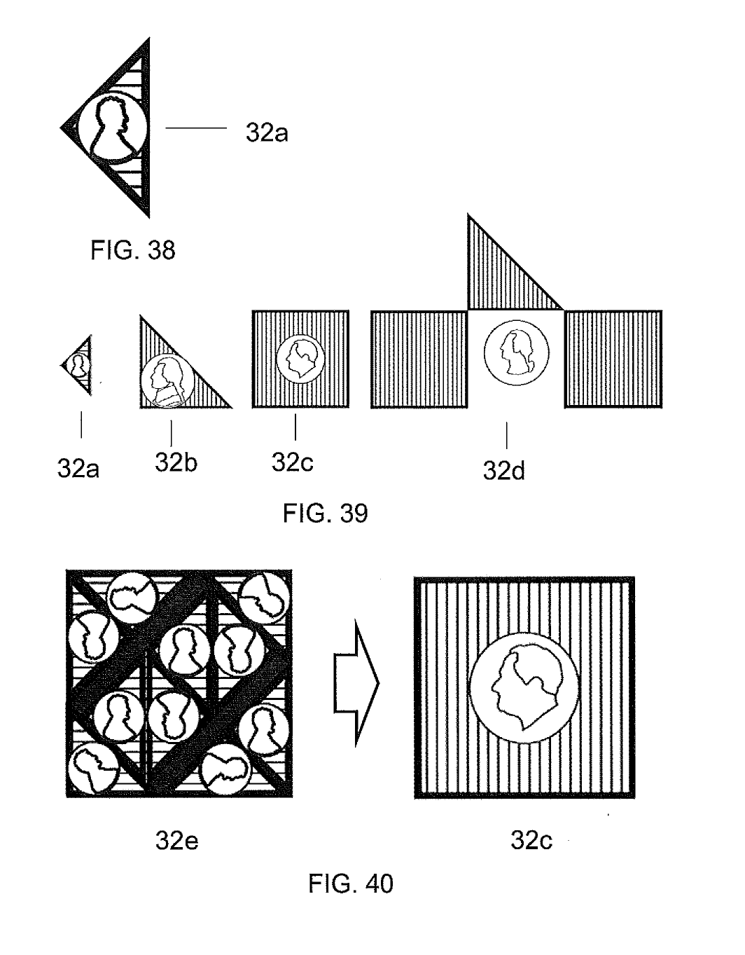

The next section will introduce the concepts and tools used to apply SHAPE MATH® to money. Much like each digit has a corresponding shape; each denomination of U.S. currency also has a corresponding SHAPE MATH® shape that is sized relative to its value. The base shape for SHAPE MATH® money is the one triangle, which is used to make the SHAPE MATH® penny 32a (shown in FIGS. 38 and 39). The higher SHAPE MATH® coins (nickel 32b, dime 32c, and quarter 32d) which are shown in FIG. 39 are all built from SHAPE MATH® pennies and can be combined using the same principles of standard SHAPE MATH® shapes. For example, 10 SHAPE MATH® pennies 32a can be combined into a ten shape 32e which is the equivalent in size and value to a SHAPE MATH® dime 32c, (as shown in FIG. 40).

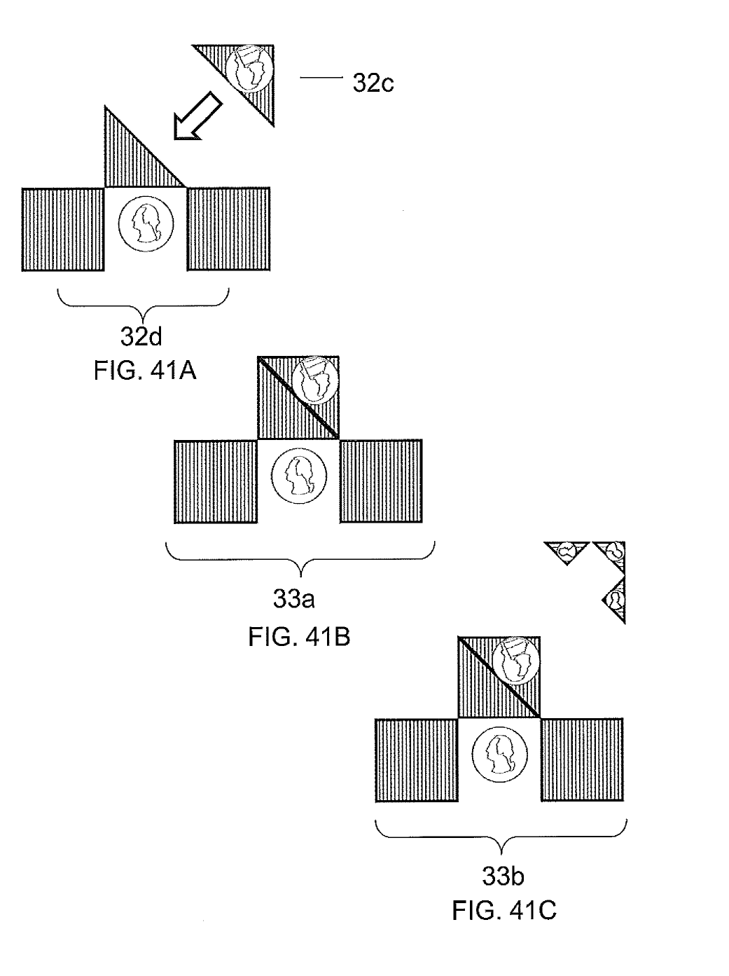

The SHAPE MATH® coins will aid a dyscalculic when working out problems that deal with change. For example, a SHAPE MATH®™ student may need to make 33 cents change. Using the SHAPE MATH® coins, the denominations can be combined physically to create a 32 pattern. Turning to FIG. 41A, this construction will begin with a SHAPE MATH® quarter 32d which is a particular 25 pattern. Then, a student will picture the addition of a SHAPE MATH® nickel 32c in order to make a particular 30 pattern 33a (See FIG. 41B). Finally, 3 SHAPE MATH® pennies are added to complete 33 pattern 33b (See FIG. 41C).

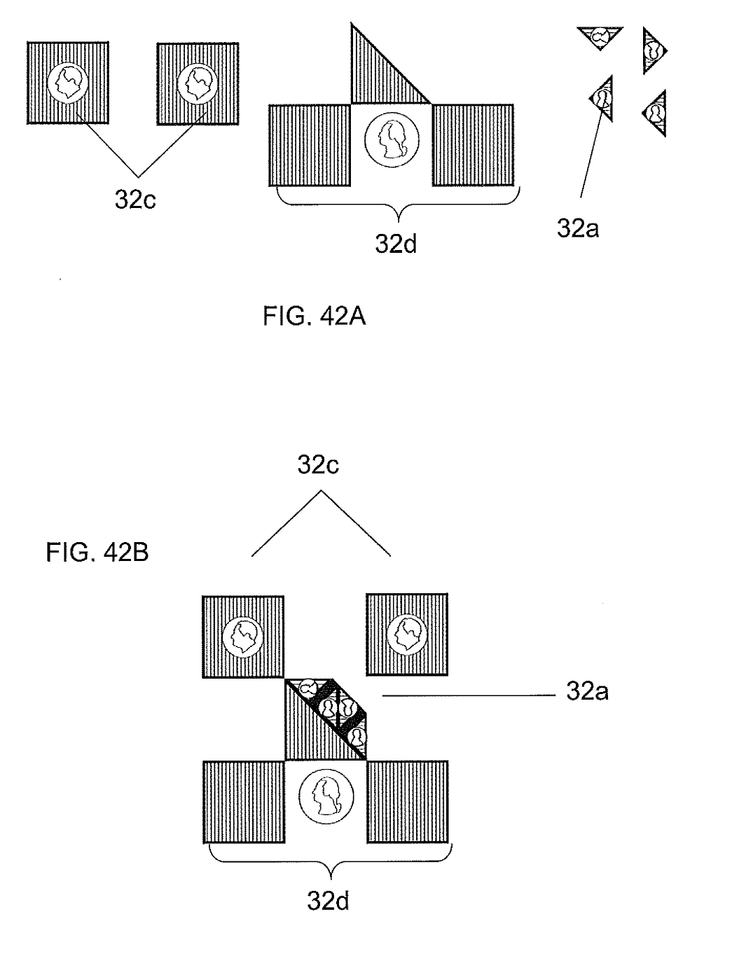

This additive process can also be used to complete addition problems as well. For example, a student may have 2 dimes 32c, a quarter 32d, and 4 pennies 32a (shown in FIG. 42A), If that student needed to calculate the sum of these coins, they could arrange the corresponding SHAPE MATH® coins into the structure of the fifty pattern in order to show their total value. When 2 dimes, a quarter, and 4 pennies are rearranged into the structure of the fifty pattern, they create a 49 pattern (shown in FIG. 42B). Much like the application of the fifty pattern elsewhere in SHAPE MATH®, arranging the coins in this way makes their total value more obvious. A student may see a forty pattern and a nine shape or they may see a fifty pattern missing a one shape. In either case, the arrangement into logical patterns and consistency of relative sizes allows a dyscalculic to visualize the addition of coins. In this case, the sum of 49 cents is made obvious.

SHAPE MATH® can also be used in subtraction problems dealing with money. Since most subtraction problems are too difficult to imagine while using SHAPE MATH® coins, a written form of SHAPE MATH® subtraction is used in which the minuend is represented by a pattern, the subtrahend crossed off, and the difference counted from the remaining shapes.

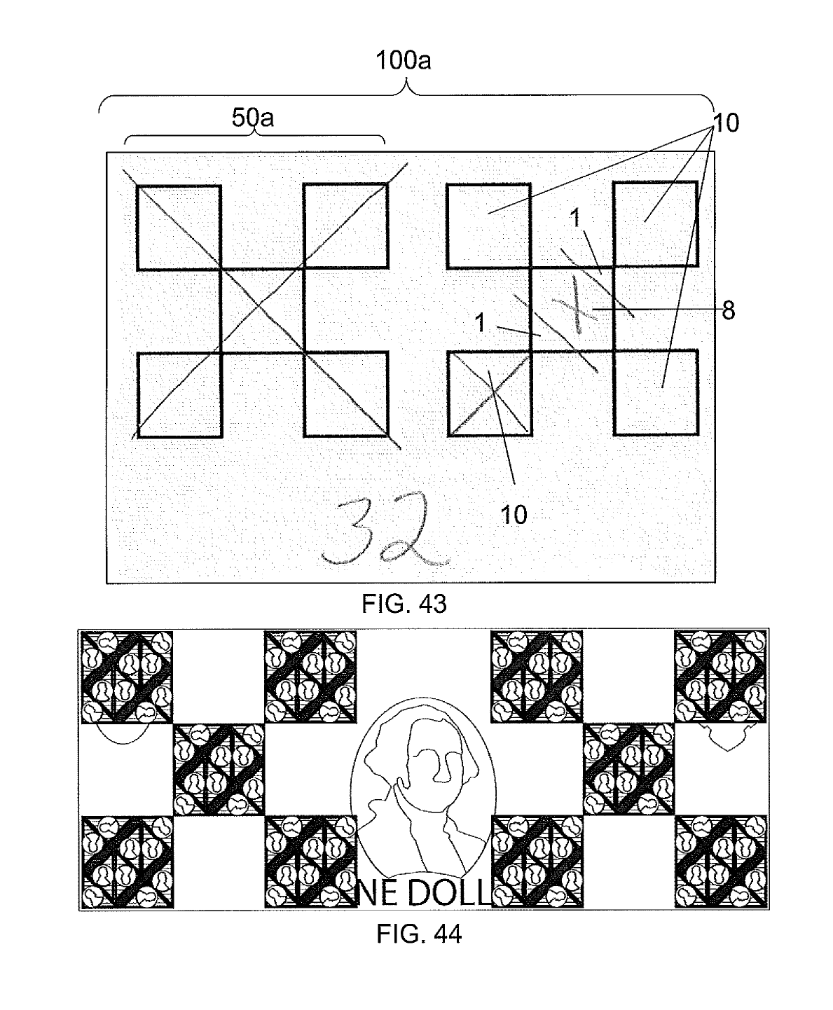

Now, turning to FIG. 43 for the problem (1 dollar−68 cents), a student would first imagine a 100 pattern to represent the 100 pennies within a dollar (shown in FIG. 43). Then the quantity of 68 would be crossed out from that 100 pattern by crossing out the fifty pattern 50a, then a ten shape 10 and finally an eight shape 8. Once the quantity of 68 has been removed, the remaining shapes can be totaled for the answer. In this case, 3 ten shapes 10 and 2 one shapes 1 remain indicating the answer of 32 cents.

### Bills

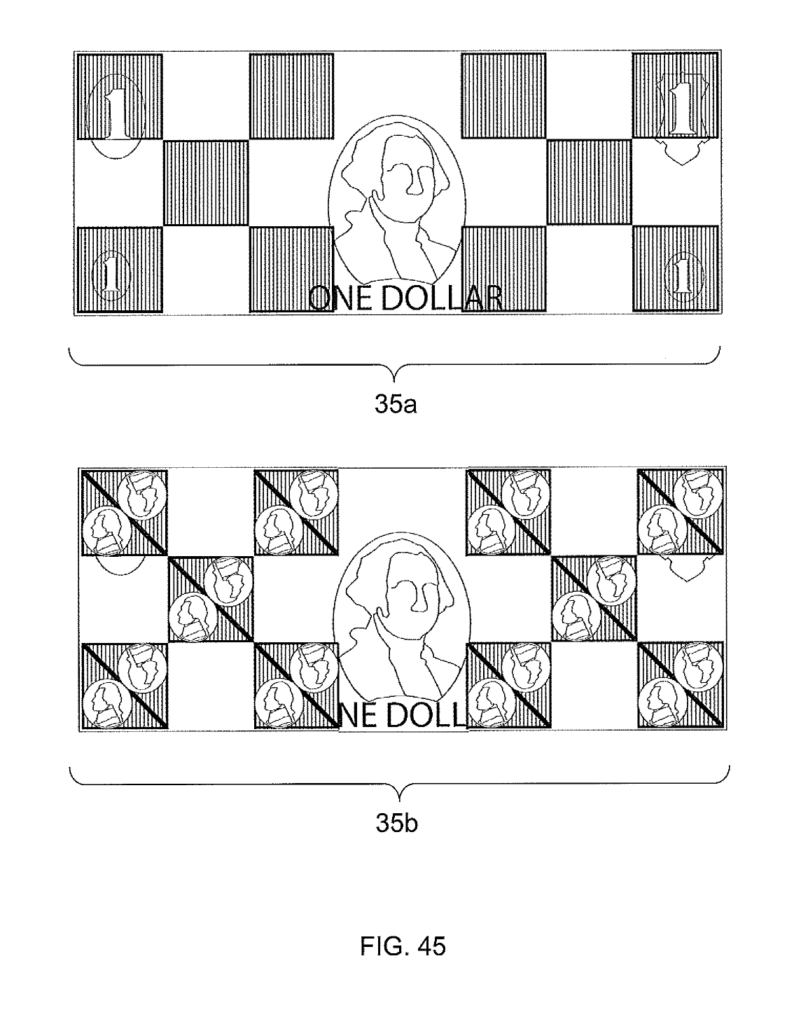

Thus far, coins have been represented with SHAPE MATH®. However, bills can also be represented within the same consistent system. A one dollar bill, for example, is composed of 100 SHAPE MATH® pennies (as shown in FIG. 44). One should note the pennies are arranged into a one hundred pattern. This is the basic pattern of arrangement for all representations of a SHAPE MATH® dollars made from coins. FIG. 45 shows the basic 100 pattern dollar and then a dollar composed of SHAPE MATH® nickels 35b that fits within this pattern. The SHAPE MATH® dollar composed of various coins is only used in smaller problems. For problems that involve manipulating larger bills, a different representation of the dollar is used.

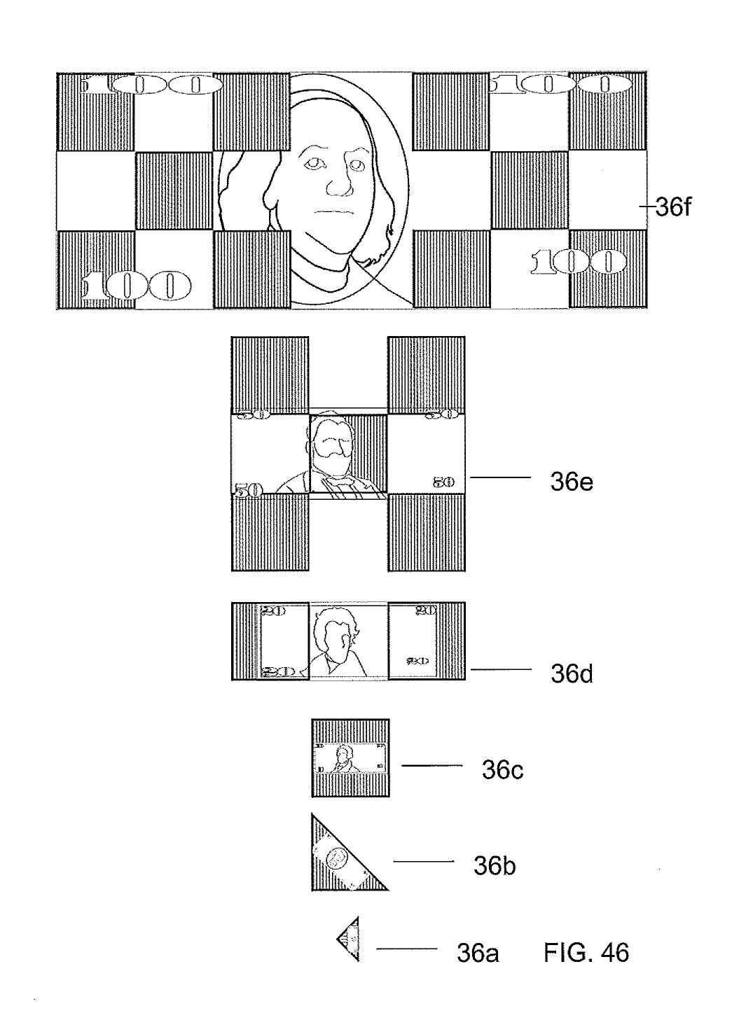

FIG. 46 shows the SHAPE MATH® bills in descending order from top to bottom. The one shape 1 represents the one dollar bill 36a, five of which can fit into the five shape 5 which represents the five dollar bill 36b and so on. Each denomination is represented by the shape or pattern from SHAPE MATH® that corresponds with the quantity of dollars expressed. Each bill also fits into larger bills a number of times that is appropriate for their relative quantities. Students will work with physical cut outs of the images displayed in FIG. 46 to become comfortable with visualizing the quantities involved. For the purpose of specification the SHAPE MATH® bills are shown in FIG. 46 as follows: SHAPE MATH® dollar 36a, SHAPE MATH® five dollar bill 36b, SHAPE MATH® 10 dollar bill 36c, SHAPE MATH® 20 dollar bill 36d, SHAPE MATH® 50 dollar bill 36e, SHAPE MATH® 100 dollar bill 36f. These images, mental or physical, can be manipulated to add and subtract bills of currency.

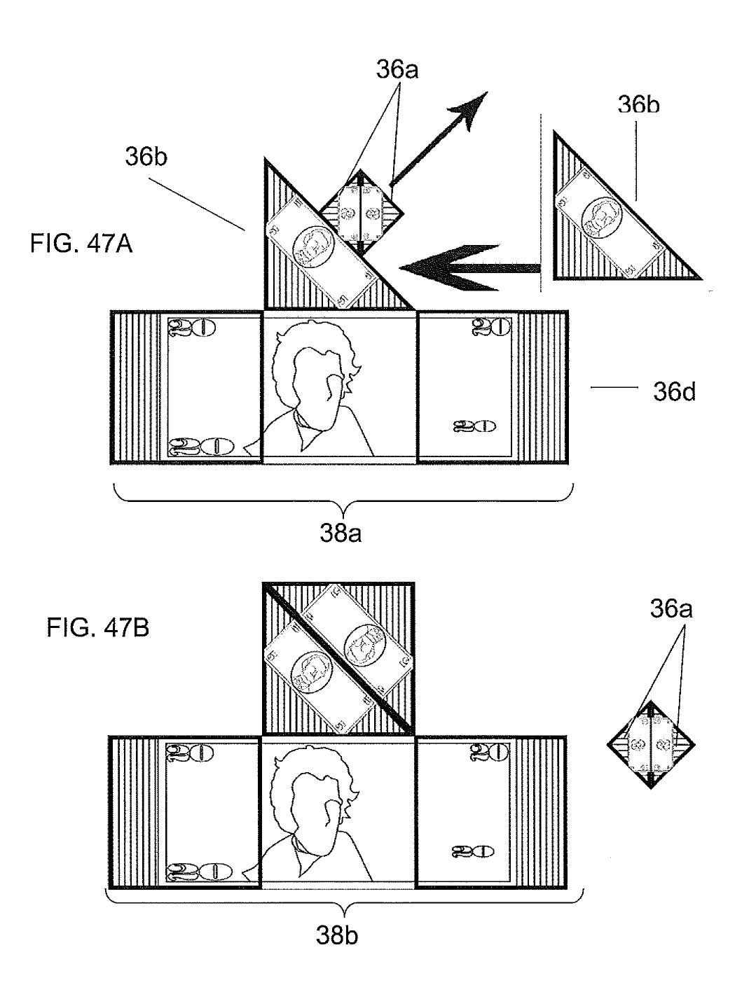

Now turning to FIGS. 47A-B for the problem ($27+a five dollar bill), a student would first arrange a SHAPE MATH® money 27 pattern 38a out of a SHAPE MATH® 20 dollar bill 36d, a SHAPE MATH® 5 dollar bill 36b and 2 SHAPE MATH® dollars 36a as seen in FIG. 47A. Then, to add a five dollar bill, a student would first separate the 2 SHAPE MATH® dollars 36a from the 27 pattern 38a and then add a SHAPE MATH® five dollar bill 36b in their place as demonstrated by arrows. This will create SHAPE MATH® money thirty pattern 38b beside 2 SHAPE MATH® dollars 36a shown in FIG. 47B, to create a SHAPE MATH® money 32 pattern that can be recognized easily as an expression of 32 dollars, the answer to the problem.

SHAPE MATH® money subtraction with bills is almost identical, in practice, to subtraction of SHAPE MATH® coins. The appropriate written SHAPE MATH® pieces are determined and manipulated to calculate the difference between 2 quantities (solution to the subtraction problem).

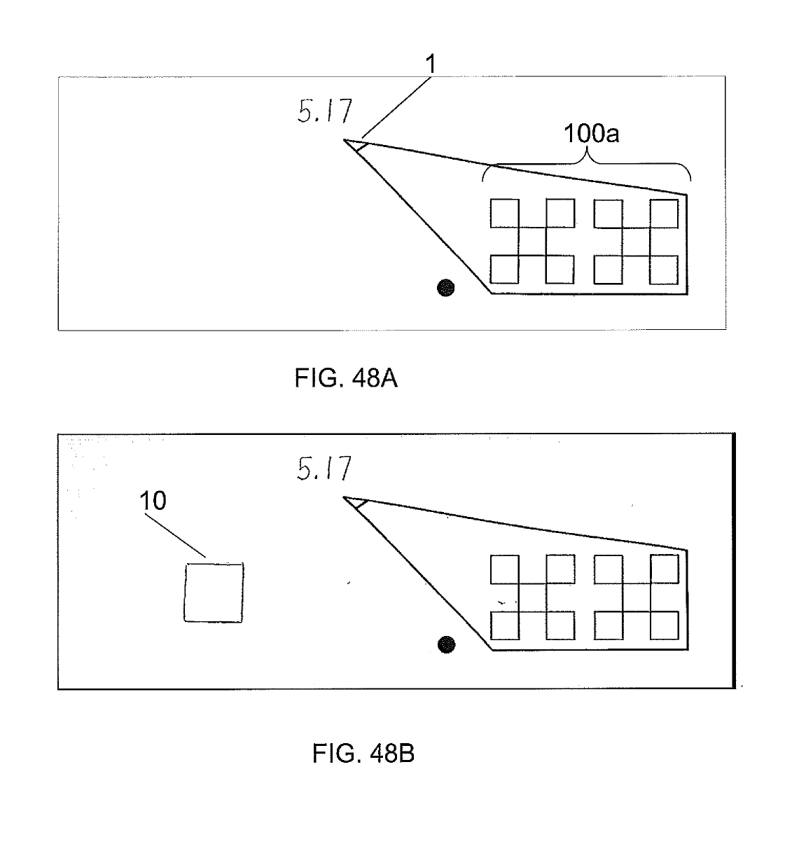

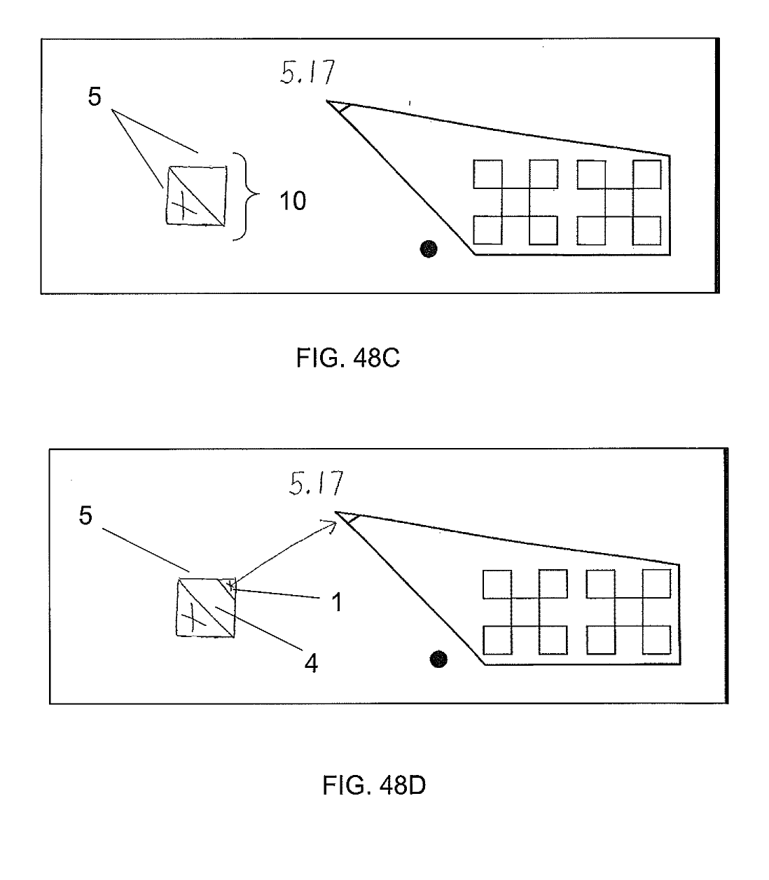

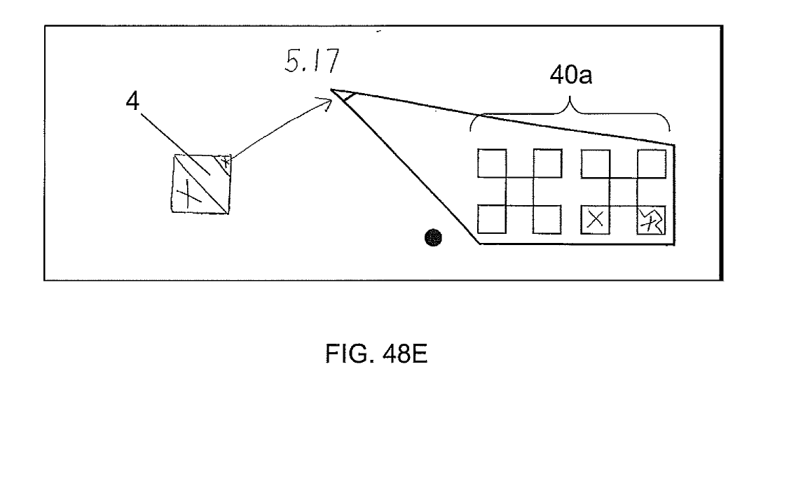

When calculating subtraction problems with both dollars and cents, a slightly different process is used. The student constructs two separate patterns, one for dollars and one for cents, which are separated by a decimal point. For the problem $10−$5.17 (seen in FIGS. 48A-E) a student would start by writing the subtrahend (5.17) just above a one triangle 1 with lines leading to and forming a box around a 100 pattern 100a which is placed to the right of a decimal point shown in FIG. 48A. It is important to note that the one triangle 1 and 100 pattern 100a each represent one dollar in different ways. The one triangle 1 refers to SHAPE MATH® dollar 36a and the 100 pattern 100a refers to SHAPE MATH® dollar 35a. Once this structure has been written, the dollars must be calculated. The minuend ($10) is written as a ten shape 10 to the left of the decimal point as seen in FIG. 48B. Then, the $5 from the subtrahend ($5.17) is subtracted by dividing ten shape 10 into 2 five shapes 5 and crossing one off as shown in FIG. 48C. Next, the cents must be subtracted which requires we borrow from the remaining five dollars of the minuend. To do this, the remaining five shape 5 is divided into a four shape 4 and a one shape 1, the one shape 1 is crossed off and an arrow is drawn to connect this one shape 1 with the one shape 1 drawn originally to indicate that one dollar was borrowed and converted into 100 cents as shown in FIG. 48D. The remaining 17 cents from the subtrahend is then subtracted by crossing this quantity from the 100 pattern as shown in FIG. 48E. At this point, the quantities that remain uncrossed can be totaled for the answer. The four shape 4 to the left of the decimal point represents 4 dollars while the 83 pattern 13f to the right of the decimal point represents 83 cents, for the solution of $4.83. This process can eventually be internalized so that the student imagines these operations instead of writing them. This method is applied to situations that require change be made when payment is made with a particular bill and thus applies only to subtraction problems with even dollar amounts as the minuend.

### Fractions

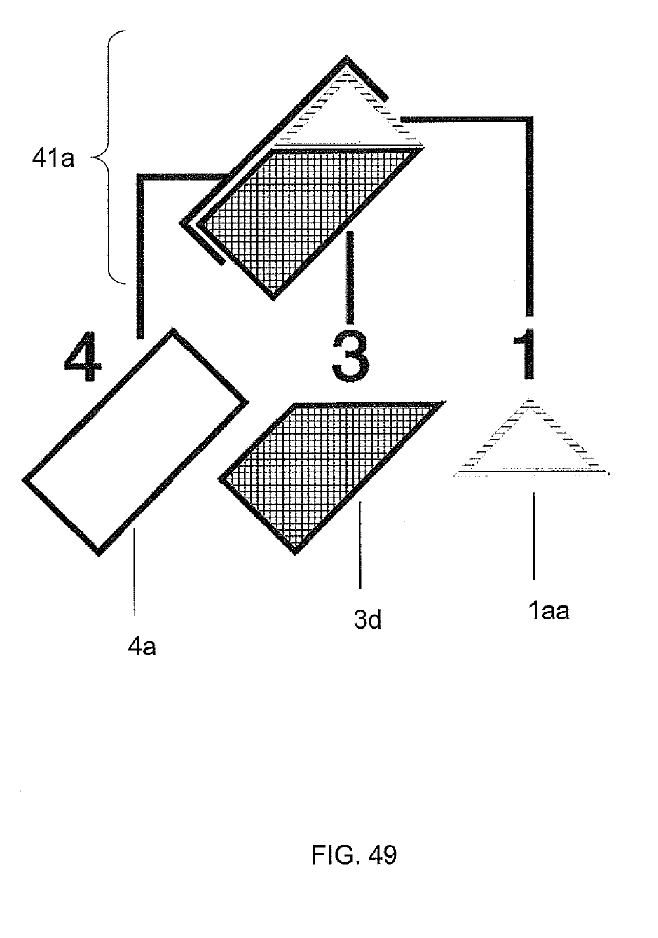

The next section will cover the representation and manipulation of fractions within SHAPE MATH®. The standard representations of fractions such as ¾ or 5/7 are abstract and hard for a dyscalculic to conceptualize or manipulate. With SHAPE MATH®, however, fractions are displayed directly and with proper relative sizes. For example, a SHAPE MATH® representation of ¾ 41a is (shown in FIG. 49). The denominator (4) is represented by the outline of the SHAPE MATH®™ fraction and is shown isolated below as four shape 4. The numerator (3) is represented by the shaded portion of the SHAPE MATH®™ fraction and is shown isolated below as three shape 3. Finally, the missing portion of the whole (not represented in standard math fractions) is represented by empty space and shown isolated as one shape 1. SHAPE MATH® fractions work very similarly to pie charts which also display colored portions within the context of a larger whole. SHAPE MATH® representations, however, use specific shapes with exact quantities that can express the specific parts of a fraction.

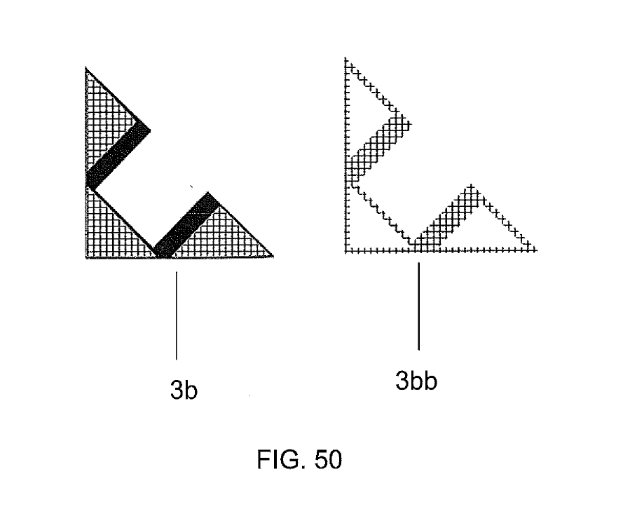

It is important to note that FIG. 49 displays a SHAPE MATH® fraction that is composed of physical SHAPE MATH® pieces, but the concept can be applied similarly in a digital format. The SHAPE MATH® pieces were mentioned above and they are a physical learning tool for SHAPE MATH® students. In a preferred embodiment, every SHAPE MATH® piece has a colored front side and a reverse side which is white with an outline of the same color from the front side. When working with fractions, the front sides of pieces are used to display the denominator while the reverse sides are used to display portions of the whole that are not present (negative space). FIG. 50 shows the front side of a three shape 3b next to the reverse side of that same three shape 3bb (shown with black dotted lines to make the outline of the faint colors more obvious).

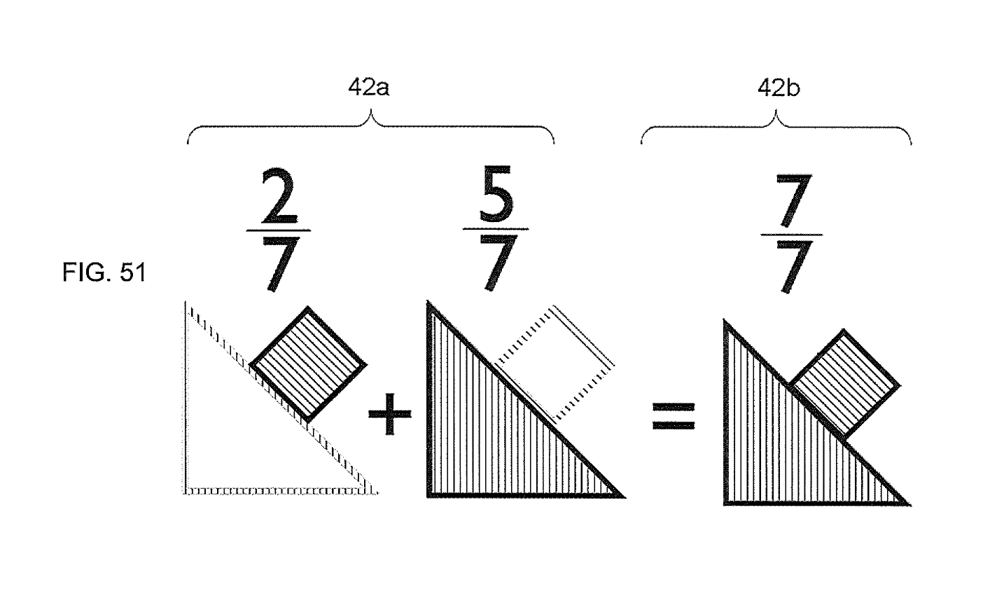

Because SHAPE MATH® fractions are displayed so directly, simple operations such as addition can be performed by visually manipulating the quantities displayed. The problem 2/7+ 5/7 (seen in FIG. 51) is shown in first fraction addition representation 42a as it would appear if constructed from SHAPE MATH® pieces. To solve this problem, the numerators (colored portions) are combined as shown in second fraction addition representation 42b. The colored two shape 2 is combined with colored five shape 5 to make a colored seven shape 7. It is important to note that filling an entire SHAPE MATH® fraction with solid colors will always be equivalent to 1. The answer 7/7 is visually represented as a normal seven shape.

### Fraction Addition Different Denominators

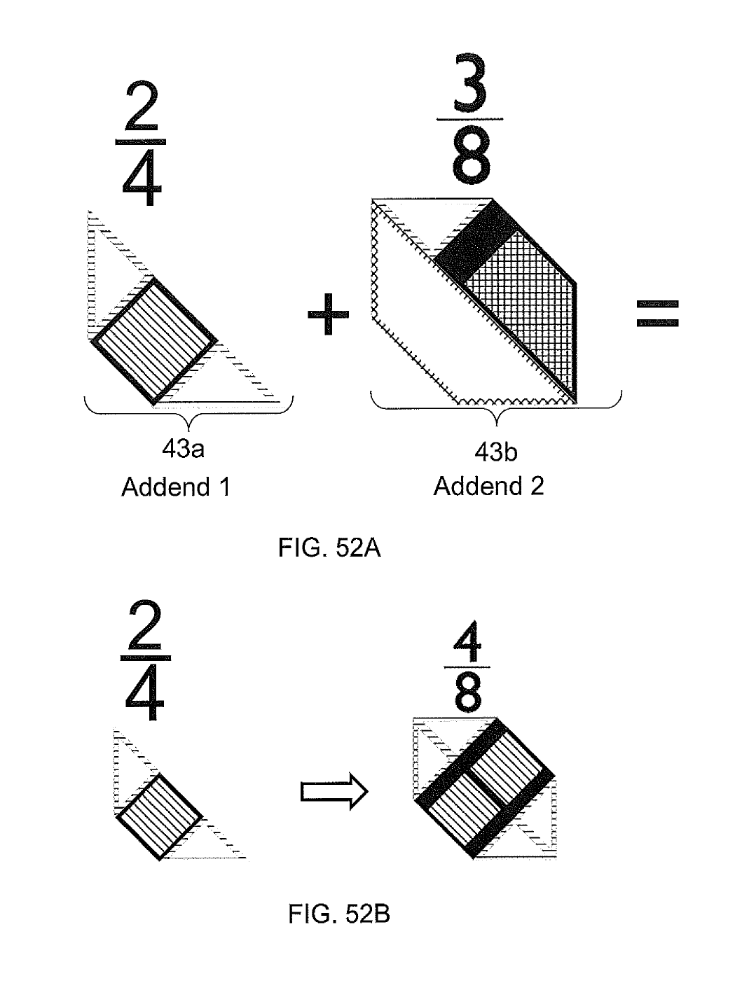

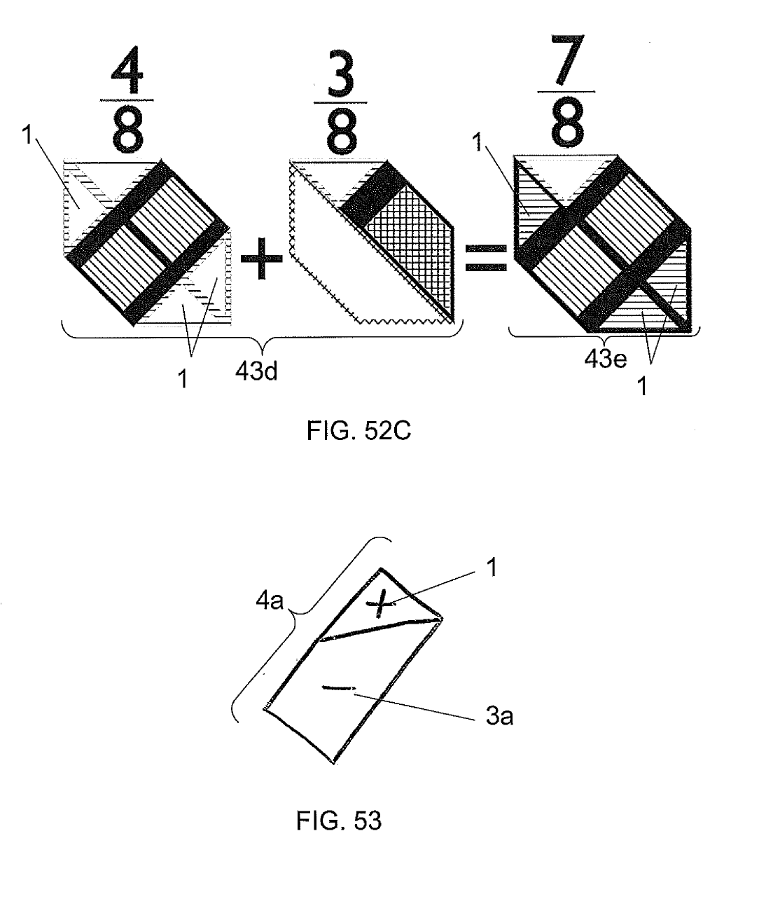

Now turning to FIGS. 52A-C, when fractions of 2 different denominators are added, a common denominator must be found and the fractions involved must be converted into fractions with that common denominator. In the case of 2/4+⅜ (shown in FIG. 52A) Addend 1 43a has a denominator of 4 while addend 2 43b has a denominator of 8. In this case, the first denominator (4) can be multiplied by 2 to convert it into the second denominator (8). Since the perimeter shape of a SHAPE MATH® fraction determines its denominator, the perimeter shape 43c of addend 1 (4 shape) must be doubled to make the perimeter shape 43d of addend 2 (8 shape). This process can be seen in FIG. 52B, in which the perimeter shape 43f (denominator) is doubled along with the colored portion (numerator) so that 2/4 converts to 4/8. Now, turning to

FIG. 52C we have the problem 4/8+⅜ 43d and the process of addition is the same intuitive combining of shapes from many other parts of SHAPE MATH®™. In this case, the three shape 3a from ⅜ is converted into 3 one shapes 1 which replace 3 of the white one shapes 1 of 4/8 for the final answer of ⅞ 43e.

### Written Form of SHAPE MATH® Fractions

SHAPE MATH® fractions also have a written form. The written form of ¼ is (shown in FIG. 53). The outside shape of written fractions still represents the denominator (four shape 4 in this case). The shape for the numerator (one shape 1 in this case), however, is signified with a plus sign (+) drawn within the shape. The portion missing from the denominator (3 shape 3d in this case) is marked with a minus sign (−).

### Multiplying Fractions

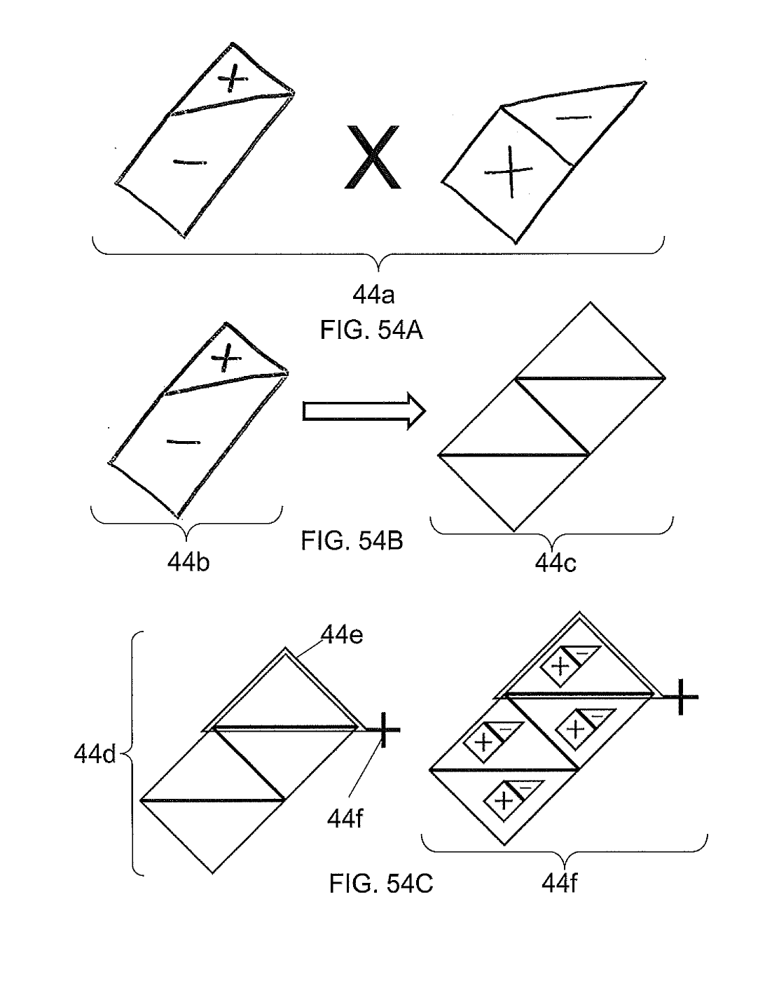

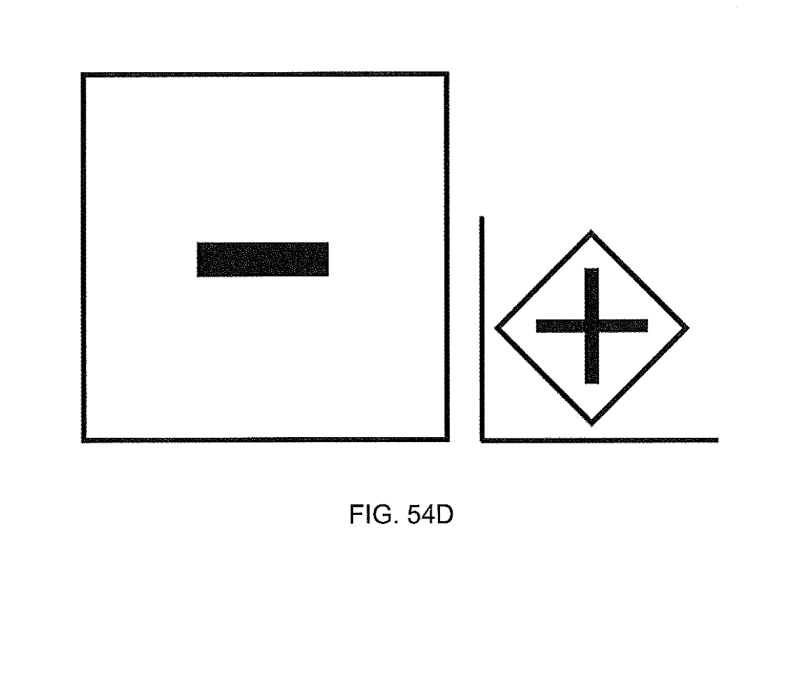

Now turning to FIGS. 54A-D to multiply fractions in SHAPE MATH®, the first step is to break the first multiplicand into one shapes and distinguish its numerator with an outline. Then, an instance of the second multiplicand is drawn in each of the one shapes from the first multiplicand. The quantity of all these instances of the second multiplicand is totaled for the denominator of the answer. Finally, attention is drawn to the numerator outline drawn earlier. The shapes within this numerator outline that have a plus sign (+) are totaled to find the numerator of the answer. In the case of ¼ (first multiplicand)×⅔ (second multiplicand) 44a (shown in FIG. 54A) the fraction ¼ 44b is converted into 4 shape 44c which is composed of 4 one shapes 1 (shown in FIG. 54B). The numerator of ¼ is then distinguished with outline 44e that has a plus sign (+) 44f attached to it shown in fraction multiplication representation 44d (shown in FIG. 54C). Then an instance of the second multiplicand (⅔) is placed in each of the one shapes within the first multiplicand as shown in second fraction multiplication representation 44f. Now that the problem is presented in this way, the denominator and numerator can be counted. To count the denominator, the one shapes are counted from each of the instances of ⅔ totaling 12 in this case. For the numerator, the one triangles with a plus sign (+) within the numerator outline are counted totaling 2 in this case. This gives us the final answer of 2/12. In SHAPE MATH®, this is presented with a negative ten shape 10 and a positive two shape 2 (shown in FIG. 54D). The denominator of 12 is represented by the combined ten shape 10 and two shape 2. The numerator is represented with a two shape with a plus sign. It should be noted that a SHAPE MATH® user can still apply the principles from SHAPE MATH® multiplication to multiply the numerators then the denominators, as seen in standard math, but completing the problem with the method just described helps the SHAPE MATH® user conceptualize fraction multiplication.

### Fraction Division with Equal Denominators

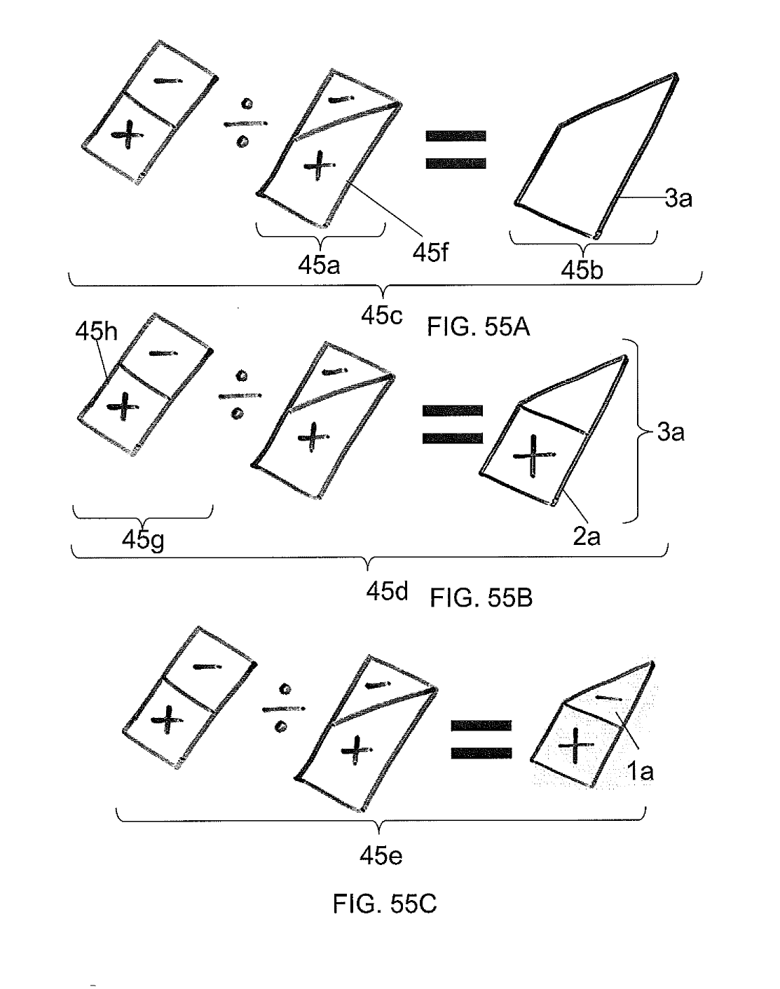

When calculating the division of SHAPE MATH® fractions of equal denominators the first step is to establish the denominator of the answer. To do this the numerator shape from the divisor is drawn in the answer space. Turning to FIGS. 55A-C for the problem 2/4÷¾, the divisor (¾) 45a has a numerator of 3 45f therefore 3 shape 3a is drawn in the answer space 45b as shown in first fraction division representation 45c (see FIG. 55A). The next step is to determine the number of times the numerator of the dividend fits into the denominator of the answer. In this problem, the dividend 45g has a numerator 45h of 2 therefore 2 shape 2a is drawn with a plus sign inside of denominator 3a of the answer as shown in second fraction division representation 45d (see FIG. 55B). Finally, the space in the denominator of the answer that is not already occupied is given a negative sign. In this example, a negative sign is drawn in one shape 1a as shown in third fraction division representation 45e (see FIG. 55C).

### Improper and Mixed Fractions

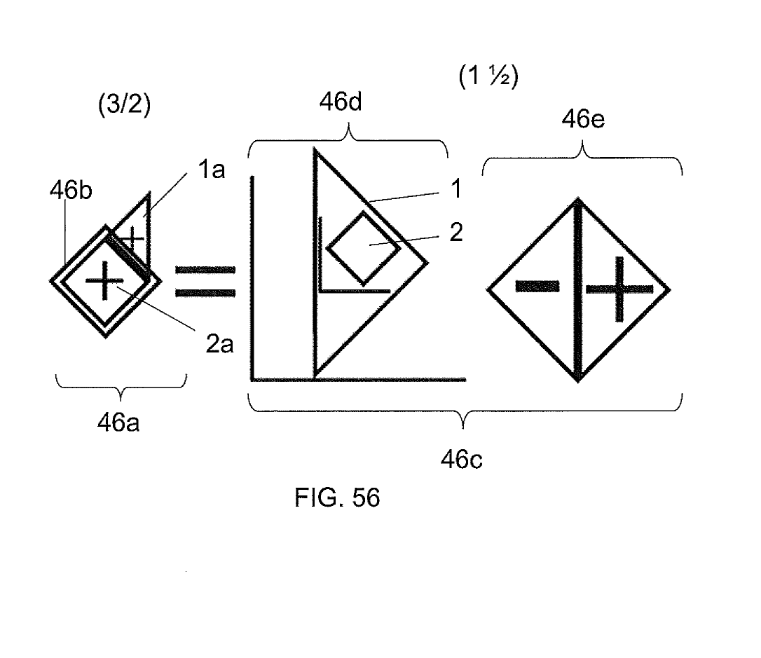

FIG. 56 shows the equivalent fractions of ( 3/2) and (1 ½) written as SHAPE MATH® fractions. Improper fraction representation 46a shows ( 3/2). In SHAPE MATH®, the denominator of a mixed fraction is expressed with a denominator outline. In this case the denominator outline 46b surrounds a two shape 2a. The numerator of improper fractions is indicated by the total quantity of SHAPE MATH® numbers, in this case a two shape 2a and one shape 1a, when combined, indicate a numerator of 3. This same quantity expressed as a mixed SHAPE MATH® fraction is shown in mixed fraction representation 46c which represents 1 ½. The whole number shape 46d expresses the quantity of 1 and the fraction 2/2 simultaneously, It expresses the quantity of 1 because of its outline is a one shape 1. It expresses the fraction 2/2 because of the two shape 2 inside this one shape 1. The two shape 2 also indicates a denominator of 2 for fraction 46e (½), which is seen to the right of whole number shape 46d. The importance of including this indicator (two shape 2) within the whole number shape will be apparent when doing operations with mixed fractions. The fraction shape 46e indicates ½ and follows the conventions of SHAPE MATH® fractions thus far. Together, the whole number shape of 1 46d and the fraction ½ 46e, make up the mixed fraction 1 ½ 46c.

### Addition With Mixed Fractions of Equal Denominators

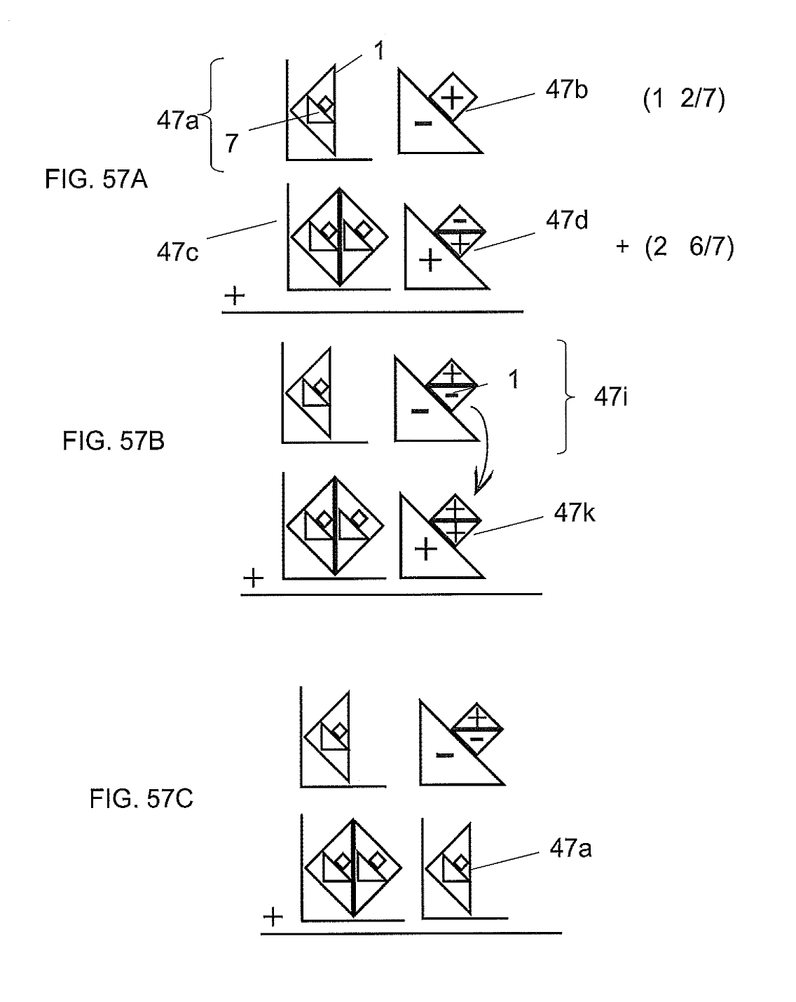

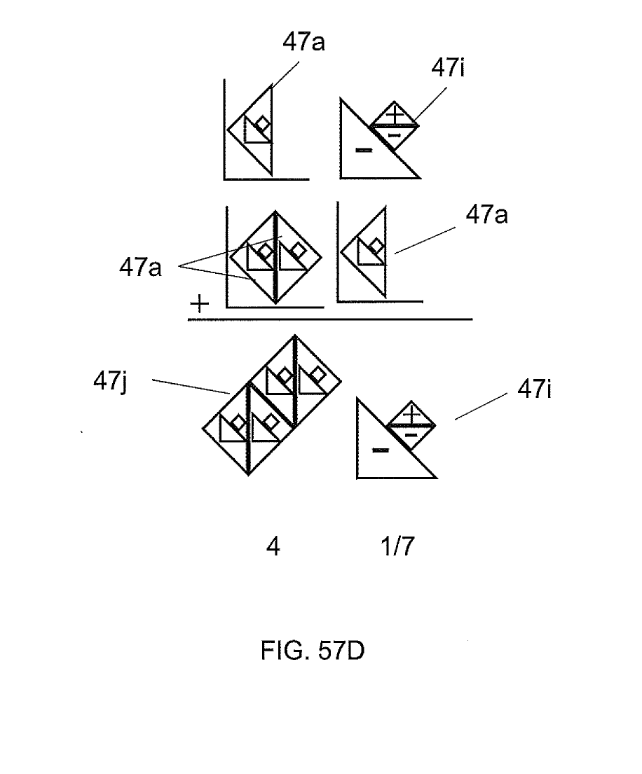

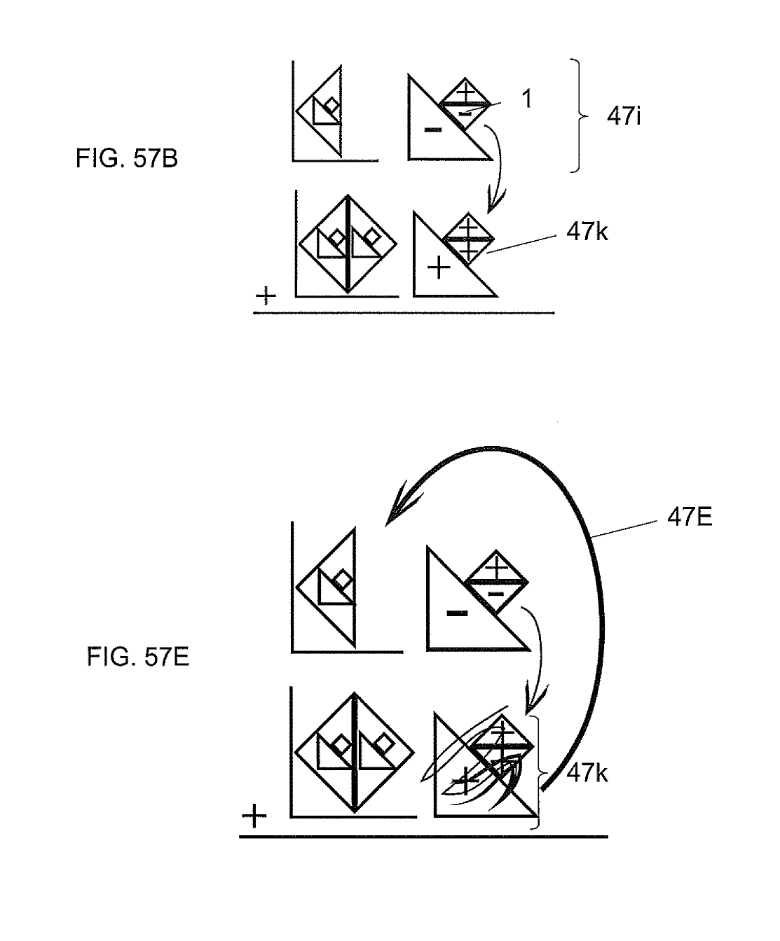

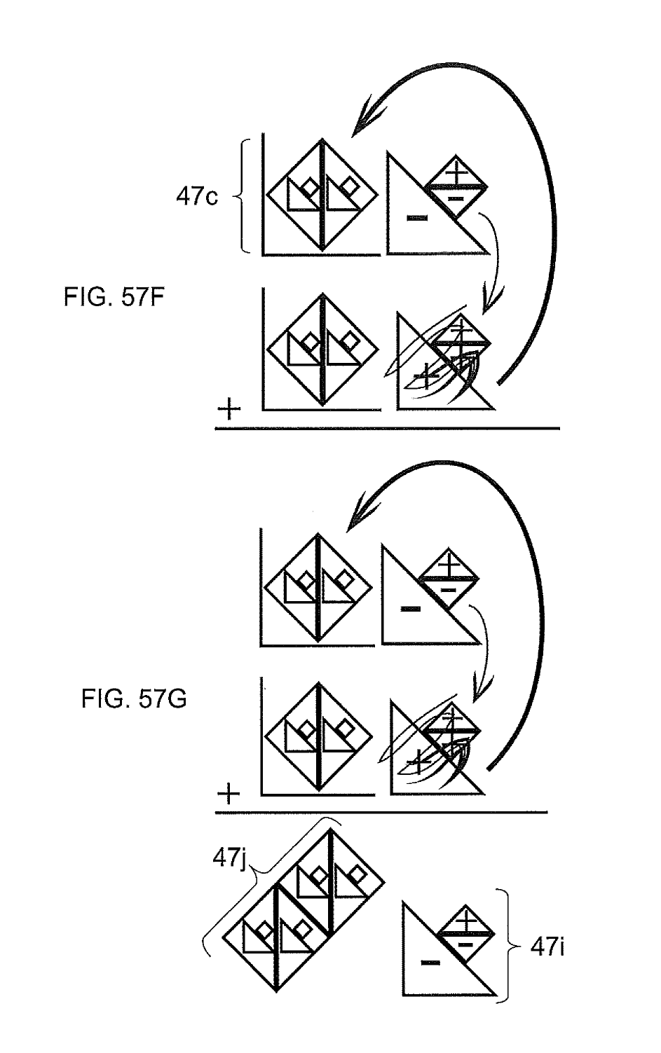

The calculation of mixed fractions in SHAPE MATH® uses a place value system. The right column houses instances of fractions below 1 while the left column houses instances of 1 expressed as fractions (ex. 2/2, 3/3). Turning to FIGS. 57A-D for the problem of [1 ( 2/7)]+[2 ( 6/7)], the first step, shown in FIG. 57A, is to present the relevant fractions as SHAPE MATH® fractions within the typical place value organization of addition. To represent 1 2/7, whole number shape 47a is used to express 1 or 7/7. The seven shape 7 is displayed within the one shape 1 to indicate the relevant denominator. Fraction shape 47b is used to express 2/7 and follows the SHAPE MATH® fraction conventions explained thus far. Below these two shapes the mixed fraction 2 6/7 is represented. Whole number shape 47c represents the quantity of 2 (more specifically 2 instances of 7/7). Fraction shape 47d represents 6/7. The second step, shown in FIG. 57B, is to add the fraction shapes contained in the fraction column (right column). To do this, the constituent shapes are recombined into a recognizable shape or pattern. In this case, the one shape 1 from fraction shape 47b is brought down to the empty space in the denominator of fraction shape 47d so that the fraction 7/7 47k is made. Whenever the numerator of a fraction shape in the fraction column equals the denominator (when the fraction is full) it is erased and redrawn as a whole number shape. In this case, whole number shape 47a is drawn to represent 7/7 or the quantity of 1 as shown in FIG. 57C. The final step, shown in FIG. 57D, is to compile the answer. The whole number shapes can be counted and combined into a larger shape. In this case, the 4 instances of 7/7 47a are drawn into a larger whole number 4 shape 47j to indicate the answer of 4 in the whole number column. Next, the remaining fraction shape from the fraction column is brought down to the answer space. In this case, fraction shape 47i is brought to the answer space and represents 1/7. Next to each other, whole number shape 47j (quantity 4) and fraction shape 47i (quantity 1/7) display the mixed fraction 4 1/7.

### Subtraction Of Mixed Fractions With Equal Denominators

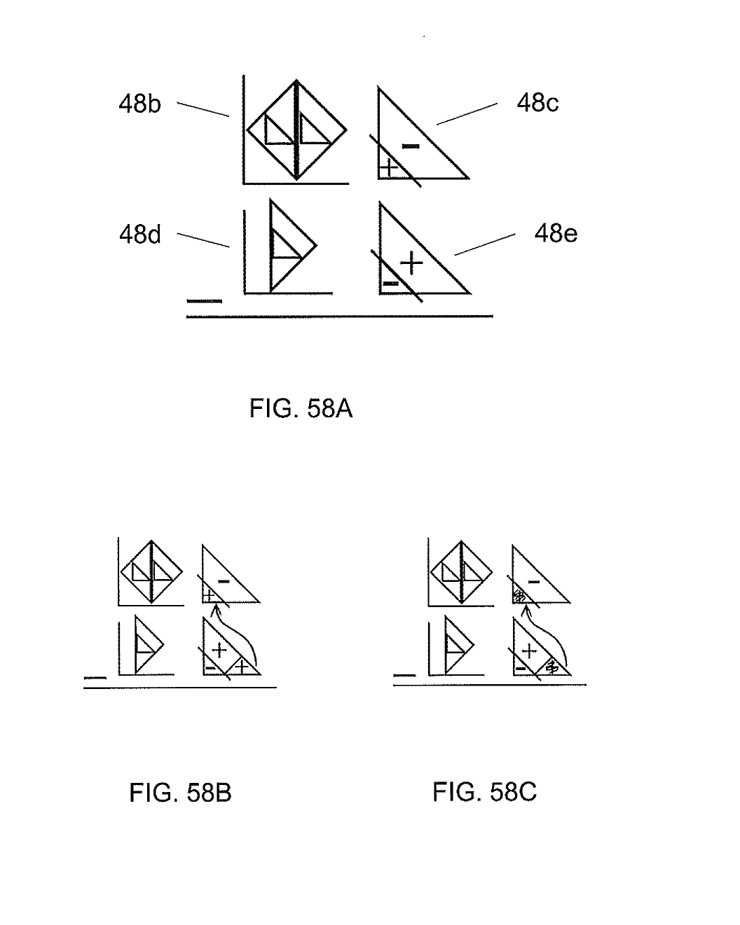

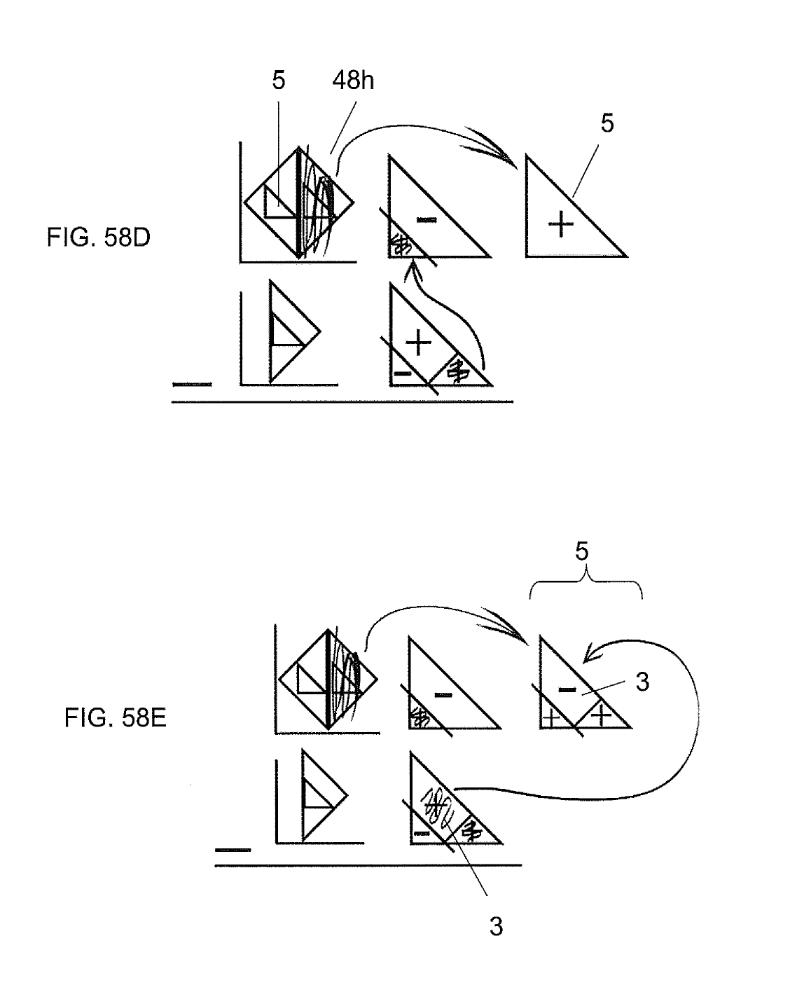

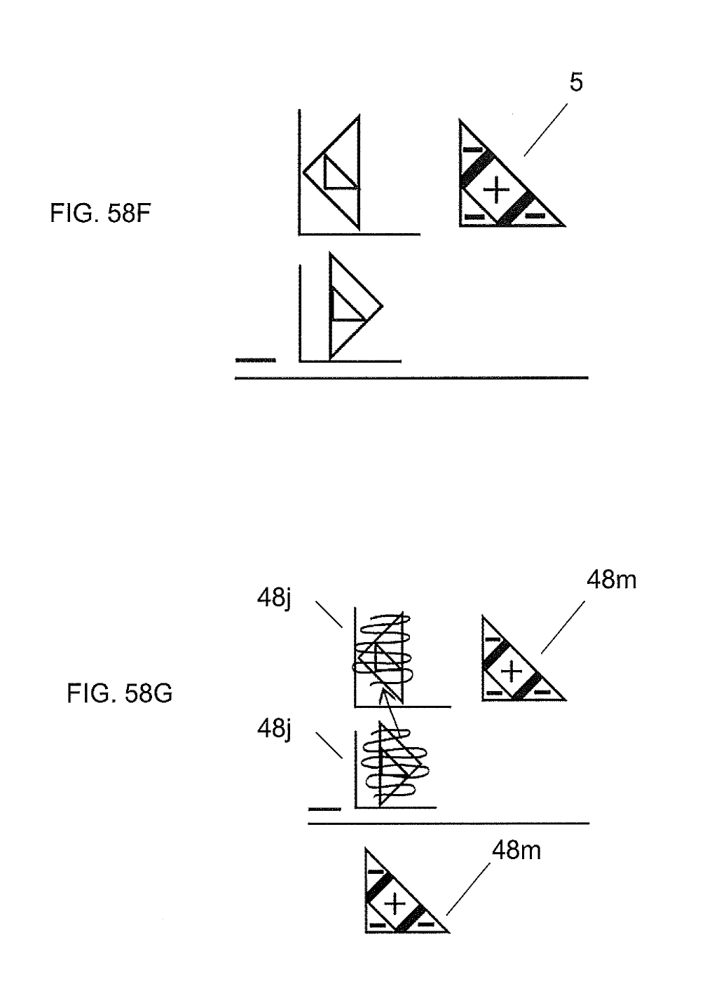

The subtraction of SHAPE MATH® mixed fractions is very similar to addition. Like addition, the relevant mixed fractions are expressed in a place value system using SHAPE MATH® mixed fractions. Turning to FIGS. 58A-G for the problem [2 (⅕)]−[1 (⅘)], FIG. 58A shows how the relevant quantities would be expressed as SHAPE MATH® mixed fractions within a place value system. Whole number shape 48b expresses the quantity of 2 (more specifically 2 instances of 5/5) while fraction shape 48c expresses ⅕. Below this, whole number shape 48d expresses 1 (more specifically 1 instance of 5/5) and fraction shape 48e expresses ⅘. The second step is to subtract subtrahend 48e (⅘) from minuend 48c (⅕). An arrow is drawn from one shape 1 of the subtrahend to 1 shape 1 of the minuend and each one shape is crossed off as demonstrated in FIG. 58B and FIG. 58C. This only subtracts ⅕ from the ⅘ of the minuend. Since the minuend (⅘) is larger than the subtrahend (⅕), a unit must be borrowed from the whole number column. In this process, shown in FIG. 58D, an arrow is drawn from whole number shape 48h to the right of the fraction column and a five shape 5 is drawn at the end of this arrow. The whole number shape becomes a five shape because 5 is the relevant denominator. The five shape 5 inside the outline of the whole number shape helps to make this more clear and obvious to a SHAPE MATH® user. Once 5/5 is borrowed from the whole number column, the remaining ⅗ of the minuend can be subtracted from this borrowed shape. To complete this step, shown in FIG. 58E, an arrow is drawn from the remaining 3 shape 3 in the minuend to the borrowed five shape 5 and a three shape 3 is drawn within this borrowed five shape 5 and given a negative symbol while the three shape 3 from the minuend is crossed off. The next step is to rewrite the problem with all crossed off shapes omitted and the remaining shapes reorganized so that the numerator is contained within a single shape. In this case, 5 shape 5 from FIG. 58E is rewritten as 5 shape 5 from FIG. 58F.

Once the fractions column has been rewritten, the subtrahend of the whole number column must be subtracted from the minuend of the whole number column. In this case, shown in FIG. 58G, an arrow is drawn from 5/5 48j in the bottom row to 5/5 48j of the top row and each are crossed. Finally, the ⅖ shape 48m (all that remains) is brought down to the answer row to indicate the answer of ⅖.

### Addition With Improper Fractions

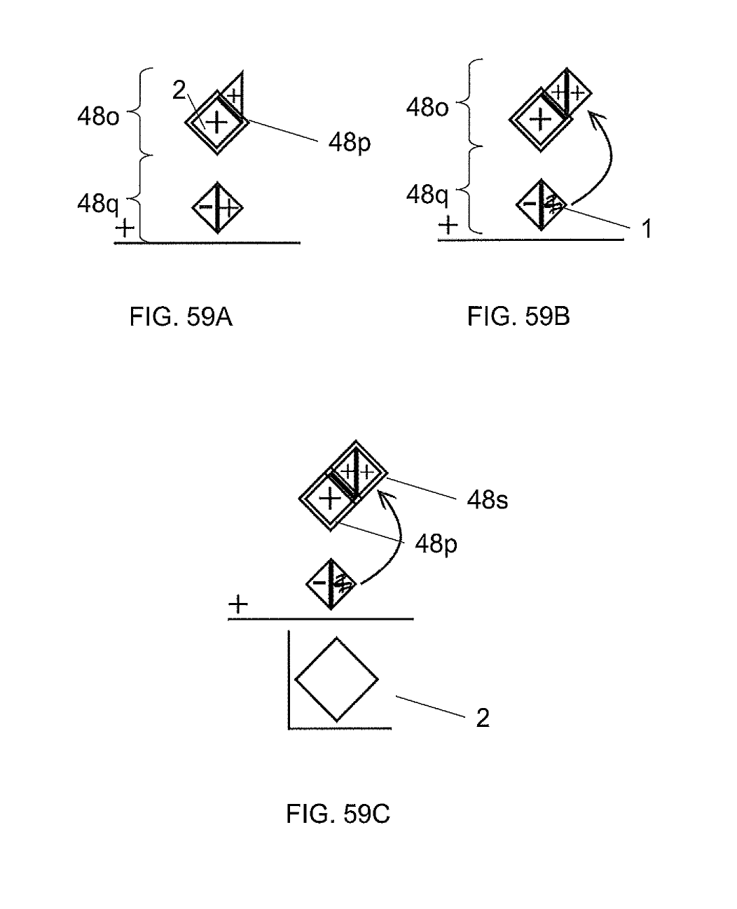

Adding improper fractions with SHAPE MATH® is almost identical to standard SHAPE MATH® addition. FIGS. 59A-C show the problem 3/2+½ as it would be completed with written improper SHAPE MATH® fractions. FIG. 59A shows the problem after it has been converted to SHAPE MATH® symbols. The top addend 48o represents 3/2 with denominator outline 48p surrounding two shape 2 and thus indicating a denominator of 2. The bottom addend 48q represents ½. The process of addition is shown in FIG. 59B and demonstrates the process of drawing an arrow from one shape 1 of bottom addend 48q to top addend 48o, crossing this one shape and redrawing it at the end of the arrow. This eliminates the numerator of bottom addend 48q and completes the answer shape. Because this answer shape has a full two shape 2 outside denominator outline 48p, another denominator outline 48s is drawn around two shape 2, shown in FIG. 59C. The denominator outlines each represent the quantity of 1 and can be totaled in this case for the answer which is written as two shape 2 in the answer space.

### Percentages

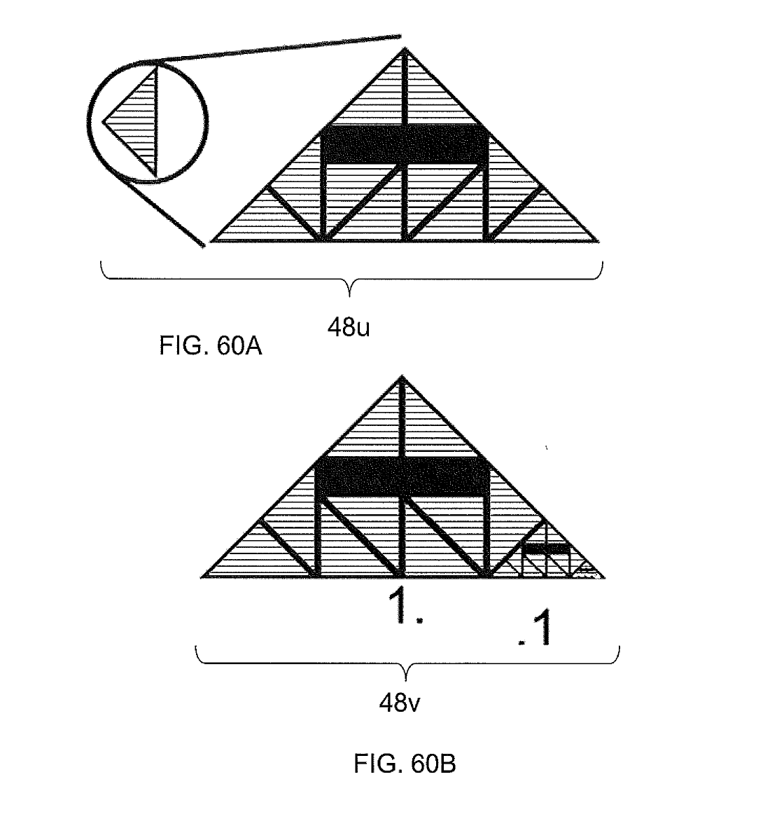

This section will show how Percentages can be done using SHAPE MATH®. When calculating percentages in SHAPE MATH®, the one shapes from each dollar of the total bill are converted into percentage shapes. A percentage shape is best understood within the context of a one shape. Turning to FIG. 60A, percentage representation 48u shows a one shape composed of 10 ten percent pieces which are each one shapes themselves. In FIG. 60B, a ten percent piece can also be broken down into 10 one shapes, which each represent 1 percent of the total shape, as they are each ten percent of ten percent. Percentage representation 48v shows a one shape composed of 9 10 percent pieces and 10 one percent pieces.

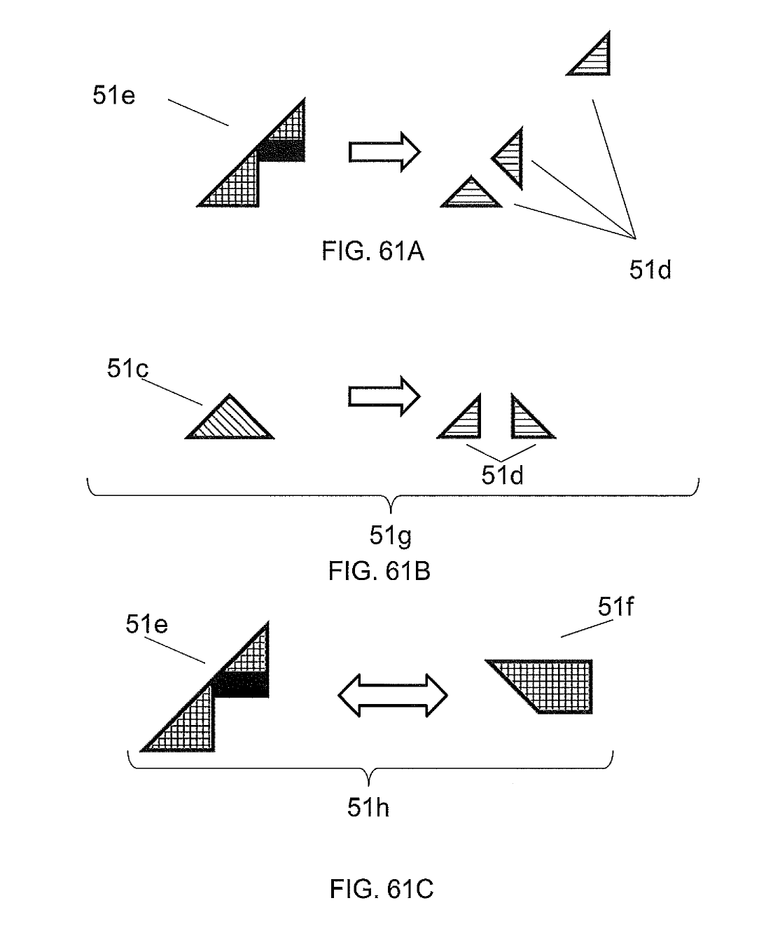

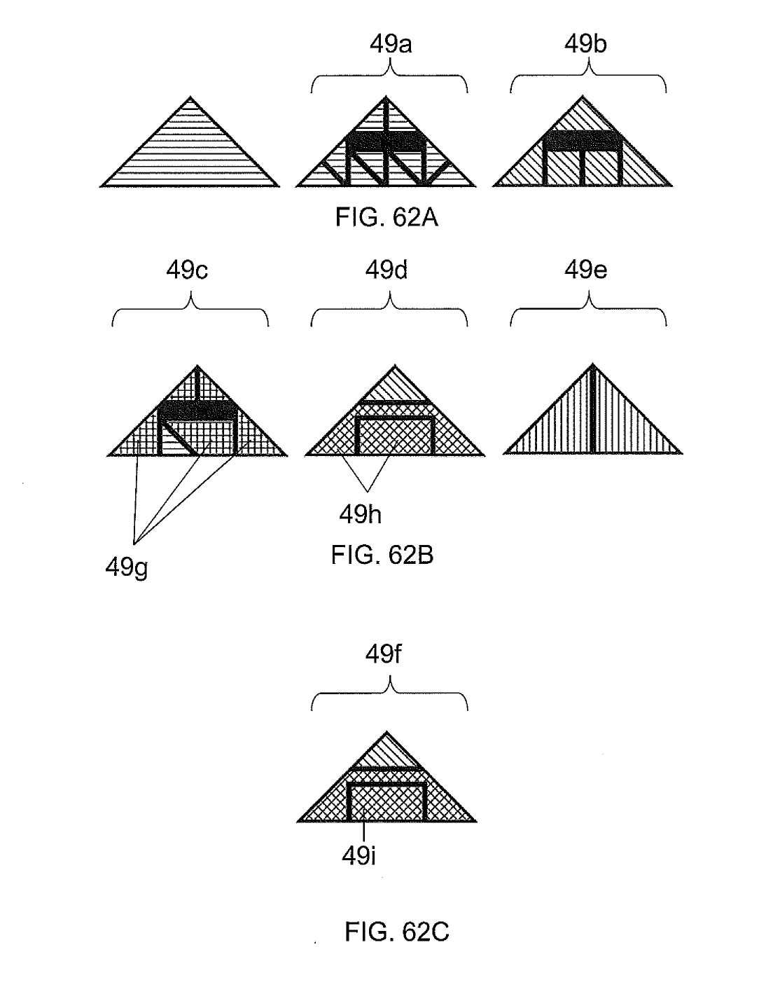

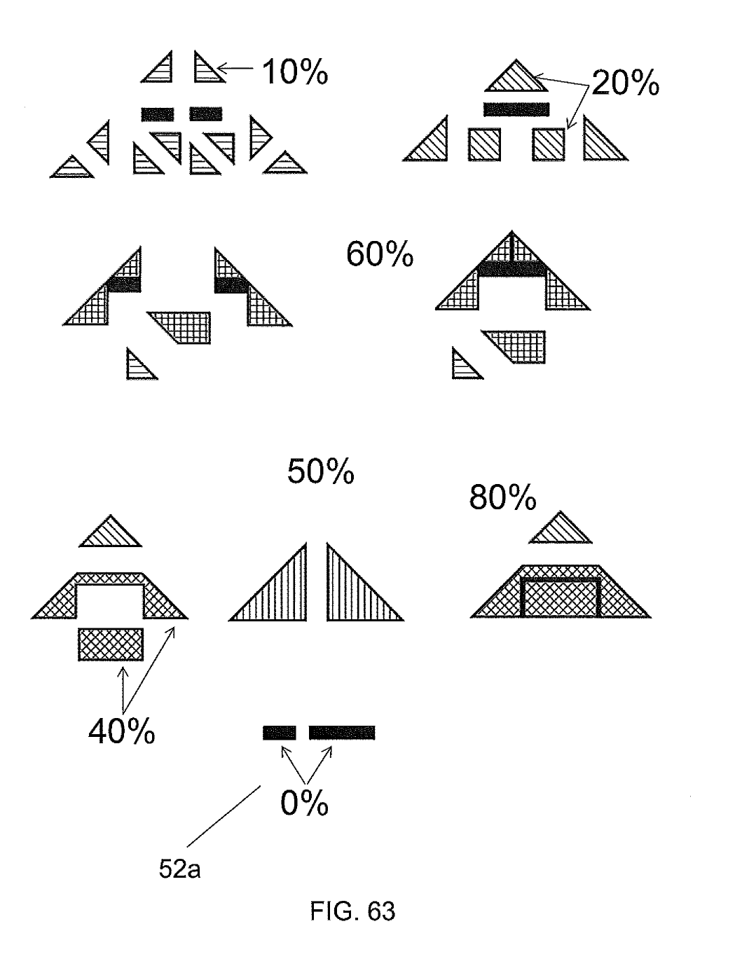

Just as 10 percent pieces are composed of 1 percent pieces, higher percentage pieces that are multiples of ten can be made by compiling 10 percent pieces. Turning to third percentage representation 51g of FIG. 61B, a twenty percent piece 51c is composed of 2 ten percent pieces 51d while a 30 percent piece 51e is composed of 3 ten percent pieces 51d (see FIG. 61A). One should note that some percentages have different specific percentage pieces. Fourth percentage representation 51h (see FIG. 61C) shows that 30 percent can be represented with both thirty percent piece 51e and thirty percent piece 51f. These various forms are required to fit percentage pieces into a triangular one shape, which represents 100 percent. It should be noted that a unique set of zero spacers 52a (shown in FIG. 63) is also needed to achieve this affect. FIGS. 62A-C show all the common percentage pieces within the one shape that represents 100 percent. One shape 49a (see FIG. 62A) is composed of 10 ten percent pieces, one shape 49b (see FIG. 62A) is composed of 5 twenty percent pieces, one shape 49c (see FIG. 62B) is composed of 3 thirty percent pieces 49g and 1 ten percent piece, one shape 49d (see FIG. 62B) is composed of 2 forty percent pieces 49h and 1 twenty percent piece, one shape 49e (see FIG. 62B) is composed of 2 fifty percent pieces and finally, one shape 49f (see FIG. 62C) is composed of 1 eighty percent piece 49i and 1 twenty percent piece. It should be noted that the eighty percent piece looks identical to 2 forty percent pieces. The interior lines and spacers from the compiled 40 percent pieces are left in the eighty percent piece to distinguish it from an outer four shape. FIG. 63 shows the same one shapes from FIGS. 62A-C as they would appear if the percentage pieces were pulled apart.

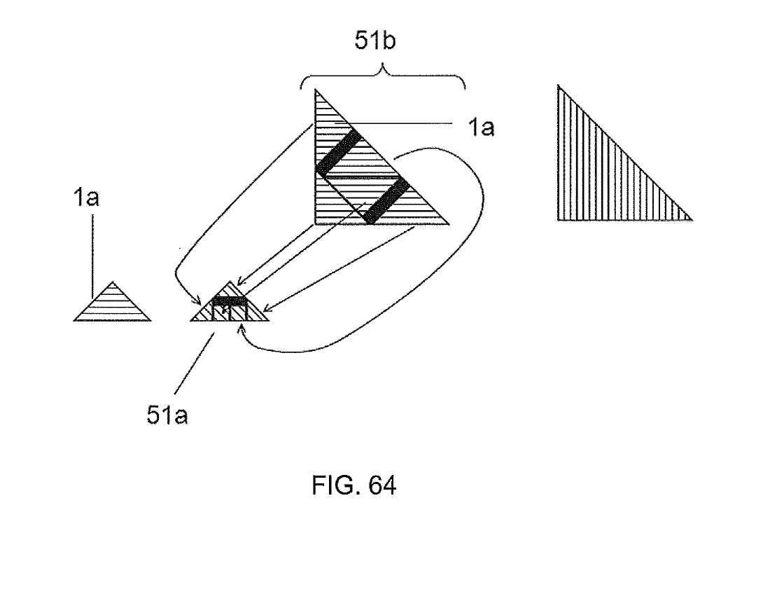

When calculating a percentage, a specific percentage piece will be replicated into a larger shape that represents the answer (referred heretofore as an answer shape). The number of replications depends on the total from which the percentage is taken. Turning to FIG. 64 for an example, the answer shape 51a when calculating 20 percent of 5 would be composed of 5 20 percent pieces. Essentially, each 20 percent piece from the answer shape 51a corresponds to a one shape 1a from the total 51b. While a student would not imagine this process, the visualization shown in this figure would be used as a teaching tool to help a student understand the process involved and what each step represents. Once this conceptual understanding is established, the process can be completed in practice by counting out each percentage piece as it is compiled into the answer shape. In this case, 5 20 percent pieces are counted as they are compiled into answer shape 51a. Because answer shape 51a completes a one shape 1a, it represents 1 dollar, which is 20 percent of 5 dollars.

There is a shortcut to calculate 20% tips that helps for larger checks. As shown in the previous example, 20% of $5=$1. This means that, when calculating 20% tips, each five shape in the total bill can represent a one shape in the tip. The procedure for calculating a 20% tip on a $27 check using this short cut goes as follows.

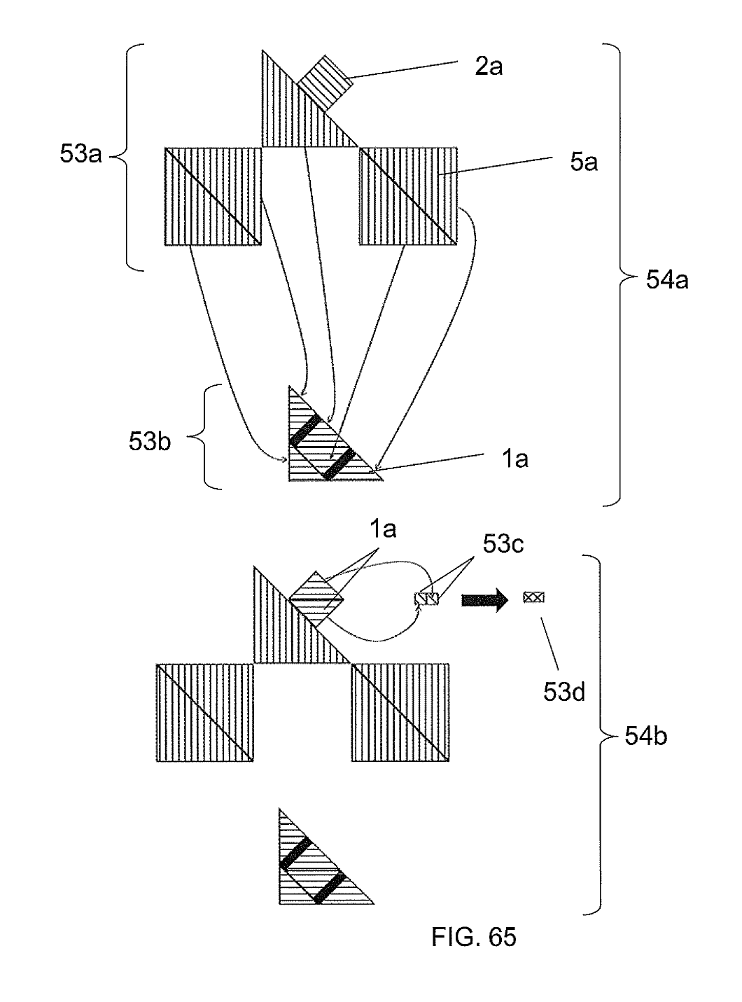

Turning to FIG. 65A, a 27 shape 53a is imagined that represents a 27 dollar check as shown in tip calculation representation 54a. Each five shape 5a within the 27 shape is counted and converted to a one shape 1a in the tip shape 53b, totaling 5 five shapes from the check and thus 5 one shapes in the tip shape 53b. This calculates 20 percent of 25 dollars and yields the answer of 5 dollars. To calculate 20 percent of what remains from the check, which consists of a two shape 2a in this example, the normal SHAPE MATH® percentage techniques are applied. Turning to second tip calculation representation 54b shown in FIG. 65B, the two shape 2a is divided into 2 one shapes 1a that each correlate with a 20 percent piece 53c in the answer. These 2 twenty percent pieces are combined into a forty percent piece 53d that represents 40 cents. A 20 percent tip on a 27 dollar check is therefore 5 dollars (five shape 53b composed of 100 percent pieces) and 40 cents (a 40 percent piece 53d).

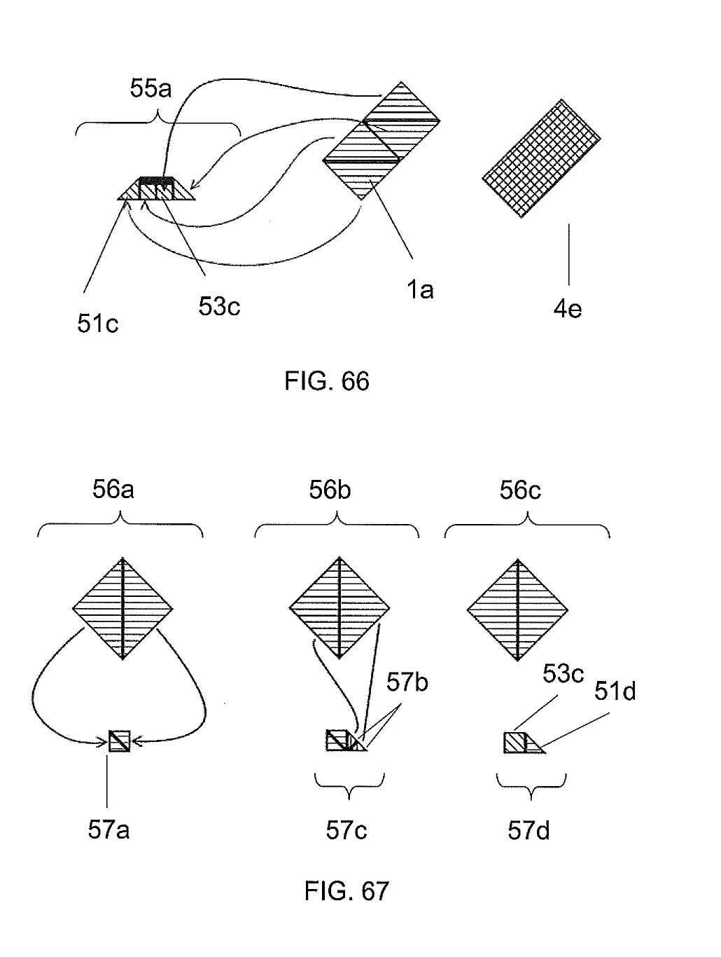

FIG. 66 demonstrates 20% of 4 dollars which does not yield an answer of even dollars. The 4 shape 4e can be broken into 4 one shapes 1a which each correspond to a 20 percent piece 51c and 53c in the answer shape. In practice, a student would simply count each 20 percent piece 51c and 53c as they compile the answer shape 55a stopping at 4 in this case. This answer shape represents 80 percent of a dollar or 80 cents. With practice, students will eventually memorize the different answer shapes that are multiples of ten cents. Until then, the answer shape can usually be recognized by either breaking it into more easily recognized base shapes or totaling the missing shapes from a full one shape and subtracting them from 100. These missing shapes are subtracted from 100 because each full one shape in the answer represents 100 percent of a dollar.

Examples thus far have taken 20 percent of a total; however, other percentages can be calculated. FIG. 67 shows the calculation of 15 percent of 2. When working with percentages that are not a multiple of ten, the problem is broken into stages that are easier to calculate. In this example, 10 percent of 2 is calculated, 5 percent of 2 is calculated and then these calculations are added for the final answer. To calculate 10 percent of 2, a 10 percent piece is replicated 2 times to make sub answer shape 57a as shown in first tip finder representation 56a. Then, 5 percent of 2 is calculated by compiling 2 five percent pieces 57b which are added to sub answer shape 57a to make answer shape 57c as shown in second tip finder representation 56b. The mental process behind visualizing the 5 percent pieces involves understanding that 5 percent is 50 percent of 10 percent so that a 10 percent piece can be broken in half to make 2 five percent pieces. Answer shape 57c can be converted to answer shape 57d, which replaces 2 ten percent pieces with 20 percent piece 53c and replaces 2 five percent pieces with ten percent piece 51d indicating the final answer of 0.3 or 30 cents as shown in third tip finder representation 56c.

Digital Shape Math® is a computer implemented learning system in which the Shape Math® unique geometrical shapes are manipulated on an interface. All the techniques and examples disclosed above can be performed on the digital interface. The interface can be run through a web page visualized on a personal computer, an electronic/digital tablet, a smart phone or any other device in the art whether run on any operating system such as a Windows, an Android, an Apple OS or iOS operating system. It is also contemplated that the system can be run wholly on devices without internet access to a web page. The geometrical shapes and how they are used for calculations are the same as discussed above. Presented below are numerous embodiments of a method to implement the system utilizing a digital interface. One skilled in the art will appreciate that there could be numerous variations of the interface and hence the present invention is not limited to the embodiments described below.

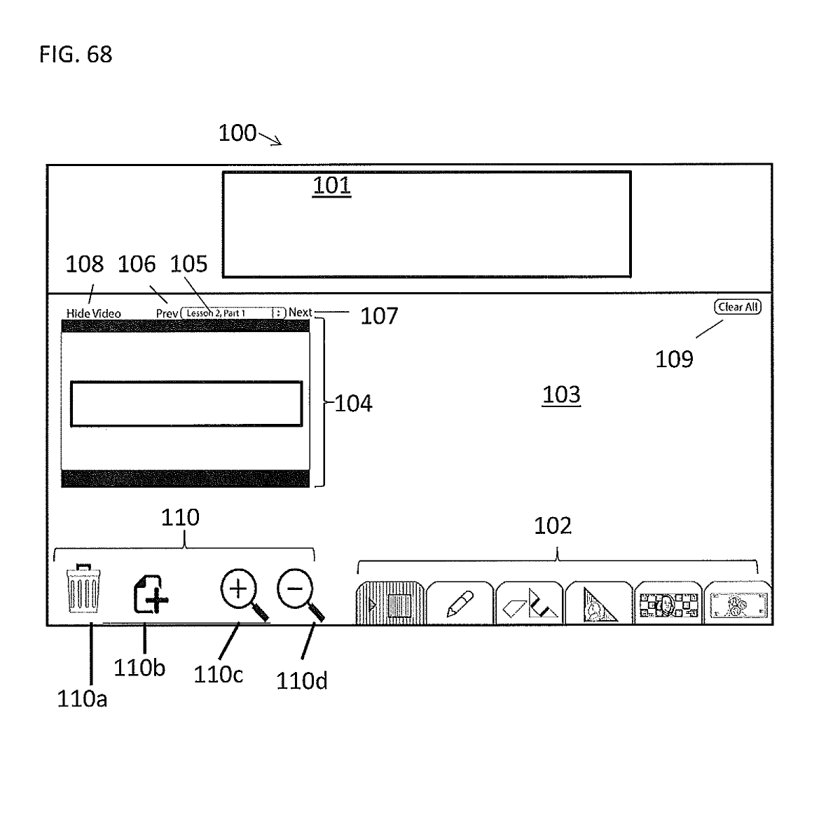

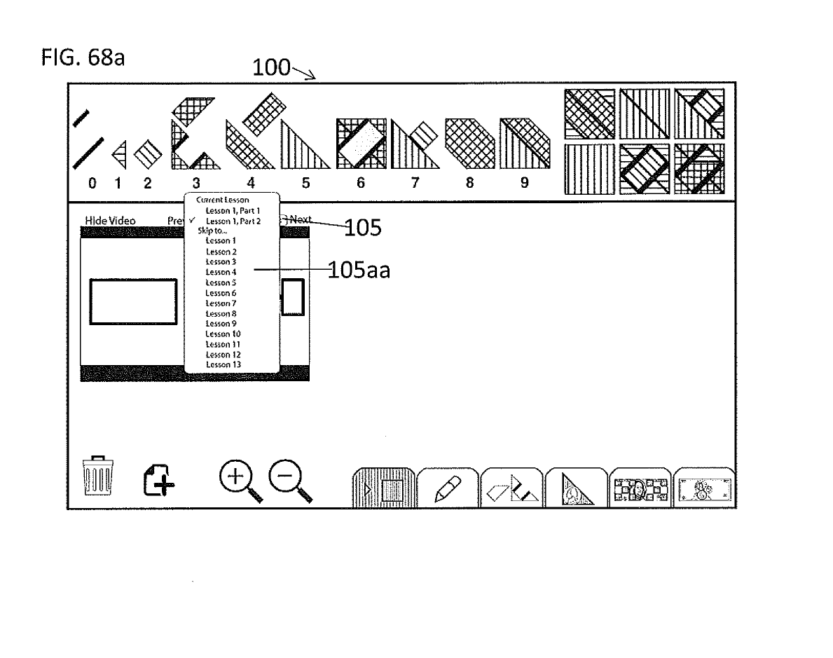

Presented in the various figures below are preferred embodiments of the Digital Shape Math® user interface 100. The user interface can be displayed using a web application that runs on devices such as but not limited to Macintosh computers, personal computers, tablet computers, smart phones, etc. An example of a screen shot is shown in FIG. 68. At the top of the user interface 100 is the shape bar 101. The shape bar is where various geometrical shapes representing numeric values and forms of currency can be retrieved. The items in the shape bar will change according to which of the interface tabs 102 is selected. For this reason, the specific items and the specific tabs and their functions will be described in more detail later in the document. Below the shape bar is the work surface 103. This is where the user can drag the items to manipulate them.

In a preferred embodiment, the Shape Math® program is taught through a series of interactive video lessons that are integrated into the Shape Math® web app. See FIG. 68A. Preferably, these videos cover addition, subtraction, multiplication, division, working with money and converting different units of time. The student digitally manipulates the Shape Math® pieces while following along with the Shape Math® lesson videos. Using videos for the lessons allows the student to teach themselves independently without having to read. In a preferred embodiment shown in FIG. 68, under the shape bar 101 to the left is the integrated video player 104. This allows the student to follow the video lessons as they manipulate the items. In the top right corner of the video player 104 is a drop down menu 105. Turning to FIG. 68a, when the drop-down menu 105 is activated, a list of lessons and their parts that the student can choose from is shown 105aa. Most preferably the videos should be followed in order because each video builds on skills learned in the previous lessons. However, as they are going through the program the user can review specific lessons at any time.

Turning back to the preferred embodiment in FIG. 68, at the top middle of the video player 104 is the previous button 106 which takes the user to the previous lesson. At the top right of the video player 104 is the next button 107 which takes the user to the next lesson clip. In the upper left of the video player 104 is the hide video option 108 which hides the video when selected. The video player 104 can also be made full screen. In the upper right corner underneath the shape bar 101 is the clear all button 109. The clear all button 109 clears all the items that are on the work surface 103 and any writing that was done on the work surface 103. Writing will be explained later in the document. In the lower left corner is the workspace manipulator 110. The workspace manipulator 110 can include the standard workspace manipulator icons, The trash can icon 110a is used to delete items. After selecting an item or items, the user can click on the trash can icon 110a and these items will be deleted. The user can also drag items into the trash can icon 110a. To the right of trash can icon 110a is the duplicate icon 110b used to duplicate items. You can duplicate items by selecting an item or a group of items and clicking the duplicate icon 110b. Users can also copy items by dragging them to the duplicate icon 110b. To the right of the duplicate icon 110b is the zoom in icon 110c indicated by a plus sign within a magnifying glass. The zoom in icon 110c is used to increase the size of the items in the workspace 101. To the right of the zoom in icon 110c is the zoom out icon 110d indicated by a minus sign within a magnifying glass. The zoom out icon 110d is used to reduce the size of the items in the workspace. Using zoom in icon 110c and zoom out icon 110d does not affect the size of the items in the shape bar 101. This is an example of a manipulator that displays when the standard shapes are used. However, any practical manipulator can be used.

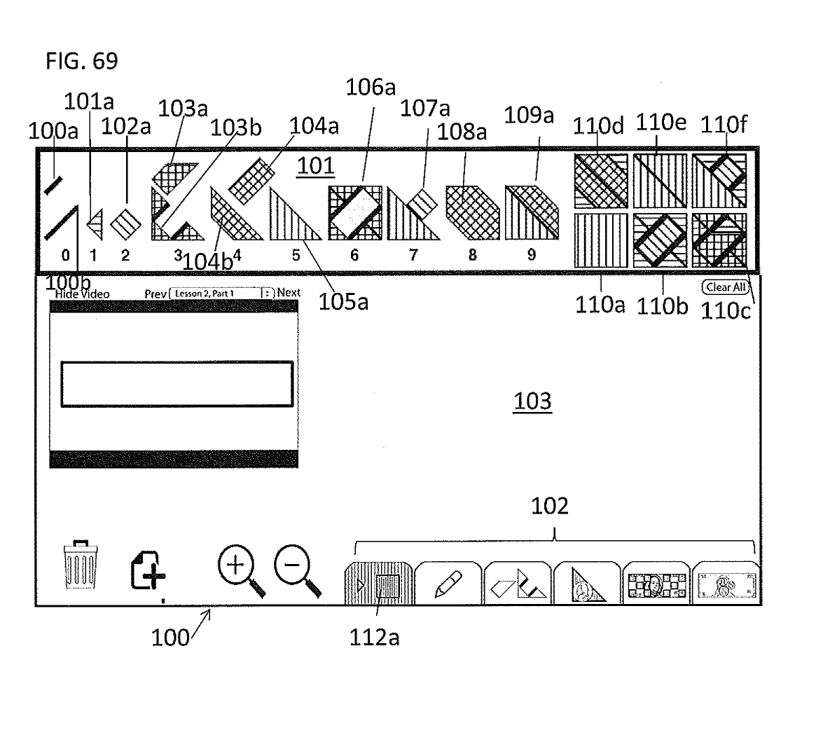

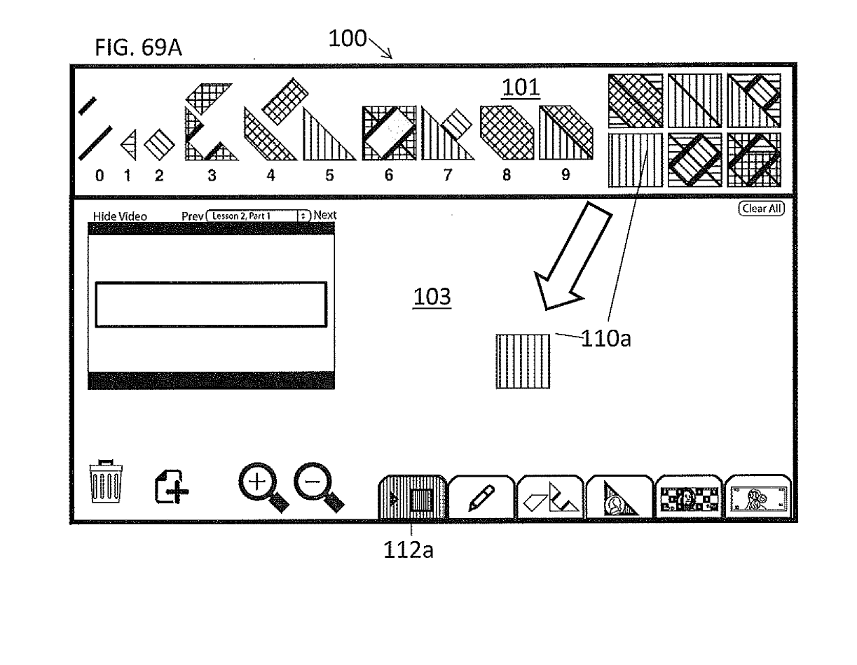

Turning to FIG. 69 for a description of the interface tabs 102 and how they change the shape bar 101 and work surface 103. The user can activate a particular tab of the interface tabs 102 by maneuvering the mouse cursor over, for example, shape piece tab 112a and clicking on it or, when using a touch screen, by tapping, for example, shape piece tab 112a with their finger or other appropriate indicators, such as a light pen.

The standard shape piece tab 112a, shown in FIG. 69, is the far left tab of the interface tabs 102. When selected, standard shape piece tab 112a displays a standard array of Shape Math® pieces in shape bar 101. From left to right, the shape pieces are as follows: a short zero spacer 100a, the long zero spacer 100b, a one shape 101a, a two shape 102a, an outer three shape 103b, an inner three shape 103a, an outer four shape 104b, an inner four shape 104a, a five shape 105a, a six shape 106a, a seven shape 107a, an eight shape 108a, a nine shape 109a, and 6 different variations of a ten shape. These variations of the ten shape are the same variations seen on the Shape Math® cube previously discussed. The variations of ten shapes going from left to right top are: a ten shape made with 2 one shapes and 2 outer four shapes 110d; a ten shape made with 2 fives shapes 110e; a ten shape with a five shape, a two shape, 3 one shapes and 2 zero spacers 110f; and from left to right on the bottom are: a solid ten shape 110a; a ten shape made with 2 two shapes, 6 one shapes and 2 long zero spacers 110b; a ten shape made with 2 outer three shapes, an inner three and a one shape 110c. When the standard piece tab 112a is selected, a user may choose to manipulate any of the shape pieces mentioned above by clicking on and dragging the desired shape piece onto the work surface 103. When using other interface tabs 102, other items will be displayed in shape bar 101 and can be clicked and dragged to the work surface 103 in the same way. Other interface tabs 102 and the items they make available in the shape bar 101 will be discussed as the document continues.

Turning to FIG. 69a, an example is shown of dragging an item as symbolized by the outline arrow from the shape bar 101 on to the work surface 103. The item dragged is a solid 10 shape 110a selected from the shape bar 101 while the standard piece tab 112a is selected.

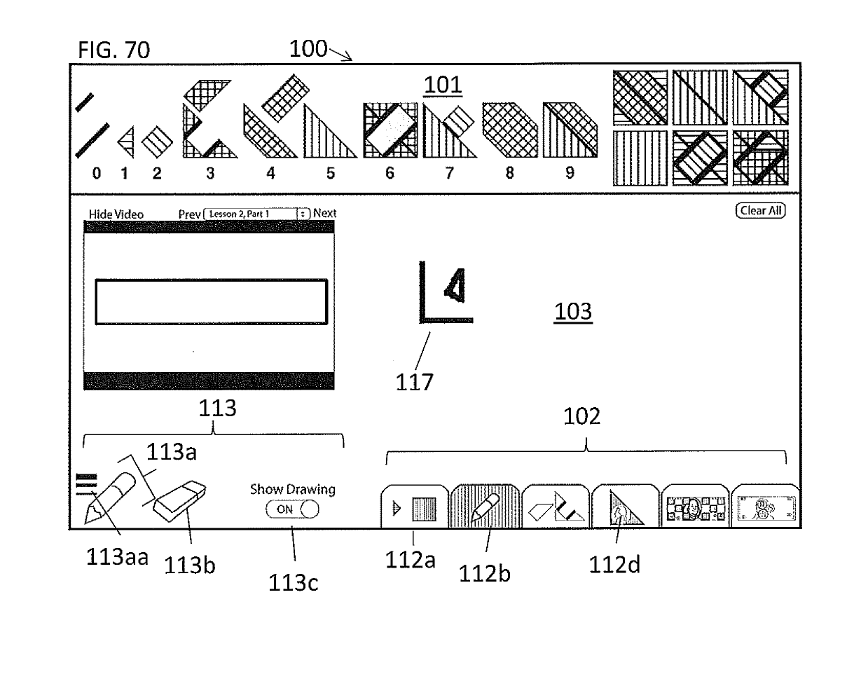

Turning to FIG. 70, the second tab from the left of the interface tabs 102 is the writing tab 112b. The writing tab 112b replaces the standard workplace manipulator icons 111 with the writing icons 113. The writing icon to the far left is the pencil icon 113a indicated by a pencil next to three lines of varying thickness 113aa. When using a mouse, activating the pencil icon 113a causes the cursor to draw a line instead of moving pieces. When using a touch screen, activating the pencil icon 113a causes a line to be drawn when the user moves his or her finger on the work surface 103.

An example of something drawn in the writing tab on the work surface 103 is seen in a drawing of a one shape surrounded by zero spacers 117. When using a mouse, the user may click any of the three lines of varying thickness 113aa to cycle through the three different line thicknesses. When using a touch screen, the user may tap any of the three lines of varying thickness 113aa to cycle through the three different line thicknesses. To the right of the pencil icon 113a is the eraser icon 113b. When the eraser icon 113b is activated, the cursor erases lines made by the pencil icon 113a. Also in FIG. 70, to the right of the eraser icon 113b is the show drawing icon 113c. When the show drawing icon 113c is in the ‘on’ position, lines made with the pencil icon 113a remain visible. When the show drawing icon 113c is in the ‘off’ position, lines made by the pencil icon 113a are hidden.

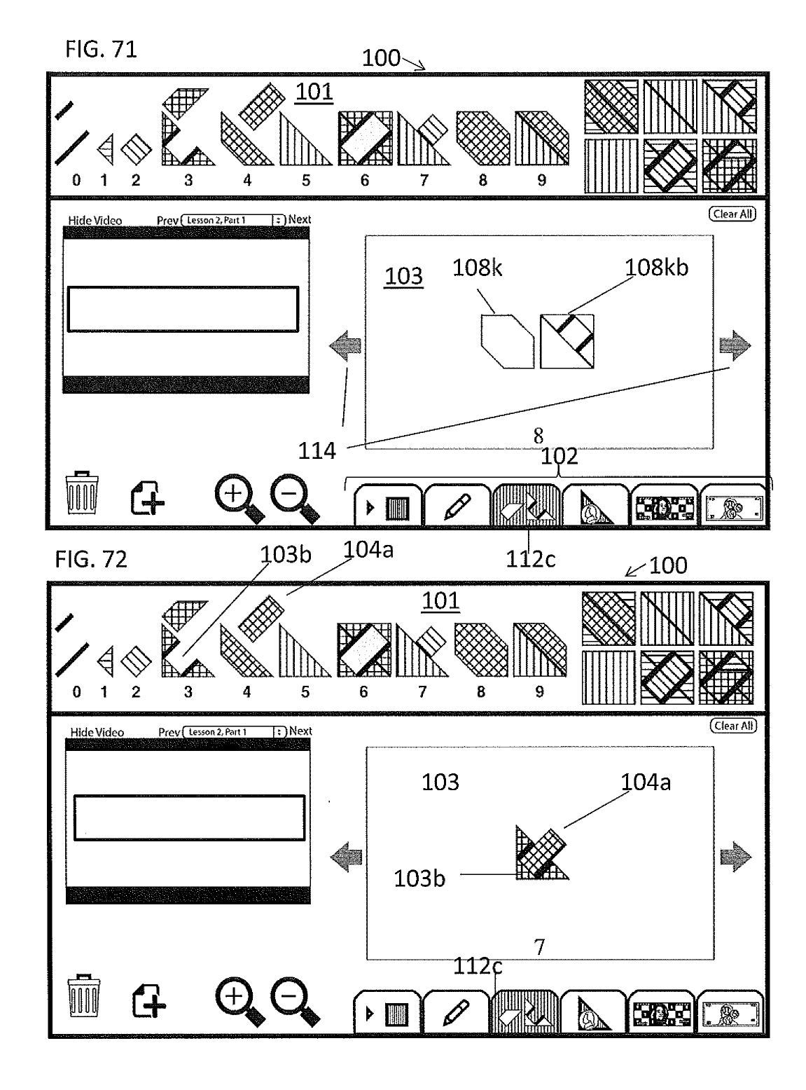

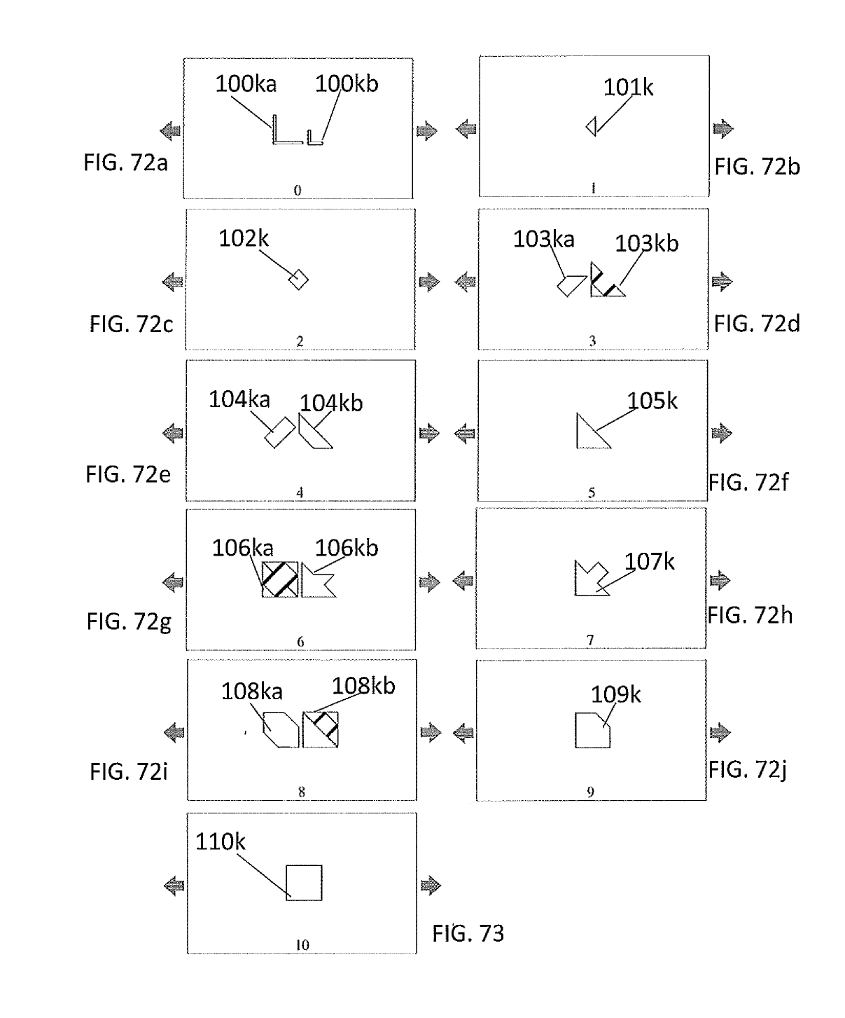

Turning to FIG. 71, the third tab from the left of the interface tabs 102 is the outline tab 112c. In this preferred embodiment, when activated, outline tab 112c displays outlines of Shape Math® numbers on the work surface 103. These outlines are displayed one digit at a time. For example, FIG. 71 shows the digit eight which is displayed on the work surface 103 in two different forms; an outline of an eight shape 108k and an outline of a five form eight shape 108kb. The user may cycle through digits zero through ten by using the outline arrows or the arrow on a keyboard. Digits zero, three, four, six and eight each include two outlines. Digits two, five, seven, and nine include only one outline. The user can drag shapes from the shape bar 101 onto the outline shapes to better understand how the Shape Math® pieces combine into larger Shape Math® numbers. FIG. 72 shows the outline shape for digit seven after it has been overlaid with an inner four shape 104a and outer three shape 103b.

FIGS. 72a-73 show the preferred outline shapes that can be displayed.

Turning to FIG. 72a the outline is shown of the zero shape and is made of both long zero spacers 100ka and the short zero spacers 100kb. Turning to FIG. 72b the outline for the one shape 101k is shown. Turning to FIG. 72c, the outline for the two shape 102k is shown. Turning to FIG. 72d the outlines for the inner three shape 103ka and an outer three shape 103kb are shown. Turning to FIG. 72e, the outlines for the inner four shape 104ka and the outer four shape 104kb are shown. Turning to FIG. 72f the outline for the five shape 105k is shown. Turning to FIG. 72g the outlines for the six shape made out of two outer three 106ka and the outline of a five form six shape 106kb are shown. Turning to FIG. 72h the outline for the seven shape 107k is shown. Turning to FIG. 72i the outline for the eight shape 108ka and the five form eight shape 108kb are shown. Turning to FIG. 72j the outline of a nine shape 109k is shown. Turning to FIG. 73 the outline of a 10 shape 110k is shown. In other embodiments, outline shapes may be displayed on the shape bar and manipulated on the work surface in the same way as shown for the standard shape pieces.

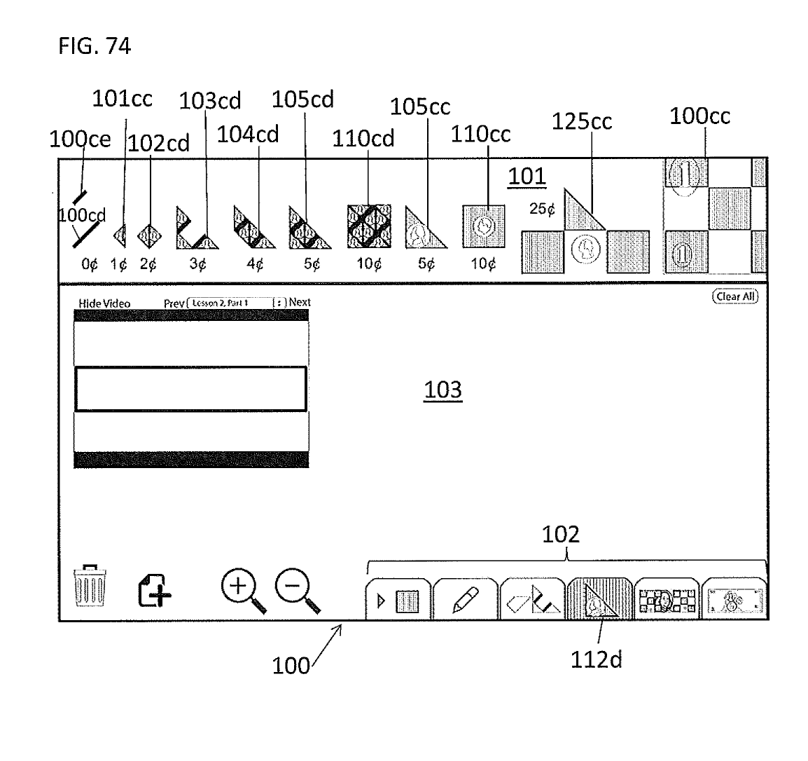

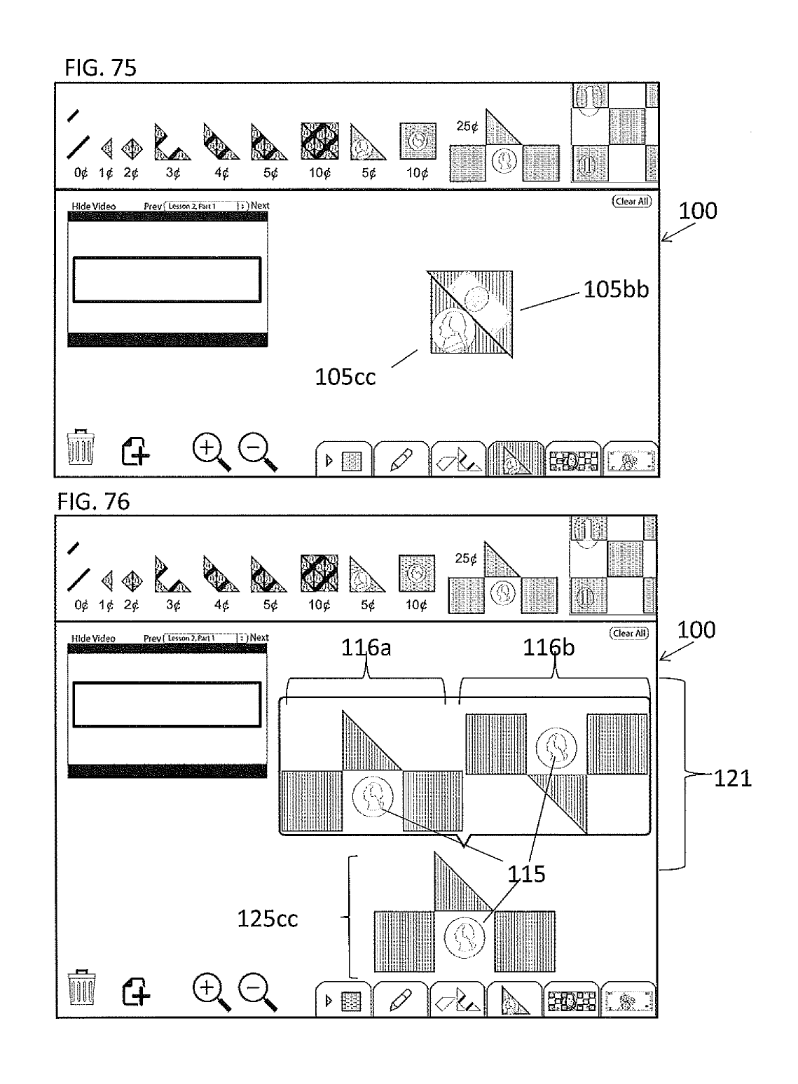

The next several figures describe the system used to teach students how to work with and how to handle money. Though U.S. currency is shown in these examples, Shape Math® can be adapted to work with any other country's currency. Turning to FIG. 74, the fourth tab from the left on the interface tabs 102 is the coin tab 112d. The coin tab 112d displays the Shape Math® coin pieces in the shape bar 101. From left to right the pieces are as follows: Shape Math® coin short zero spacer 100ce, Shape Math® coin long zero spacer cd, Shape Math® Penny 101cc, 2 Shape Math® pennies combined in a two shape 102cd, an outer three piece made of Shape Math® pennies 103cd, an outer four piece made of Shape Math® pennies 104cd, a five piece made of Shape Math® pennies 105cd, a ten piece made of pennies 110cd, a Shape Math® nickel 105cc, a Shape Math® dime 110cc, a Shape Math® quarter 125cc and a one dollar bill consisting of a hundred pattern 100cc. The Shape Math® coins are intentionally smaller than the Shape Math® bills so that a student does not confuse the two. Turning to FIG. 75 for an example, a Shape Math® five dollar bill 105bb is larger than a Shape Math® nickel 105cc and thus do not fit together. One difference between the digital Shape Math® money and the physical Shape Math® money is that the digital coins and bills of the digital Shape Math® money stay right-side up when changing the orientation of their piece. Turning to FIG. 76 for an example, the quarter 115 inside the Shape Math® quarter 125cc stays right side up when displayed in both its lower orientation 116a and upper orientation 116b. This would be impossible with physical pieces discussed earlier.

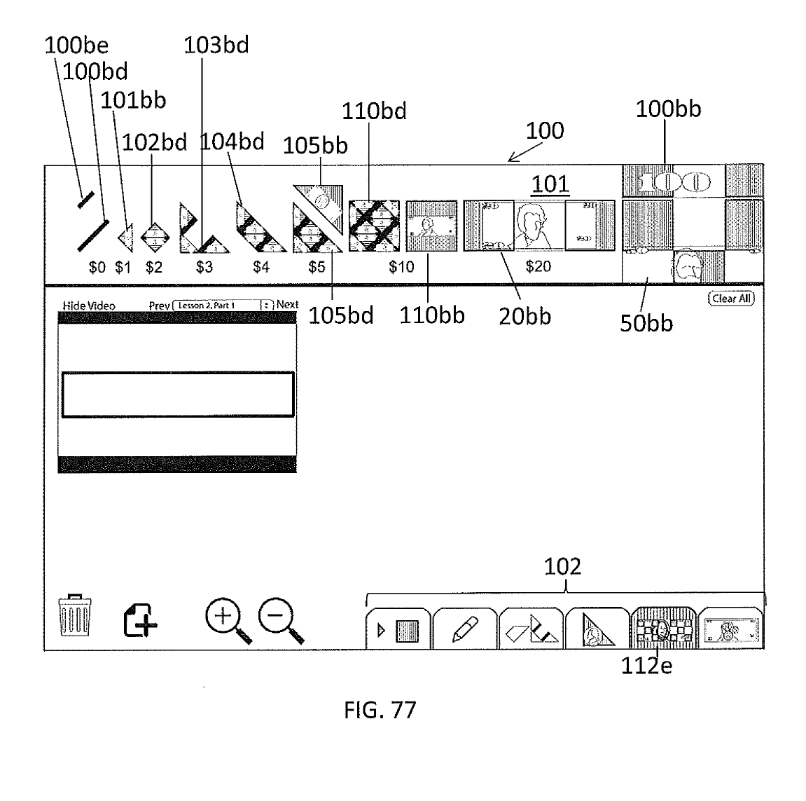

Turning to FIG. 77, the fifth tab from the left on the interface tabs 102 is the bills tab 112e. The bills tab 112e displays the Shape Math® bills in the shape bar 101. From left to right the shape bar 101 displays, Shape Math® Bill short zero spacer 100be, Shape Math® Bill long zero spacer 100bd, a Shape Math® dollar piece 101bb (made from a one piece as opposed to the Shape Math® dollar bill which is comprised of a one hundred pattern), a two piece made of dollar pieces 102bd, an outer three piece made of dollar pieces 103bd, an outer four piece made of dollar pieces 104bd, a five piece made from dollar pieces 105bd, a Shape Math® five dollar bill 105bb, a ten piece made of dollar pieces 110bd, a Shape Math® ten dollar bill 110bb, a Shape Math® twenty dollar bill 20bb, a Shape Math ® fifty dollar bill 50bb, and a Shape Math® one hundred dollar bill 100bb. The images of real money bills inside the Shape Math® bills stay as upright as possible within the confines of the shape of which they are a part.

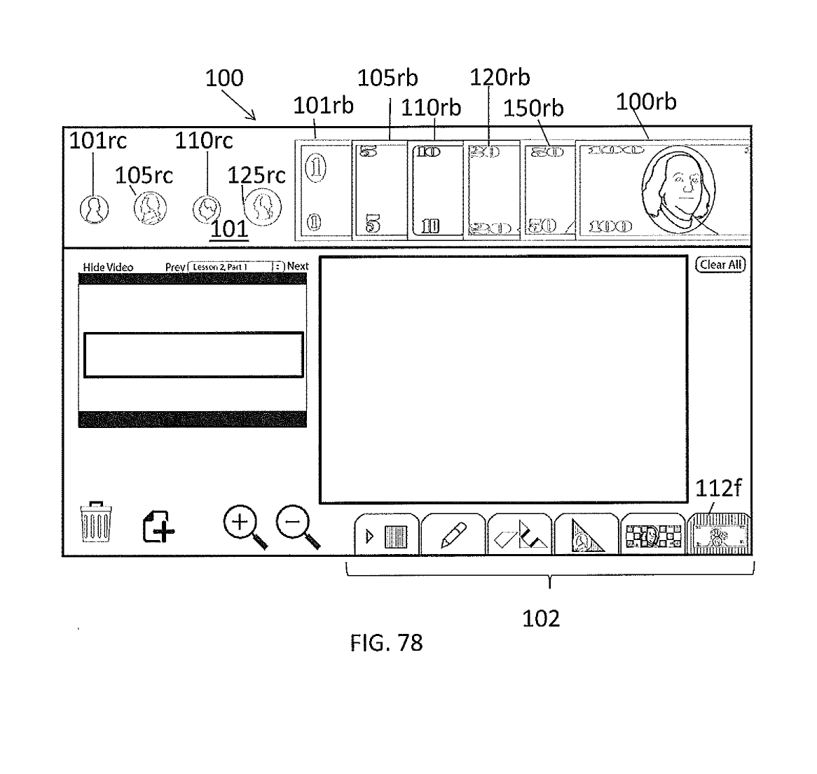

Turning to FIG. 78, the sixth tab from the left on the interface tabs 102 is the real world money tab 112f. The real world money tab 112f displays in shape bar 101 an array of coins and bills made from images of actual money. From left to right the coins and bills are: a penny 101rc, nickel 105rc, dime 110rc, quarter 125rc, one dollar bill 101rb, five dollar bill 105rb, ten dollar bill 110rb, twenty dollar bill 120rb, fifty dollar bill 150rb, and one hundred dollar bill 100rb. The coins in the real world money tab are the same size as the coins inside the Shape Math® money with the exception of the pennies which are larger than the Shape Math® pennies. The bills and coins in this array are selectable as pieces in the same way as the pieces available in other tabs.

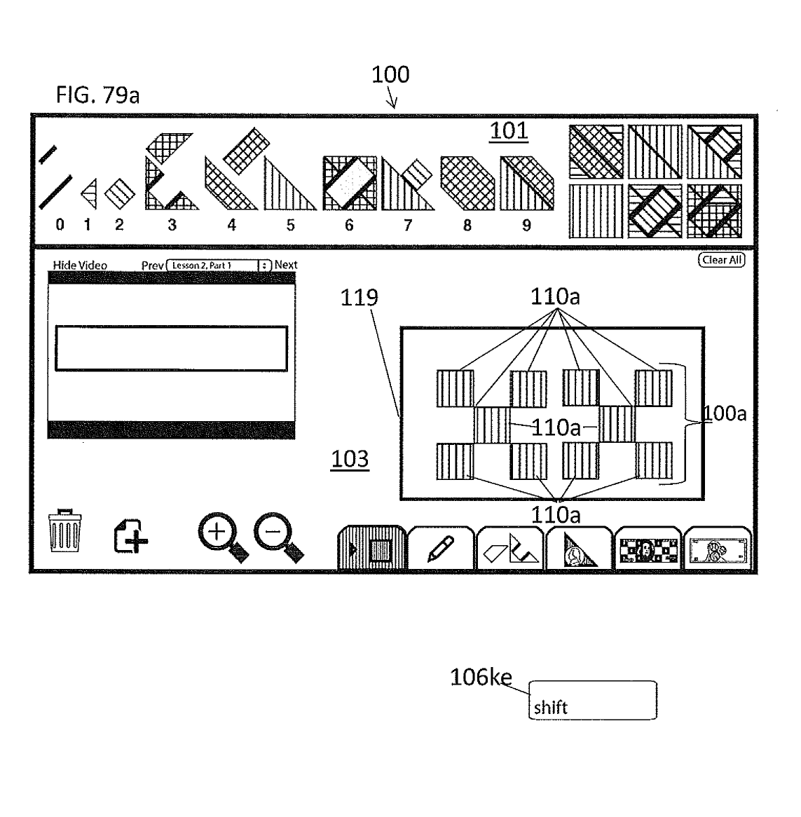

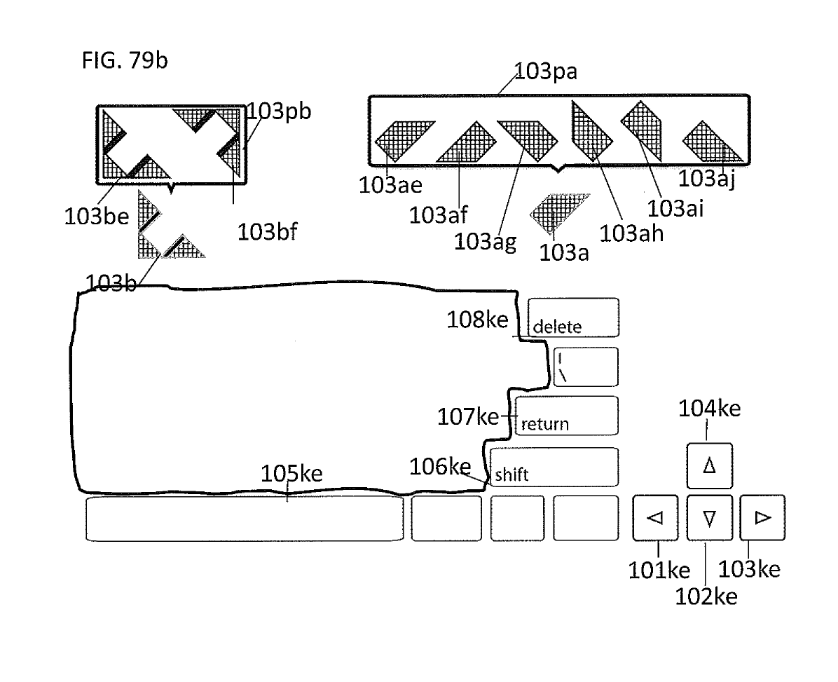

Turning to FIG. 79a, a user can select and manipulate items displayed in the shape bar 101. To retrieve an item from the shape bar 101 the user will click and drag the item onto the work surface 103. Users may drag as many items as they desire to the work surface 103. For example, the user could click and drag 10 ten shapes 110a onto the work surface and move them into the pattern of one hundred 100a. Items on the work surface 103 can be selected by clicking on the item and moved by clicking and dragging the item. A user can select more than one item on the work surface 103 at a time by clicking and dragging a selection box 119 over the desired group of items or for example, holding shift key 106ke while clicking on each desired item.

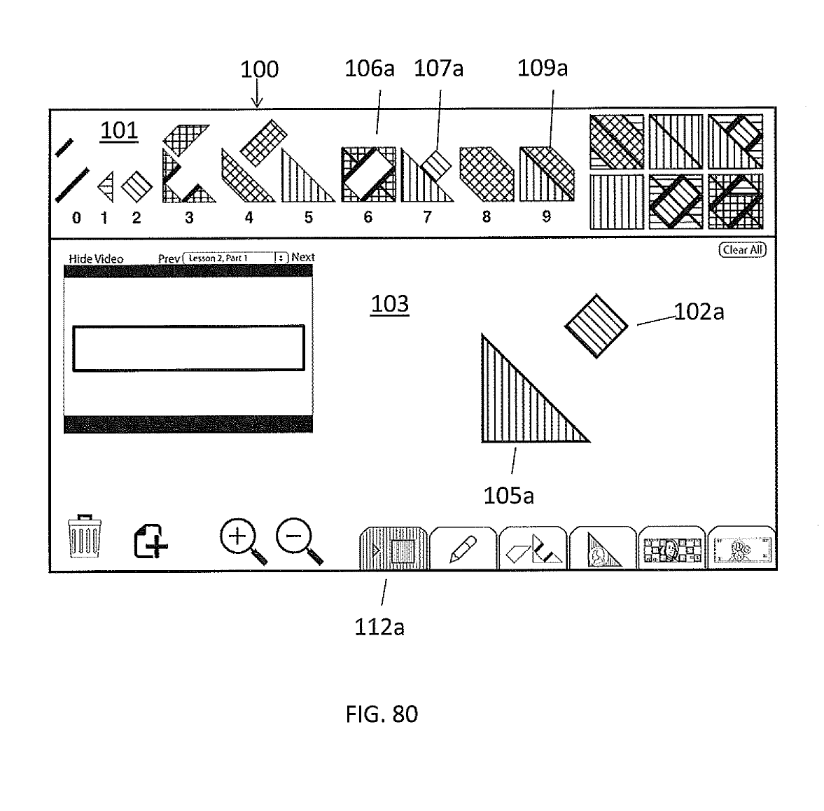

The orientation of the figures can be changed in any way known in the art. For example, in FIG. 79b, the user can double-click with a computer mouse to cycle through the different available orientations of that item. Every double-click changes the orientation once. For example, the outer three shape piece 103b can be in two orientations 103be or 103bf and cycled back and forth between both orientations 103pb. 103pa shows an example of all the orientations (103ae-103ai) of the inner shape three 103a. The user can also press the spacebar 105ke on a keyboard to display a pop-up menu of all the orientations for the item selected. The user may also cycle through available orientations using the left and right arrow keys 101ke and 103ke. Certain items are equivalent such as the inner three shape and outer three shape. When available, the user can cycle through items of the same quantity using the up and down arrow keys 104ke and 102ke. Alternatively different orientations can be selected by the user by clicking with mouse on a specific shape multiple times with the cursor, each click showing a different orientation of the specific shape. In a preferred embodiment shown in FIG. 80, some of the pieces in the shape bar 101 displayed when the standard piece tab 112a is selected are composed of smaller constituent pieces. These pieces stay locked together until the user is done dragging them to the work surface 103. Once on the work surface 103, the constituent pieces behave as separate pieces. For example, if the user were to drag the seven piece 107a onto the work surface 103, the constituent five piece 105a and two piece 102a move as one. Once the seven piece 107a is placed, the five piece 105a and two piece 102a will behave separately. If the user were to click and drag the five piece 105a from the two piece 102a, the two piece will remain in its location. In this embodiment, this property is exclusive to the six piece 106a, the seven piece 107a and the nine piece 109a.

Some preferred features that enhance the functionality of the Digital Shape Math® system will be discussed next. One skilled in the art will appreciate that there are variations of these enhanced features. The present invention is not limited to these examples.

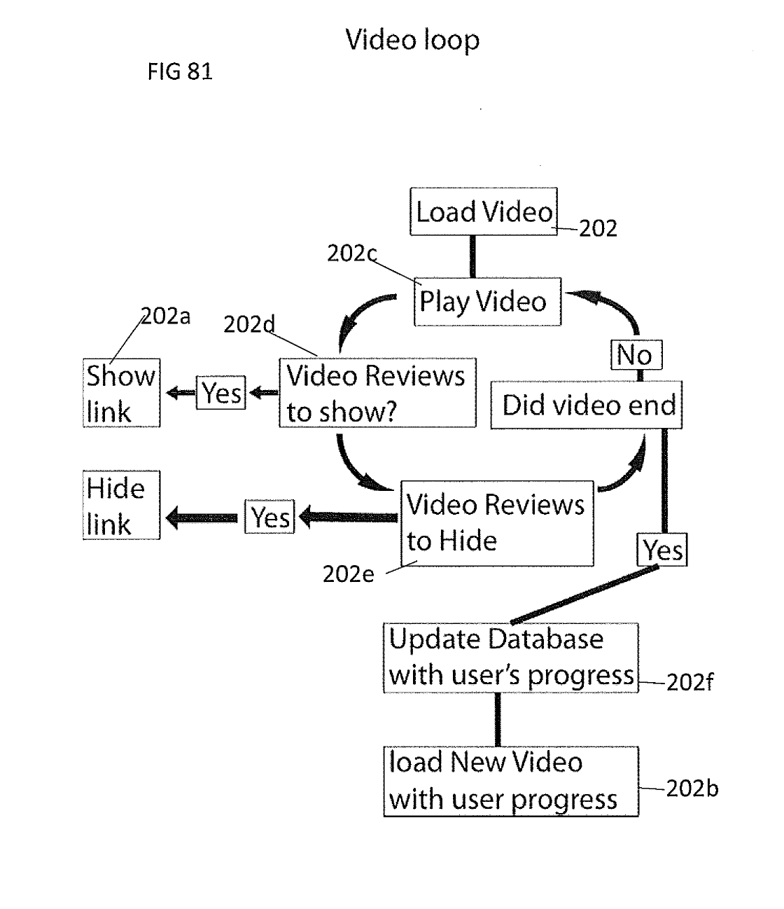

FIG. 81 is a diagram showing a preferred embodiment of the process for checking for video review links. This diagram begins when the video is loaded 202 and the video begins to play 202c. The program checks to see if there is a review link 202d. If presents, it displays 202a. Then there is a check to see if there is a hide video command in the database 202e. When the hide video function is engaged, the annotation and screen links are switched off. If a new video is played, the database is then updated with the user's progress 202f. Loading a new video 202b brings us back to the beginning of the loop to load a new video 202.

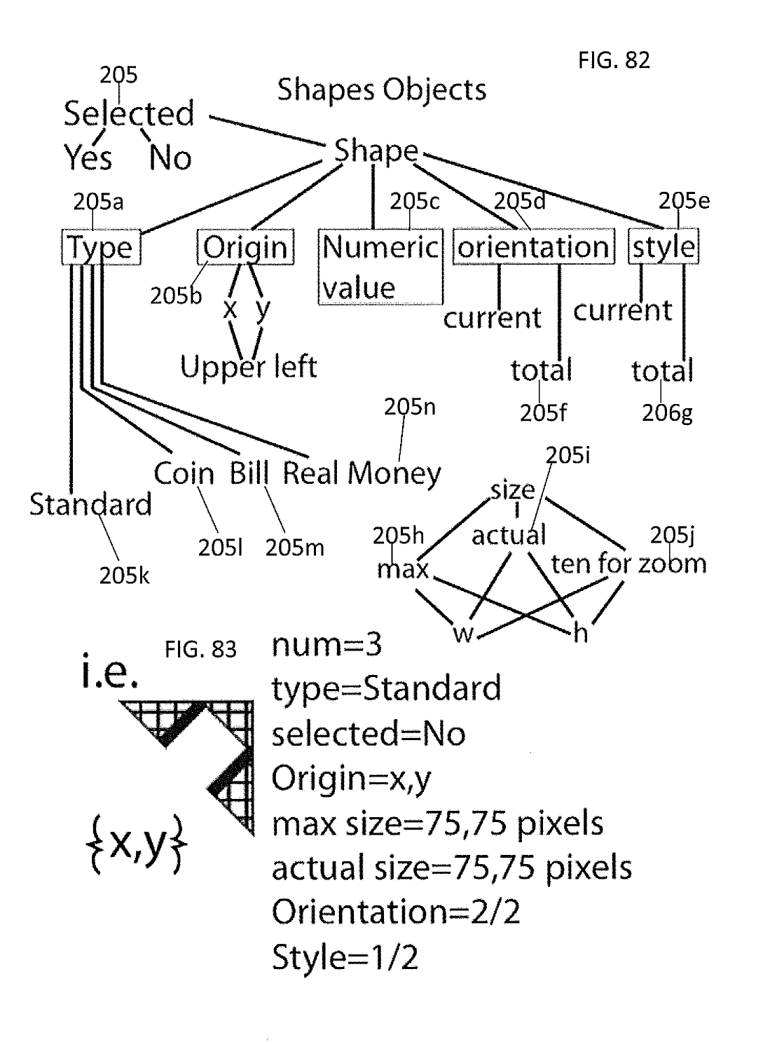

In preferred embodiments, specific information is stored for each object on the interface as shown in FIG. 82. For example, whether or not the object is selected 205, what type of object it is 205a: standard (numbers zero to ten), 205k Shape Math® coins 205l, shaped math bills 205m, or the real-world money 205n, and the origin of the Shape 205b is stored. The program also keeps track of the shape's numeric value 205c—whether it is a three shape or two shape for example. It also keeps track of the orientation of the piece 205d. Some pieces have many orientations such as an inner three and others have only one, so the program keeps track of the current orientation (stored by a numeric value—i.e. ‘1’) as well as keeping track of the total number of possible orientations 205f a shape with this numeric value and style could possess. The program keeps track of what style the shape is 205e. Style in this context means whether the shape is an inner shape or an outer shape. An example is an inner and outer three which would have a current style value of 1 and 2 respectively. These two three shapes are stored in the program as the same value but are stored as a different style. An example of the different values stored for a piece can be seen in FIG. 83. The total number of orientations is stored as to appropriately size the border for the pop up of the multiple orientations for that shape.

There are three size values stored for each piece on the interface, the maximum size 205h, the actual size 205i and the size of a 10 shape at the current zoom level 205j. When determining if a shape has been clicked on by the user, the max size is used as a quick test to see if the user interaction is with the perimeter of a rectangle formed by the max size of the shape at the shape's origin. If the click is within said perimeter, then the actual size of the shape is used more precisely to determine if the click is in fact within the shape's actual perimeter. The size of a ten shape for the zoom level is stored to be able to compare shape sizes relatively with a normalized value. The ten size was chosen because all shapes with numeric values less than or equal to ten (i.e. a one shape, a two shape, an outer three shape . . . a ten shape) fit within the ten shape.

In the last set of figures, examples are provided showing how the present invention can be used to teach students to perform basic math operations and how to use currency. Though the examples given here are relatively simple, they are the basis of how to perform more complex operations and more complex uses of currency. The computer implemented system of Digital Shape Math® is not limited by these examples. One skilled in the art will appreciate that there are infinite numbers of math problems or operations that can be performed using the present invention. One skilled in the art will also appreciate that there are numerous ways of demonstrating the different combinations of currency, and though U.S. currency is shown in these examples, the presented invention can be adapted to any foreign currency.

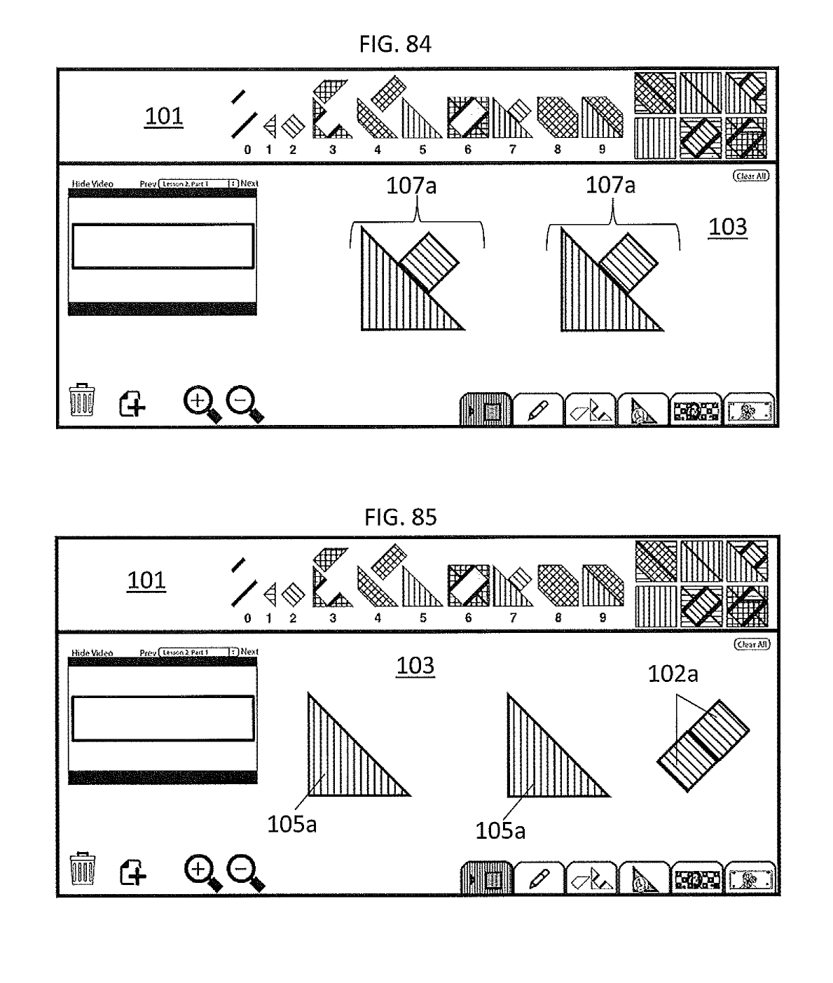

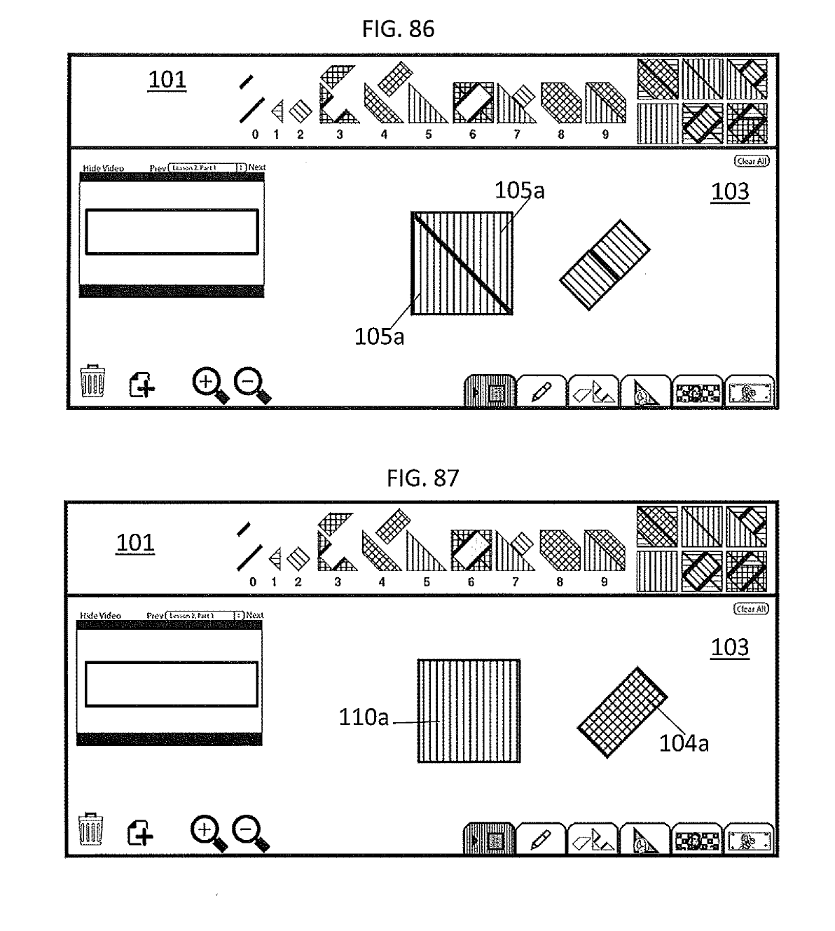

As shown earlier in the application, the basis of performing the math operations is the utilizing the formation of the ten shape, and then proceeding as necessary to solve the problem. The first example demonstrates the problem 2×7. As in the Shape Math® system presented earlier, 2 seven shapes are selected and the individual pieces making up the seven shapes are separated and rearranged. The 2 five shapes are put together which make the shape of a ten, and the 2 two shapes are rearranged to make the shape of an inner four. So you have the ten shape and the inner four or 14. Utilizing the computer implemented system of the present invention, this process might look like something that is shown in FIGS. 84-87. In FIG. 84, a student would drag 2 seven shapes 107a from the shape bar 101 onto the work surface 103. Turning to FIG. 85 the student takes the 2 two shapes 102a off of the seven shapes and groups them together into what is the outline of an inner four shape. Turning to FIG. 86, the student then combines together the 2 five shapes 105a that were left behind in the last step together into the shape of ten. To further demonstrate the answer the student can then place the shape of the numbers they have created over top of what they have created. Turning to FIG. 87 a solid ten shape 110a has been placed over top of the two five shapes and an inner four shape 104a has been placed over top of the 2 two shapes. This gives us the answer of 14 because there is 1 ten shape and 1 four shape.

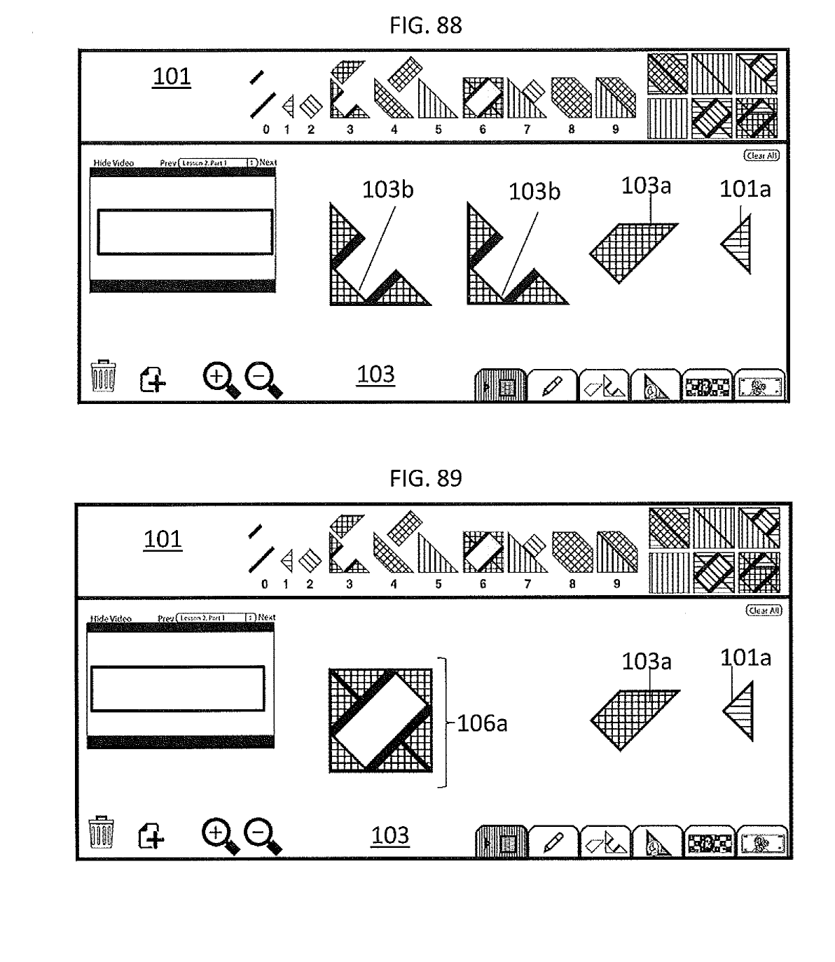

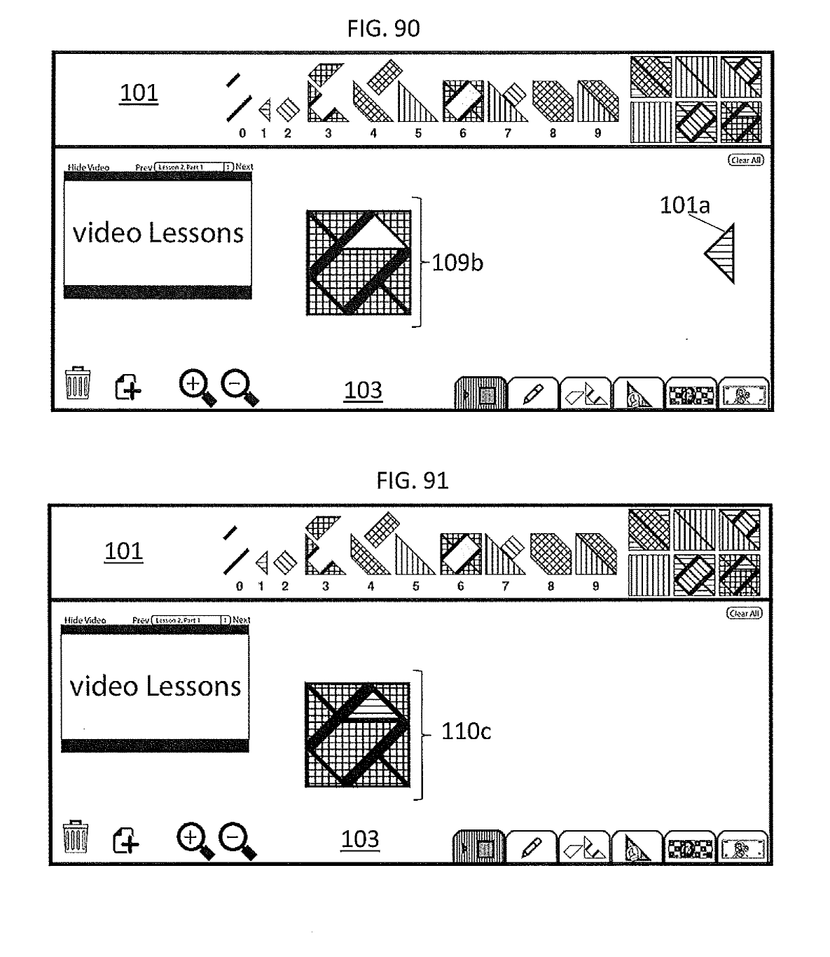

Next is an example of an addition problem, 3+3+3+1. Utilizing the Shape Math® system, the user combines these shapes together to see what shape they can come up with. When these pieces are rearranged, the 3 three shapes and the 1 one shape, when combined together, make the shape of 10. Utilizing the computer implemented system of the present invention this process might look like something shown in FIGS. temp 88-91. Turning to FIG. 88, the student would drag 2 outer three shapes 103b, 1 inner three shape 103a, and 1 one shape 101a from the shape bar 101 on to the work surface 103. Turning to FIG. 89 the student would then start to combine together the different pieces to see what shape he or she would get. The 2 outer three shapes are combined together to make a six shape 106a. Turning to FIG. 90 the inner three shape has been moved into the six shape making a ten shape with a one shape missing 109b, which is equal to nine. Next, we turn to FIG. 91. The one shape has been placed inside of the nine shape from the last figure to complete the problem. The answer is ten 110c because the outside shape that is created has a value of ten and it is completely filled in. This way of making a ten shape is one of the ways displayed in the shape bar 101.

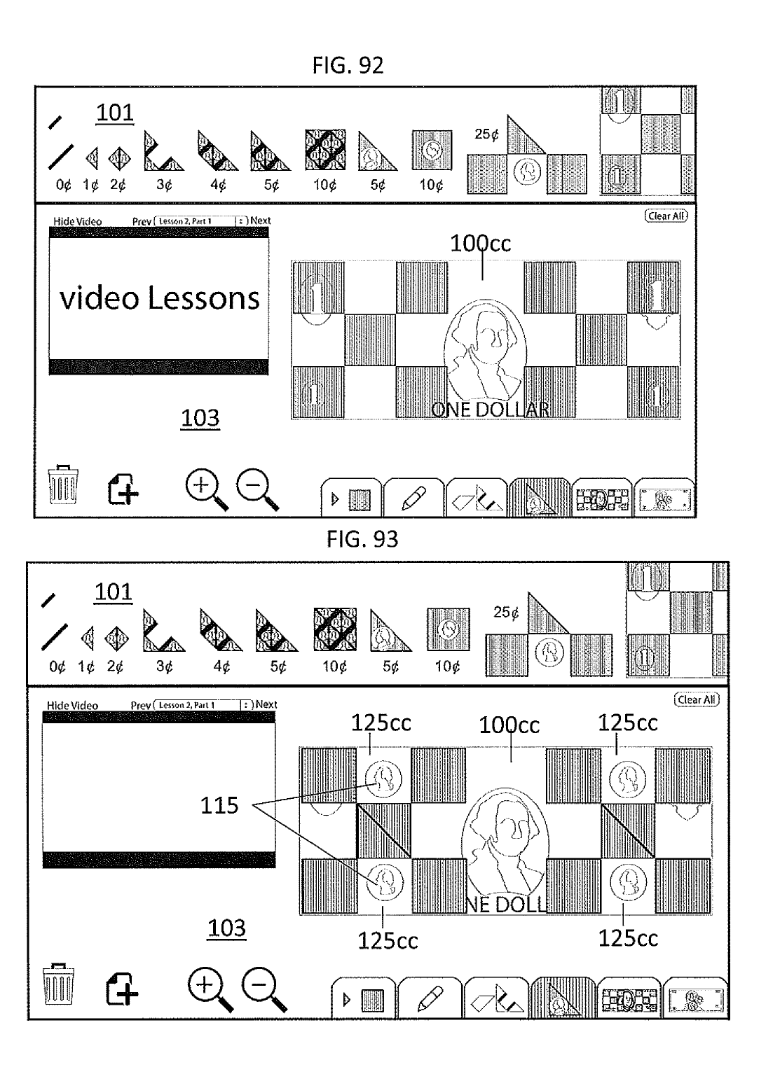

The Shape Math® digital program can also be used to demonstrate concepts in regards to money. What follows is a demonstration of how four quarters fit into a dollar, FIGS. 92-93. The student would drag a one dollar Shape Math® bill consisting of a hundred pattern 100cc from the shape bar 101 on to the work surface 103, FIG. 92. Now turning to FIG. 93, the student would then take Shape Math® quarters 125cc from the shape bar 101 and place them over top of the one dollar Shape Math® bill consisting of a hundred pattern 100cc. The quarter inside of the Shape Math® quarter 115 does not change its orientation, but stays upright whether the five section of the quarter is pointed down or up. When the student is done he or she has placed 4 Shape Math® quarters onto the pattern of one hundred on the Shape Math® one dollar bill 100cc. The four quarters when combined together make the pattern of one hundred demonstrating that 4 quarters make a dollar or 100 cents.

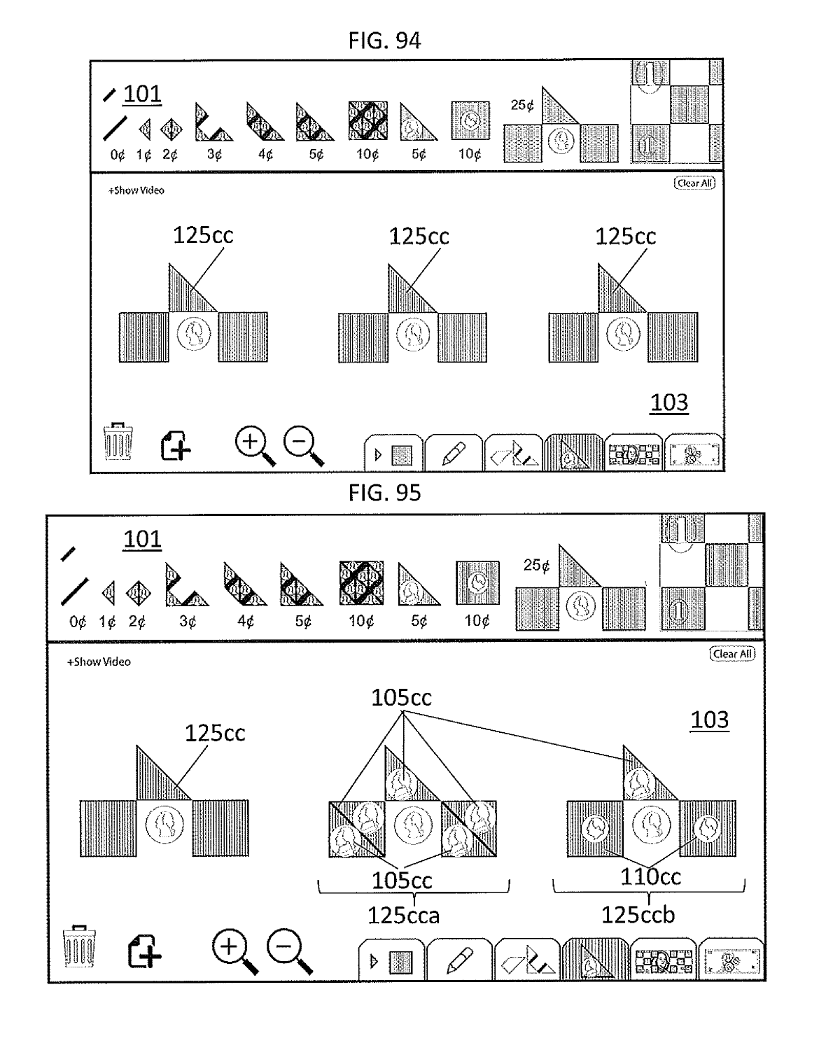

The Shape Math® program can be used to break down amounts smaller than a dollar, FIGS. 94-95. Turning to FIG. 94 a student drags 3 Shape Math® quarters 125cc onto the work surface 103. The student then sees what other Shape Math® coin denominations can fit into the Shape Math® quarters. Turning to FIG. 95 the student sees how many Shape Math® nickels 105cc will fit into a Shape Math® quarter 125cc. The student drags five Shape Math® nickels 105cc onto the second Shape Math® nickel 125cca. The five Shape Math® nickels 105cc when combined together make the same pattern as the quarter. The nickels inside of the Shape Math® nickels keep their upright orientation regardless of the Shape Math® pattern around them the same way the quarters did in the dollar bill example. The coin inside of the Shape Math® coin staying upright regardless of the orientation of the Shape Math® shapes around it is a property of all Shape Math® coins. The student can also make the pattern of a Shape Math® quarter 125cc by placing 2 Shape Math® dimes 110cc and a Shape Math® nickel 105cc onto a Shape Math® quarter 125ccb. These money techniques are useful when demonstrating the equivalency of different combinations of coins.

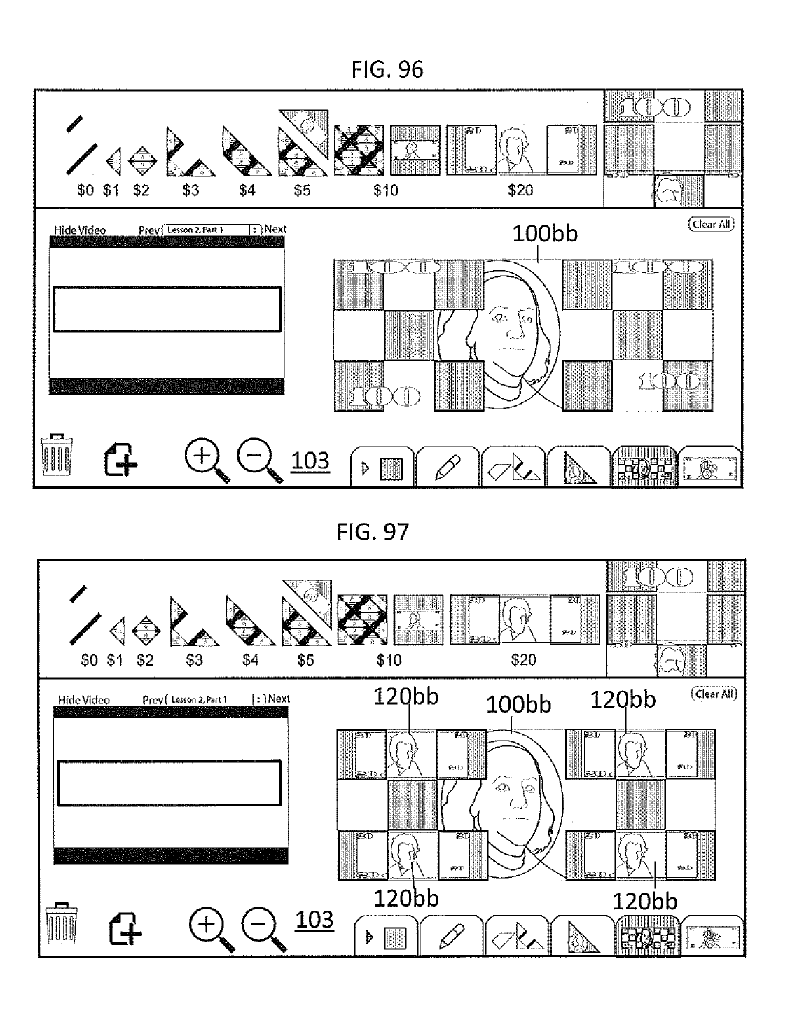

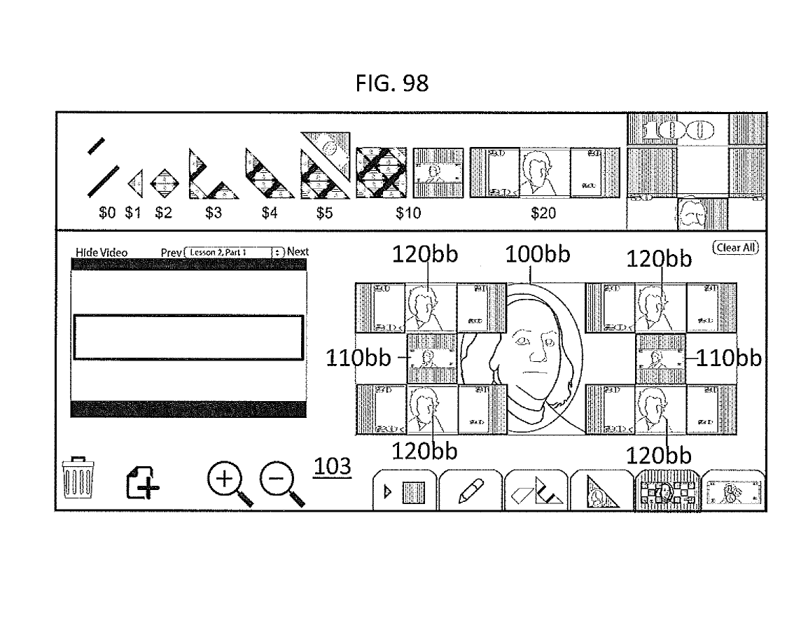

The Shape Math® digital program can help teach a student how different denominations of bills can equal the same amount. Now turning to FIG. 96 for the example of 4 twenties and 2 tens equaling $100. The student drags a Shape Math® one hundred dollar bill 100bb onto the work surface 103. Now turning to FIG. 97, the student can now drag 4 Shape Math® twenty dollar bills 120bb onto the pattern of a hundred on the Shape Math® one hundred dollar bill 100bb. Now turning to FIG. 98, the student can then place 2 Shape Math® ten dollar bills 110bb over the remaining section of the pattern of one hundred on the Shape Math® one hundred dollar bill 100bb. The combination of Shape Math® twenty dollar bills 120bb and Shape Math® ten dollar bills 110bb equal one hundred dollars and fit into the pattern of 100 on the Shape Math® one hundred dollar bill 100bb.

While the disclosure has been described in detail and with reference to specific embodiments thereof, it will be apparent to one skilled in the art that various changes and modifications can be made therein without departing from the spirit and scope of the embodiments. Thus, it is intended that the present disclosure cover the modifications and variations of this disclosure provided they come within the scope of the appended claims and their equivalents.

What is claimed is:

1. A computer implemented digital interactive learning system comprised of having a user manipulating a plurality of geometrical shapes on a device with an interface; said plurality of geometrical shapes comprising unique geometrical shapes, each unique geometric shape having a specific value ranging 1-10, wherein the unique geometrical shape having a value of 10 is formed by manipulating any combination of unique geometrical shapes that when their specific values are added together equals the value of 10, and wherein the user can learn to perform basic math operations.

2. The system of claim 1, further comprising a spacer having a null value.

3. The system of claim 1, wherein the interface is comprised of a shape bar and a workspace.

4. The system of claim 1, wherein the unique geometrical shapes are comprised of standard shapes.

5. The system of claim 4, wherein each unique geometrical shape has a specific color.

6. The system of claim 4 further comprised of outline shapes, whereby the outline shapes are used to demonstrate how unique geometrical shapes with smaller values can combine to form unique geometrical shapes with larger values.

7. The system of claim 1, wherein the unique geometrical shapes are drawn by a user in a written form.

8. A computer implemented digital interactive learning system comprised of having a user manipulating a plurality of geometrical shapes on a device with an interface; where said plurality of geometrical shapes are comprised of corresponding shapes; each corresponding shape representing a monetary value of a specific currency denomination.

9. The system of claim 8, wherein each corresponding shape representing a monetary value of a specific currency denomination is of a size relative to its monetary value.

10. The system of claim 8 wherein manipulating the plurality of geometrical shapes teaches the user to make change.

11. The system of claim 8 wherein manipulating the plurality of geometrical shapes teaches the user to add and subtract currency.

12. The system of claim 8, wherein the interface is comprised of a shape bar and a workspace.

13. The system of claim 1, wherein information is stored for each unique geometrical shape and wherein the information stored is comprised of: a) a selection status; b) a type status; c) a numeric value; d) an orientation; and e) a style.

14. The system of claim 1 wherein there are at least three size values for each unique geometrical shape.

15. The system of claim 8 wherein there are at least three size values for each corresponding shape.

16. The system of claim 8, wherein information is stored for each corresponding shape and wherein the information stored is comprised of: a) a selection status; b) a type status; c) a numeric value; d) an orientation; and e) a style.

17. The system of claim 3, wherein at least one unique geometric shape is comprised of smaller unique geometric shapes, and wherein these smaller unique geometric shapes stay locked together until the user places them onto the work surface and once on the work surface, the smaller unique geometric shapes can be manipulated by the user as separate pieces.

18. The system of claim 12, wherein at least one corresponding shape is comprised of smaller corresponding shapes, and wherein these smaller corresponding shapes stay locked together until the user places them onto the work surface and once on the work surface, the smaller corresponding shapes can be manipulated by the user as separate pieces.

19. The system of claim 1, wherein the unique geometric shapes are comprised of outline shapes.
